(19) United States
(12) Patent Application Publication
(10) Pub. No.: US 2009/0223682 A1
(43) Pub. Date: Sep. 10, 2009

(54) PROCESS TO FIGHT FOCI OF HEAT AND/OR FIRES OF ANY MAGNITUDE, AND PIECES OF EQUIPMENT FOR RUNNING THE OPERATIONS, PIECES OF EQUIPMENT FOR FIRE EXTINCTION, AND COMPOUNDS THAT PROMOTE FIRE EXTINCTION - PROJECT SALAMANDRAS"

(76) Inventor: Ramatis Piscirilli Ramos, Chacara Agrindus (BR)

Correspondence Address: Keith Kline;THE KLINE LAW FIRM, P.C., 161 Little Pond Lane, Palmyra, VA, 22963-5161, US

(21) Appl. No.: 11/666,212

(22) PCT Filed: May 16, 2005
(86) PCT No.: PCT/BR05/00085

§ 371 Date: Apr. 25, 2007

(30) Foreign Application Priority Data
Oct. 25, 2004 (BR) PI0406354-6

(51) Int. Cl. A62C 3/02; A62C 19/00; A62C 27/00; A62C 39/00

(52) U.S. Cl. 169/46; 169/36; 169/53; 169/70; 169/91

(57) ABSTRACT

Those are new lines with new equipment, compounds, methods to provide immediate answers for the extinction of fires of any magnitude. The containers or Capsules herein proposed are defined as Fire Extinction Flexible Capsules (22), Fire Extinction Hard Containers (22-A), Fire Extinction Hard Spherical Containers (22-B), Refractory Fire Extinction Articulated Container (113), Special Fire Extinction Articulated Container (113-A), and Fire Extinction Mortars (96), and/or Fire Extinction Bottle-type Container (96-A).

All pieces of equipment proposed will be deployed on aircrafts (97-B) or on Helicopters (97, 97-A) hovering and specially equipped to run the applications, as well as specially equipped land vehicles.

The aircrafts can be provided with systems or guiding devices to guarantee target route accuracy for the extinction of forest, urban, and/or technical fires.

This current patent of Invention is related to the results of new studies, researches, and special technological developments to solve immediately and in the event of any emergency through the use of new methods, pieces of equipment, different operations, and new compounds for the extinction of all fires, applied through the use of our new technologies, our new methodologies, and that when added to our new cooling fluids defined as Refractory Gel/Bio-Gel and that can also if necessary add Soil Recovery Elements, herbicides etc., herein listed in this claim, will ensure concrete and hyper-efficient solutions to all the several problems connected to the prevention, contention, and extinction of any type of focus (foci) of heat and fires, thus offering a quick response to control them immediately. This quick and effective response enables protection and prevention for the whole life chain because it has a direct and an indirect action over the processes involved in the protection and prevention of climate balance, global warmth, greenhouse effect, the protection of macro and micro biodiversities, etc., worldwide. Since none of our technologies, new methodologies, and new fluids are being used in the world, to minimize environmental impacts from global warmth and the resulting number of fires that happen around the world, our new proposals bring solutions of social interest to the world. The communication media around the world show only the use of inefficient methods that do no meet the needs of thousands of victims.

As it is well known in the technical community linked to the production of products and to fire fighting, currently the following methods and pieces of equipment are used to fight fires in woods, or in buildings, or in plants, namely:

a) Small bombs like flasks that are used as delay bombs and placed on the soil, activated by the use of a wick that is stretched towards the fire and when the fire reaches the tip and burns the wick, the explosion process starts. They are placed previously in environments susceptible to small size fires, as in woods for instance, with the inconvenience of being small, they have to be transported by people to the site, and in many cases this means a transportation through long and rough terrain or places impossible to be reached; they do not stop the propagation of fires because of their small cubic capacity of extinguishing liquids, and when these fires are under the influence of wind, or they occur in woods, bushes, etc. taller than 50 cm;

b) Bags made of natural, or synthetic material with the upper edge of a hard material that maintains them always open, and that are filled with water when they are submerged into rivers, lakes, etc., and are carried by helicopters through cables that force these bags to always remain at a certain distance from the aircraft and with no possibility of height adjustments. They are transported by helicopters that must always be in constant move and fly over fires at a certain speed so that they can release the cargo but without any control over the bag output hole, throwing the water all at once over the area of the fire. The inconveniences and deficiencies here lie on the time needed to replenish the bag, the losses of water during transportation and friction with the air because the bags have no lids on their upper edge, and the extremely low performance because of the lack of valves to control the release and direction of the water that hardly reach the target, and the high costs because of evaporation of the water when it reaches the air and gets in contact with the heat waves, the flames, etc., which happens before the water touches the burning load, and finally the danger of bags tearing apart by the excess of heat whenever they come too close to the heat and fire, therefore rendering the equipment useless;

c) On-waiting device to contain fire using only Ethylene Oxide that forms a chock wave of higher pressure creating a cloud of air-fuel finely dispersed and that is exploded through detonating loads. The inconvenience lies on the use that is restricted to places that are close and easy to access and that allow its transportation and application; only part of the flames are temporarily contained and fire re-starts promptly; they do not have cooling compounds to extinguish and cool down the fire, and their use becomes restricted to fires that are not oxygenated by the wind, and to fires of very low intensity;

d) Fire suppression device. Brazilian Patent Application PI 9709954-6 and a Russian priority 97106264. The whole set is suspended by cables and hang at a distance from the aircraft. It is thrown by helicopter, or fixed on the soil, like an on-waiting bomb with a dispersing load, a height sensor, and an explosive load. Detonation occurs by contact and a fine cloud of dispersed air with the compound to extinguish the fire is obtained. This has its disadvantages and inconveniences when thrown by cables attached to the helicopter because the system is unpredictable and difficult to throw without control of the operator and without target accuracy; it is of low capacity, expensive and a dangerous operation because it is transported and thrown by a cable; it may tear-up; it may be shifted from its target when it hits against mechanical barriers such as tree branches, and with spherical spray during the explosion cycle, which means a loss of cooling liquids; or if damaged by branch collision, it looses its content without the explosion of the detonating load, which transforms these bombs in hazards to operators working on land;

e) Fire extinguishing bomb. A device under U.S. Pat. No. 4,037,665 that deploys an emulsion of water and heavy oil as fire extinguishing agent. The serious inconvenience lies on the fact that the system, because of the oil used, generates a pollutant and hazardous debris that are spread into the environment;

f) A device to extinguish fires in woods. The U.S. Pat. No. 4,344,489. It deploys a fire extinguishing gas that is held inside a metal cylinder with small windows that open mechanically when a fixation pin penetrates the soil. There are limitations concerning transportation, pressure, and gas launching accuracy because of the sealing system used. This restricts the amount of extinguishing agent, and its efficacy. The inconvenience lies on the fact that it can be drifted from its route by mechanical barriers such as tree branches, and it lacks cooling technical conditions, re-cooling, etc, because its content is only gas;

g) Fire extinguishing bomb. The U.S. Pat. No. 6,012,531. It concerns an egg-shaped bomb that contains an explosive load and a fire-extinguishing load in a structure made of several metal parts. It has the disadvantage and inconvenience of being small, of not having a streamlined shape appropriate to ensure target precision when launched by aircrafts, which makes its throw or drop unpredictable. It may fall on the soil on the opposite side to the one planned and spray the extinguishing product on a sole non-planned ascending direction, thus limiting the efficacy of its use for small size fires and introducing dangerous later effects if detonation does not occur or if it occurs partially, or if it occurs before it should;

h) Plastic bomb to fight forest fires of small magnitude. A Brazilian Patent Application PI 9801957-0. A droplet-shaped bag made of a plastic and an anti-flame material that holds water up to a 15 kg range. It has a closing system, pressure contention, and Velcro sealing system with water spray system that is only activated by the impact on the soil. This is a very limited and deficient device because of volume restrictions, and the Velcro sealing to hold the water, which does not allow a planned omni spray. It is also limited in its capacity and structure, in the efficiency of system operations that generate big losses and low performance because of a lack of streamlined systems to help on the target route accuracy because these plastic bags are drifted by the wind, by the speed that the aircraft itself needs to deploy, and by launch speed, which requires several and constant flights, so that the pilot can correct the fires target route.

It must be highlighted that the inefficiencies detected above and listed in items (a, b, c, d, e, f, g, h) which include both methods and pieces of equipments used, also show major deficiencies and restrictions in their results, or they show that those pieces of equipment or their methods have not been either developed or built to be used in actual circumstances because the fires continue out of control for long periods, as it is widely broadcasted on world news shows.

More recently the same inventor requesting this current patent introduced some important innovations with the same purpose: the Mechanical, Chemical, Electro-electronic Explosive Equipment for the Inhibition, Contention, Extinction of foci of heat, Different Types of Fires subject-matter of the Brazilian Patent Application PI 0204247-9; the Containers of Moldable Materials and/or the Containers with Ice-Covered Walls with Variable Thickness and/or Ice-Covered Containers that Are and/or Contain Different Products, subject-matter of the Brazilian Patent Application PI 0205383-7 and the Mechanic, Hydraulic, Electric, Electronic Transposition Container for Cooling Down; and/or Extinguish, and that Sprays Diversified Flows, subject matter of the Brazilian Patent Application PI 0205238-5, and that have the following characteristics:

i) Mechanical, Chemical, electro-electronic, and Explosive Equipment for the Inhibition, contention, Extinction of Foci of Heat, Fires, Different Types of Fire, subject-matter of the Brazilian Patent Application PI 0204247-9 introduces innovations in its manufacture and operational methodology, in its composition, in its streamlined design, in the method to control the spray of its contents through the use of containers built with grooves and/or dotted points, and/or fissures, and/or support belts and pins for fixation on the soil and with a stopper that successfully helps breaking different barriers, has target accuracy, totally controlled and directed spray without leaving any hazardous debris to the environment. The only inconvenience lies on the fact that its medium cost of production restricts its use to medium and big size fires because these are fires of greater danger, and that demand application techniques of major responsibility;

j) Containers of moldable materials and/or containers with ice-covered walls of different thickness, and/or frozen containers that are and/or contain diversified products, subject-matter of the Brazilian Patent Application PI 0205383-7, introduces a more economic production alternative with the use of cheaper building materials and the use of frozen containers that are shaped in ice and/or only with walls of ice that may or not deploy a full and more complex lid, or only a simple and cheaper device for start-up, and using explosives for the spray effect or not. These containers have some limitations and disadvantages because of their fragility on the ice wall structure, of their mass losses because of natural melting during transportation, and their need of refrigerated storage sites; and

k) Cooling Transposition Container, Mechanic, Hydraulic, Electric, Electronic, Container that Sprays Diversified Flows, subject matter of the Brazilian Patent Application PI 0205238-5, adding improvements to the equipment and to the methods for the extinction of fires with the use of water gathered in rivers, or lakes, or pools, through a hard, anti-flame container of a special structure with upper lid, valve, and sprayers that help to place it inside the fire and when it is inside the fire its special valves with controlled spray are opened via a motor, thus ensuring accuracy and great utilization of the water. The disadvantage lies on the need of extremely skilled operators and special aircrafts. This increases the cost of the whole operation and limits the application on fires on bushes, grass, or on fires of low magnitude.

As a justification in all aspects, moral, social, and technical for our studies and INVENTIONS, we include the greenhouse effect that we define as the hazardous accrual of pollutant/gases that do not dissipate because of the lack of wind currents and/or rain, and that triggers because of the excessive and continuous concentrated heat that is generated, the start-up of the decomposition processes of the compounds via desiccation, and also the other effects over the compounds here meaning only fuel loads, fire loads, Biomass, etc.

The heat that is generated produces an effect that separates off these fuel loads their inflammable gases, keeping them in very dangerous concentrations, and any energy of ignition, which we define as the Fourth Element, and that can be a lit cigarette tip, bonfires, matches still burning, the fall of balloons made of paper and launched during Brazilian festival and that carry burning torches, pyromaniacs, sparks, lightning, etc. that may set on fire these gases, spreading the flames and starting big fires that get out of control.

A Fourth Element must be included in the questionable Triangle of Fire, which is known as: fuel, heat, and oxygen.

The Fourth Element herein introduced is the mandatory energy of/or/for ignition proving that it is only with its interaction that it is possible to generate in the triangle of fire the combustion of the concentrated gases and their subsequent flames.

The pollutant products resulting from the burning process, carbon dioxide mainly, that in the volumes currently emitted plus the other gases generate in a cascade into the atmosphere hazardous chemical reactions, electromagnetic reactions, and other reactions are reflecting in all ecosystems worldwide deadly hazardous consequences. These consequences are so hazardous as unpredictable and have already destroyed the necessary balance in our atmospheric layers, drastically changing the climates all over the planet.

When the triangle of fire was analyzed, questioned, and reviewed it was understood that it could only be considered partially as an explanation to the origin of fire. It could only be considered without the presence of the Fourth Element as a partial basis for the explanation and understanding of fire and only related exclusively to the fires in class A category that we qualify according to the origin: paper, fabric, wood, etc., found in forest fires, etc.

The triangle of fire should not be considered in the explanation of fires that originate from a class B category either, because fire/flames from fuels in class B category do not need to be heated with high temperatures in their composition; quite the contrary, they have to be kept under low temperatures or under controlled temperatures with the appropriate storage, because their components are mostly volatile and highly inflammable such as solvents, etc and to make them burn the sheer presence of the Fourth Element is enough.

For fires in the class C category, we must also question the triangle of fire because the heat element plays an important role but limited to start-up/ignition of flames once the heat is generated because of malfunction in electric equipment and/or on the connections in energized cables and in a certain instance of excess of heat generated to an extent that can melt the conductive elements together with the other energized cables and/or with electric equipment, we find in this meltdown and in this short-circuit the spark(s) that is the Fourth Element, inflaming/lighting the accrued gases and that are present, generating a class C fire.

In this descriptive report, the triangle of fire is questioned as the foundation to explain fire because the Fourth Element that is herein recognized and presented has been left out.

This patent brings solutions to the pressing need of controlling forest fires and other types of fires that must be immediately extinguished and avoided by all means, because when compared to other polluting means such as automobiles and factories, forest fires and other types of fires can and should be controlled as the only effective means to avoid great percentages of emissions of carbon dioxide, ozone, and other gases that are generated during big fires on agricultural areas or on forests, without generating unemployment and other serious social problems. Like this we can help solve the current social and economic turmoil, because we know that to stop immediately the emission of pollutant gases derived from the burn of fossil fuels will always, according to progress needs, be out of the question.

Therefore, using these new sets of technologies introduced in this patent, all technical conditions necessary to solve immediately all the problems generated and started by fires, forest fires, urban and technical fires, pipeline fires, gas line fires, oil well fires, fuel reservoirs fires, etc., are available. This means that in the scale of emission of pollutants a relevant reduction will occur helping the preservation of life worldwide.

To get a better understanding of this patent, below is a list of components that must be used in “PROCESSES TO FIGHT FOCI OF HEAT AND/OR FIRES OF ANY MAGNITUDE, AND PIECES OF EQUIPMENT FOR RUNNING THE OPERATIONS, PIECES OF EQUIPMENT FOR FIRE EXTINCTION, AND COMPOUNDS THAT PROMOTE FIRE EXTINCTION—PROJECT SALAMANDRAS”—herein proposed as the result of a combination of components and/or compounds specially developed and/or adjusted and listed below for a co-joint action and/or partial action whenever necessary:
1—1^{st} Barriers BIAI—Fire and Flame Height;
2—2^{nd} Barriers BIAI—Smoke and By Products;
3—3^{rd} Barriers BIAI—Heat Wave Displacement;
4—4^{th} Barriers BIAI—Wind Speed;
5—5^{th} Barriers BIAI—Atmosphere Temperature;
6—6^{th} Barriers BIAI—Air Relative Humidity;
7—7^{th} Barriers BIAI—Resulting Temperatures—Convections;
8—8^{th} Barriers BIAI—Mechanical Barriers;
9—9^{th} Barriers BIAI—Interference Barriers for Cooler(s) and/or Extinction and Isolation of the Focus of Heat and Flame Extinction;
10—Angular Ascending Counter Pressure;
11—Ignition Power or Fourth Element;
12—Fire Fuel Loads;
13—Triangle of Fire with Fuel, Oxygen and Heat in a Chemical Reaction;
14—Resulting Temperatures from 200° C. to 1000° C., 2.000° C.;
15—Dispersive and Water or Fire Extinction Flow Compounds Fragmenting Barriers and/or others;
16—Wind Speed, Convection Columns putting Angular Counter Pressure, Ascending Heat waves between 5 Km/h to 150 Km/h;
17—Water or others liquids without any protection against evaporation when launched from aircrafts;
18—Ordinary Helicopters;
18-A—Aircrafts, Equipment, and/or devices for helicopters equipped with advanced avionics for special helicopters, and/or helicopters piloted only by a crew, and/or helicopters piloted by crew and/or commands by remote control, radio, and/or other means, and/or helicopters only piloted by remote controls, by electronic means, and/or other means;
19—Airplanes or balloons, dirigibles, air balloons, and/or other ordinary aircrafts;
19-A—Equipment and/or devices for airplanes, balloons, dirigibles, air balloons, and/or others, provided with advanced avionics for special aircrafts and/or airplanes, balloons, dirigibles, air balloons and/or others piloted only by crew and/or commands by remote control, radio, and/or other means, and/or helicopters only piloted by remote controls, by electronic means, and/or other means;
20—Scale with probable heights in meters from where launches may occur;
21—Fire Extinction Flexible Capsules (22), and/or Fire Extinction Hard Containers (22-A or 22-B), and/or Fire Extinction Mortars (96 or 96-A) launched by aircrafts/Helicopters;
22—Fire Extinction Flexible Capsules;
22-A—Fire Extinction Hard Containers;
22-B—Spherical Containers;
22-C—Details on the Spherical container and spray directions;
23—Programmed fragilities;
24—Fire Extinction Flow Compounds;
25—Lower Gäa-Kibele Vectorizer;
26—Upper Gäa-Kibele Vectorizer;
26-A—Cylindrical hole for the passage of the Upper Vectorizer for the different Drivers of Ignition;
27—Hole(s) for fastening or fitting the Upper Vectorizer;
28—Hole(s) for fastening and/or fitting the Hook(s);
28-A—Running through hole for the different Drivers of Ignition;
29—Fastening and/or adjustment, and/or sealing clamp;
30—Support and/or guide, and/or transportation belts;
31—Starting, Detonating Device(s);
32—Different Drivers for Ignition;
33—Support and Transportation Hook;
34—Screw Cap;
35—Option 1 Lid for different containers;
35-A—Option Lid 2 for different containers;
35-B—Fastening and/or adjustment, and/or sealing shoulder of the clamp(s);
35-C—Hole(s) for Fitting and/or Fastening the Starting and/or Detonating Device(s);
35-D—Filling opening for different Capsules (22) or Containers (22-A or 22-B);
35-E—Running through, or Fastening, or fitting hole(s) of fastening screws for the Upper Vectorizer (26), or for the Upper Cap (48), and/or the Adaptor with internal and external threads (71) for the Core Set;
35-F—Fitting hole of the Starting and/or Detonating Device(s);
36—Core Set Body;
37—Simple Nesting Body to hold Explosive(s) or Mix of Explosive(s) or Chemical Compound that generates High Speed Pressure (41);
37-A—Nesting body to hold Staggered Explosive(s) and/or Mix of Explosive(s) or Chemical Compound that generates High Speed Pressure (41);
37-B—Nesting Body in cone-trunk format to hold Explosive(s) and/or Mix of Explosive(s) or Chemical Compound that generates High Speed Pressure (41); 37-C—Nesting Body in a spherical format or other formats to hold Explosive(s) and/or Mix of Explosive(s) or Chemical Compound that generates High Speed Pressure (41);
38—Axle Limiting Rings;
38-A—Rod(s) Details;
38-B—Adjustable Ring(s) Details;
39—Axle Limiting Guide(s);
40—Propelled-Propellant Crystals and/or Granules;
41—Explosive(s) and/or Mix of Explosives, or Chemical Compound that generates High Speed Pressure;
42—Delay Fuse(s) or not and/or explosion train;
43—Staggered Reducing Adaptor for the Containers (52-2);
44—Lower cap Containers to hold explosive(s) (51-1 or 52-2 or RCE-3);
45—Upper cap Containers to hold explosive(s) (51-1 or 52-2 or RCE-3);
46—Core Set;
46-A—Core Set in a cone-trunk format;
46-B—Core Set on a spherical format or other formats;
47—Core Set lower cap;
48—Core Set upper cap;
49—Upper Cap Pin(s) for fitting and/or fastening;
50—Upper Cap running through hole of the different Drivers for Ignition;
51—Simple Containers (51-1)—container to hold Explosive(s) and/or Mix of Explosives or Chemical Compound that generates High Speed Pressure (41);
52—Containers (52-2)—staggered container to hold Explosive(s) or Mix of Explosives or Chemical Compound that generates High Speed Pressure (41);
52-A—(RCE-3)—staggered container to hold Explosive(s) or mix of Explosives or Chemical Compound that generates High Speed Pressure (41);
53—Sealing conical flexible adaptor with central running through hole for different drivers;
54—Running through hole on the Disk (58) for the fastening screw(s) between the Disk (58) and the Upper Vectorizer(s) (26), or Upper Cap(s) (48), and/or the Adaptor with internal and external threads (71) to fasten the Core Sets;
55—Set of Lids 55—option three;
56—Adjustment, Retention, Fastening, and Transportation Lid;
57—Hard Polymer Lids for experimental Capsules (22), and/or Containers (22-A), and/or (22-B);
58—Retention and Fastening Disk;
59—Support, adjustments, and/or transportation hole for Capsules (22), and/or Containers (22-A), and/or (22-B);
59-A—Support reinforcement rim(s) of the Lid;
60—Adjustment screws for the Lid Set (55);
61—Running through hole of the Adjustment Screws of the Lid Set (55);
62—Fastening Screws between the Disk (58) and the Upper Vectorizers (26) or Upper Caps (48) and/or Adaptor with internal and external threads (71) to fasten the Core Sets;
63—Check nuts, Adjustment nuts, and fastening nuts for the Lid Set;
64—Option Lids 4, 5, 6, 7, 8, 9, for different containers;
64-A—Lateral edge of the body of the Lid(s) with internal threads;
64-B—Lower lateral edge of the body of the Lid(s) with external threads;
64-C—Fastening external threads for the containers on the lower external edge of option 8 and 9 Lid(s);
65—Articulated Lid for the Protection of the Electronic Board(s) and their component(s);
66—Electronic Board(s) and their component(s);
67—Supporting and fastening pins for the Electronic Board(s) and their component(s);
67-A—Fastening and/or fitting holes for the Electronic Board(s) support and fastening pin(s) with their component(s);
68—Calibrating valve of the Capsules (22), and/or Containers (22-A), and/or (22-B);
69—Calibrating valve of the Core Sets;
70—Central Opening of the Lid for the introduction of the Fire Extinction Flow Compound, and/or for fastening other accessories;
71—Adaptor with internal and external threads, with or without calibrating valve, with or without conical running through hole for the Drivers, or fastening hole(s), or running through hole(s);
72—Lid Reinforced Base;
72-A—Lid Straight Base;
73—Fittings for Fins or Wings (79), or spoilers (80) that guide target route, or for male and female Guides for target route;
74—Fitting or Fastening Hole of the articulated Lid for the Protection of the Electronic Board(s) and their component(s);
75—Running through hole or fastening hole of the calibrating Valve of the Capsules (22), and/or Containers (22-A), and/or (22-B);
76—Running through or fastening Hole of the calibrating valve of the Core Sets;
77—Male and Female guide Set for Target Route and Starting process via pull for Ignition of the Starting Device(s) and/or Detonator(s) provided with fastening rod (77-A) and speed control device(s) for the Capsules (22), and/or Containers (22-A), and/or (22-B);
77-A—Fastening Rod(s) for an eventual connection of the Target Route Male and Female Guide and for Ignition of the Starting and Detonating Device(s);
77-B—Speed control device(s) for the Capsules (22), and/or Containers (22-A), and/or (22-B);
78—Decentralizer Adaptor of the Core Sets and/or Rods (82);
79—Fins or wings for target guidance;
80—Spoilers for target guidance;
81—Special Vulcanizable Adaptor with external threads and smooth internal area;
82—Support Rod(s) for the Core Sets;
83—Fitting hole for the Capsules (22), and/or Containers (22-A), and/or (22-B) closing Lids;
84—Upper part of the spherical container (22-B);
85—Female edge for fastening the spherical containers (22-B);
86—Male edge for fastening the spherical containers (22-B);
87—Lower part of the spherical containers (22-B);
88—Counter weight for plummet maintenance;
89—Hard Cork(s) with or without metal jacket(s) and/or other self-screwing materials, and/or made of other combined materials, and/or for fastening on the soil, and/or for different perforations, with or without metal jacket, or composed semi-jacket, and/or for eventual fastening on the soil of the Capsules (22), and/or Containers (22-A), and/or (22-B);
89-A—Whole Metal Jacket(s);
89-B—Hard Material Semi-jacket;
90—Refractory or Especial Articulated Containers;
90-A—Lids;
90-B—Sealing rims made of rubber or of different materials to retain contents;
90-C—Hinges;
90-D—Buoys or floating systems;
90-E—Lid Limiting Angle Bars;
90-F—Support and/or fastening, and/or transportation hooks;
90-G—Counterweight for immersion;
90-H—Electric, electronic, mechanical, or hydraulic motor and/or engine, and/or rotating system;
90-I—Pin(s) or fitting, or fastening area(s) for the sprays;
90-J—Spray(s);
90-K—Water and/or other liquids output holes located on the lateral areas and in the lower areas of the spray(s) (90-J);
90-L—Water and/or other liquids output holes located only on the lower area;
90-M—Male and female fitting set for overlaying the valves for sealing water and/or other liquids;
90-N—Articulated axle of the motor and/or engine, and or of the Rotating System to control the Valves;
90-O—Optional cable(s) to control the valves;
90-P—Adjusting and fastening ring of the axle or cable(s);
90-Q—Support Guide of the Valves;
90-R—Valve(s), and/or sealing device(s);
90-S—Support, sealing, and fitting base of the valve(s);
90-T—Sealing hinge of the valve(s);
91—Capsules (22), and/or Containers (22-A) and/or (22-B), in a cylindrical format or others formats in free launch;
92—Trolley(s) or guide trolley hook(s) for support and transportation of the Articulated Mobile Hook;
93—Special guide rail(s) for aircrafts and for storage, displacement, positioning, and launching of Capsules (22), and/or Containers (22-A), and/or (22-B);
94—Details of blasted Bottle Type Container (96-A) and their sprays;
95—Details of spherical format or Bottle Type Container or spherical Containers (22-B) and their sprays;
96—Fire Extinction Mortars ready to use;
96-A—Bottle Type Container to be launched;
96-B—Bottle Type container lid;
96-C—Reusable and reinforced metal capsule;
96-D—Percussion pin to activate the fuse(s) explosion train (42);
97—Special helicopter equipped with (18-A, 92, 93, 98, 99, 105, 106, 107, 108, 109, 109-A, 110) to store and launch Capsules (22), and/or Containers (22-A or 22-B) or Mortars (96) or Bottle Type Container (96-A);
97-A—Special Crane-type helicopters equipped with items (18-A, 108, 109, 109-A, or 110), or whenever necessary, with items (92, 93, 98, 99, 105, 106, 107);
97-B—Special aircraft equipped with items (19-A, 92, 93, 98, 99, and/or 108, and/or 109, and/or 109-A);
98—Door(s) or opening(s) equipped on Special Helicopters, and/or airplanes from where the launches of the Capsules (22), and/or Containers (22-A or 22-B) will occur;
99—Articulated Mobile Hook connected to the Trolley and/or Trolley hook from where free fall launches Capsules (22), and/or Containers (22-A or 22-B) will occur;
100—Fuel load in flames;
101—Fire, or flames, and smoke;
102—Inactive fuel load;
103—Soil devastated by fire;
104—Directions of the Fire Extinction Flow Compound sprays and other by-products, and/or compounds;
105—Cable(s) or Guide Chain(s) of target route, with or without Dart(s) connection (106), with or without Rod(s) (107), that can also be cables, ropes, and/or wires, and/or fibers with or without dart(s) as in item (106), with or without pendulum rod(s) as in item (107);
106—Starting and/or Detonating rotating conical Dart(s) and starter(s) with central hole for the connection of the Cable(s) or chain(s) for breaking the guides and pull or the starter and for starting and blasting the Capsules (22), and/or Containers (22-A or 22-B);
107—Pendulum Articulated Rod(s) with or without articulations, with or without Electromagnetic Fields, with connection to the Dart(s) and to identify and limit the level and/or distance of the soil to guarantee target route(s);
107-A—Sensor(s) for different identifications and scanning;
107-B—Flashing light or not, signaling bulb(s) or Light Emitting Device(s);
107-C—Reflective and/or Fluorescent Device;
108—Cable(s) or Lowering and Hoisting Chain(s) of the Capsules (22), and/or Containers (22-A), and/or (22-B), or for the Thermal Booth (133) only to Transport the Containers (22-B) and/or the victims, and/or the operators, and that can also be cable(s), rope(s), and/or wire(s), with or without Dart(s) (106), with or without Pendulum Rod(s) (107);
109—Guide Pulley(s) of the Cable(s) or Chain(s) (108);
109-A—Special electric, and/or electronic, and/or mechanical, and/or hydraulic Hoist for lifting and lowering;
110—Rotating device(s) for Cable(s) or Chain(s) and Hook alignment maintenance;
111—Oil pipes, or gas pipes, or pipes in flames;
111-A—Oil well(s) in flames;
112—Fuel material(s) reservoir(s) in flames;
113—Refractory Fire Extinction Articulated Container (totally coupled to helicopter 97-A);
113-A—Special Container provided or not with items (114, 114-A, 115, 116), (and hanging very close to Helicopter 97);
114—Protection Box for output Pipe(s) with or without water Pump(s) and/or other Cooling Fluid(s) and/or Extinction Fluid(s) (114-B), with or without Retractable Mobile Reel equipped with Discharge Pipe(s) (114-A) for Special Hose(s) (115) for flow and spray;
114-A—Retractable Mobile Reel equipped with discharge pipe for flow and spray hoses;
114-B—Water pump(s) and/or other Cooling Fluid(s), and/or Extinction Fluids;
115—Special Hoses or pipes flowing by gravity with or without wall reinforcement mesh, with or without anti-flame coating;
116—Nozzle or open/close spray valve;
117—Operators, or land team, or teams inside the aircrafts/Helicopters;
118—Traditional cable(s) or rope(s) to control opening and/or closing of valves;
119—Soil topographies;
120—Lakes, pools, reservoirs, other sites for water supply;
121—Support and alignment tripod(s) for Mortars (96 or 96-A), launching or for soil fastening for support and alignment of Capsules (22), and/or Containers (22-A), and/or (22-B), when directly used over the soil;
122—Launchers for Mortars (96);
123—Adjustable angular curve for route Bottle Type container (96-A) trajectory;
124—Special land vehicles;
125—Buildings;
126—Details of the buildings;
127—Special land vehicle(s) with special hoist(s) for fire fighting;
128—Telescopic trough for the launch of containers (22-B), and/or for access when rescuing victims or operators;
129—Special telescopic hoist;
130—Thermal Booth of controls;
131—Telescopic arms for fastening and transportation connected and supported by Crane (129);
132—Tackle of the Crane with hoist, cable, and hook;
133—Thermal Booth for the transportation of the containers, and/or of victims, and/or of the operators;
134—Bazookas, disposable rifles or not to be fastened to the soil or not, catapults, and other device(s);
135—Capsules (22), and/or Containers (22-A), and/or (22-B) placed by operators on the line of fire for controlled and immediate explosion and blast of the waiting Capsules (22), and/or Containers (22-A), and/or (22-B);
136—Trees as fuel load of tree-crown fire(s);
137—Probable format in monoblock of the openings of the Capsules (22), and/or Containers (22-A), and/or (22-B) as a consequence of the explosion or blast of the Capsules (22), and/or Containers (22-A), and/or (22-B);
138—Robots, or robotic, or cybernetic device(s), controlled by remote control or other types of control for handling, transportation, launching, or placement of the Capsules (22), and/or Containers (22-A), and/or (22-B) at the sites;
139—Ordinary steel cable(s) or specially weaved with or without core/kernel, made of natural and/or synthetic flexible materials, for the transportation and guidance, for (105), or (108);
140—Special anti-flame rope(s), for the transportation or guidance;
141—Special chain(s) with different types of link(s), for transportation or guidance, for (105) or (108);
142—Chain(s) with a special construction process, through the union of spheres, for transportation or guidance for (105) or (108);
143—Weaved metal wires or not for transportation or guidance for (105) or (108);
144—Ceramic or refractory coatings for parts or pieces or for the containers bodies (113 or 113-A);
145—Special fastening, support screw with central and longitudinal hole for the passage of the different driver(s) for ignition;
146—Bio-natural anti-flame, Bio-Gel-Refractory;
147—Soil Recovery Elements, fertilizers/chemical and/or natural fertilizers, different seeds for reforestation;
148—Herbicides, special gel-capsules to coat the seeds, and that include nutrients, and/or fertilizers, and/or other types of fertilizers, or products;
149—Special magnets of different sizes, formats, and capacities;
150—Special electro-magnets;
151—Intruder;
152—Special mechanical and motorized sweeper, and/or damper;
153—Different hoisting shackle or clips;
154—Reinforcing element(s);
155—Delay element(s);
156—Fuse(s); Igniter(s);
157—Hard Nozzle(s) for guidance, breaking, and/or fastening on the soil, and/or for the transposition of mechanical and other Barriers;
158—Electronic circuit(s);
159—Sensor(s);
160—Thermo viewer (cameras that detect temperature);
161—Signal receiver(s) and/or transmitter(s)
162—Rivets;
163—Other tools.

To have a better understanding of fires, their dynamics, hazards, as well as the operational deficiencies and inefficiencies during fire fighting, control, and extinction, we introduce FIGURE A that technically shows the causes and reasons why current technologies for fire fighting are extremely inefficient and/or deficient, namely: arrow (09) represents the direction and displacement of the Barriers that are an Obstacle for the Cooling down, and/or Extinction, and/or Isolation (a.k.a. Barriers) of the focus of heat and extinction of flames. Arrow (10) represents the direction and displacement of the Angular and Ascending Counter pressure. The lower rectangle identified as (12) represents Fire Fuel Loads. The triangle of fire identified as (13) and that includes on its basis the fuel element, and on the sides the element oxygen and the element heat, all in a chemical reaction with the spark or defined scintilla, or energy for ignition, the Fourth Element (11); this Fourth Element will start the flames in the chemical reactions that originate from the triangle of fire. The parallel rectangles represent the 1^{st} Barrier that are Fire and Height of Flames; the 2^{nd} Barrier are Smoke and Byproducts; the 3^{rd} Barrier are the Displacements of Heat Waves; the 4^{th} Barrier are Wind Speeds; the 5^{th} Barrier are Atmospheric Temperatures; the 6^{th} Barrier are Air Relative Humidity ranges; the 7^{th} Barrier are the Resulting Temperatures and convections; the 8^{th} Barrier are the Mechanical Barriers; the arrow (14) shows the directions of the resulting Temperatures and vary from 200° C. up to 2000° C. Arrow (15) shows the directions of all Barriers and that these are Dispersive and Fragmentizers of Water or of the Fire Extinction Flow Compound and/or other. Arrow (16) shows the directions and Speeds of Wind, Convections Columns with their Angular Counter Pressure and their Heat Waves and ascending Flames going between 5 and 150 Km/hour. The rectangle identified as (18) represents the Helicopters throwing water/other over the above identified and explained Barriers Rectangle (19) represents the Airplanes throwing water/other over the Barriers. The parallel lines identified as (17) represent the water being thrown without any container or protection against its evaporation. The scale identified as (20) represents the probable heights in meters from where the water can be thrown, showing very clearly why fires are not extinguished quickly, economically, safely, and efficiently even when very expensive equipment is deployed, such as aircrafts that throw thousands of liters of water and delaying foam or other compounds over the flames and/or fires.

These methods when used following these guidelines continue to generate relevant and unacceptable losses greater than 80% in terms of water utilization and performance of other compounds as well as of the processes involved.

The understanding and recognition of the Barriers clearly explains the appalling inefficiencies, deficiencies, and losses in the processes deployed all over the world that have very high loss rates. When we analyze forest fires and other types of fires there is a moment where they self acclimatize generating angular and ascending temperatures through the whirlpool of flames, convection columns, radiation, etc., that can vary between 200° C. and 2000° C. and that may reach, because of certain dynamic circumstances and climate characteristics higher temperatures, we understand how important it is to have a good knowledge of these Barriers.

Once water reaches its boiling point, always taking into consideration sea average level, at 100° C., and going from liquid to steam, it becomes quite clear and easy to understand that what was liquid and thrown from flying aircrafts over the flames of a fire, with the friction with the air produces the beginning of the process to change from a liquid state to micro particles of water and these particles of water colliding with the currents generated by ascending heat vaporize because of flame temperature, radiation, etc.

If the small percentage of water still in a liquid state passes through the Barriers shown in FIGURE A, it will still have to deal with the high temperatures held by and/or contained in the burning fuel loads. If these burning fuel loads fall in class A category, they may well be between 200° C. and 2000° C.; and to try to cool down the focus of heat until it is extinguished having left only 20% of water in a liquid state, turns all the operations involved technically unfeasible because the volume of fuel load is many times superior in energy accrued when compared to the volume of the cooling/re-cooling agent launched—the water. We should not forget that nearly 4,000 Kcal are generated per 1 Kg of wood burnt.

In FIGURE B, we find the same Barriers listed in FIGURE A, but the difference in both figures should be highlighted because the very relevant differences are found in FIGURE B. In FIGURE B water and other compounds are thrown from the Helicopter identified as (97) and (97-A), provided or not with all the items described in (18-A, 92, 93, 98, 99, 105, 106, 107, 108, 109, 109-A, 110), or by the special Aircraft identified as (97-B) provided or not with the items described in (19-A, 92, 93, 99, and/or 108, and/or 109, and/or 109/A), and that it is this water and/or other compounds that are always kept or protected in Flexible Capsules for Fire Extinction (22), and/or Hard Containers for Fire Extinction (22-A), and/or Spherical Containers (22-B), and/or if necessary also launching Fire Extinction Mortars (96 or 96-A), all represented and identified by rectangles (21), thus enabling, as well as with the use of new methods of launching with extremely accurate route and target direction, all together with the new natural compounds for immediate fire extinction for any kind of fires, the benefits, savings, performance, and speed in all operations and more than 800% of efficiency compared to previous methods shown in FIGURE A.

These high efficiencies that serve as basis for FIGURE B, were confirmed through several tests performed with the new equipment and methods herein claimed in this patent of invention.

This high efficiency confirmed by FIGURE B is clearly observed when the results presented and reached with the use of these new sets of technologies herein claimed and analyzed are compared to the method showed in FIGURE A. The big differences detected between both figures are presented below in TABLE no. 1:

TABLE 1

| | CURRENT | SALAMANDRAS |
|---|---|---|
| | TECNOLOGY | PROJECT |
| CONTROLLED | LOW | 100% |
| TRANSPOSITION OF BIAIS | | |
| TARGET ACCURACY | LOW | 100% |
| RATE | | |
| ISOLATION/COOLING | LOW | 100% |
| DOWN AND/OR | | |
| EXTINGUISHING RATE | | |
| FLOW LAUNCHING SPEED | 40 to 100 Km/h | ZERO |
| (HELICOPTERS) | | |
| FLOW DISPERSION | HIGH | ZERO |
| (LIQUID TO STEAM) | | |
| FLOW DECOMPOSITION | HIGH | ZERO |
| in STEAM X 1000° C. | | |
| FLOW REFLUXING | HIGH | ZERO |
| OPERATIONAL RISKS | LOW | ZERO |
| ON AIR | | |
| OPERATIONAL RISKS | HIGH | ZERO |
| ON LAND | | |
| VORTEX EFFECT | HIGH | ZERO |
| TIME TO REPLENISH | SLOW | IMMEDIATE |
| AIRCRAFTS | | |
| DISTANCE OF | RIVER/POND | AT THE |
| REPLENISHMENT | | ASSEMBLY |
| SOURCE | | BASE |
| SPEED/QUALITY/ | LOW | 100% |
| SECURITY OF THE | | |
| RESULTS | | |
| FRAGMENTATION OF | LOW | 100% |
| FIRE LOADS AND | | |
| RECOOLING (FUEL) | | |
| SAVINGS GENERATED TO | LOW | HIGH |
| THE FLORA/FAUNA/ | | |
| LOSSES/DAMAGES/LIVES | | |
| DEBRIS FROM FLOWS | — | ZERO |
| WITH OR WITHOUT | | |
| SUBSTRACTS THAT | | |
| FORM FOAM | | |
| TOXICITY | — | ZERO |
| ANTIFLAME | — | 100% |
| RECICLABLE | — | 100% |
| PERFORMANCE AND | LOW | 100% |
| WATER SAVINGS | | |
| SOIL RECOMPOSITION | LOW | HIGH |

FIGURE B is based and it is confirmed by the results of the tests already carried out with the new Flexible Capsules for Fire Extinction (22), with the Hard Containers for Fire Extinction (22-A) and/or (22-B), and with the Fire Extinction Mortars (96) and your Bottle-Type Container (96-A), in fire trials both in labs and in the field with fires in class A and B category.

During the performance of the several tests, only an initial volume of 62 liters of the Fire Extinction Flow Compound (24) and/or (146), and/or (147), with or without Crystals (40) was used as an initial standard, with changes to the construction processes of the capsules and of the containers, as well as the quantities and types of explosives or mixture of explosives and/or Chemical Compound that generates High Speed Pressure (41), the formats and quantities of the programmed fragilities (23), the granulometric compositions of the Propelled-Propellant Granules and/or Crystals (40), and fires with growing fuel load were simulated, analyzing the results and because of these results equipment and extinction methods were optimized.

To perform one of the several tests, the following containers were filled in: the Flexible Capsules for Fire Extinction (22), or the Hard Containers for Fire Extinction (22-A), with only 62 liters of the Fire Extinction Flow Compound (24) and/or (146), and/or (147), with or without Crystals (40) that were sprayed inside and over the focus of heat to extinguish the emulated fire immediately. This fire was simulated with a fuel load where different types of wood obtained from pallets that were disassembled were used. These pieces of wood were concentrated although supplied with plenty of oxygen, and radially distributed throughout a well ventilated area of twenty-two square meters with a total of 800 Kg of mass, plus 20 Kg of hand planes and saw dust, plus 20 liters of ethyl alcohol used as an agent to foster ignition and immediate propagation, plus 40 liters of diesel oil used as agent of maintenance and flame and heat transfer to the wood and that after having the fuel load lit up generated a convection of flames that reached 4 to 7 meters high.

The fuel loads burnt quickly and uniformly for three minutes; enough time for the transfer of fire to the wood and to incandesce it. At this moment, the only specific container that can hold 62 liters of the compound (24) and/or (146), and/or (147), with or without Crystals (40) was thrown inside and over the epicenter of the fire and the Starting Devices (31) were activated. The container blasted with the generation of high speed pressure obtained through the blasting reaction of the Chemical Compound that generates High Speed Pressure and the Propelled-Propellant Granules and/or Crystals (40) were thrown together with the spray of Fire Extinction Flow Compound (24) and/or (146), and/or (147), with or without Crystals (40) in a fully planned and controlled way, totally extinguishing the flames, dissipating the concentration of gases, promoting friction and re-cooling of the incandescent mass, lowering the temperature of the incandescent mass and of the environment from nearly 1500° C. to sheer 50° C. in tenths of a second, thus confirming the objectives herein proposed as new INVENTIONS. Everything properly filmed, photographed, and with the appropriate technical reports recorded for the necessary explanation and proof.

In another of the several tests run, each Container or Capsules were replenished with only 62 liters of the Fire Extinction Flow Compound (24) and/or (146), and/or (147), with or without Crystals (40) that were sprayed inside and over the focus of heat to extinguish the simulated fire immediately. This fire was simulated with a fuel load that included different types of wood from pallets that were disassembled. These pieces of wood were concentrated although supplied with plenty of oxygen, and radially distributed through a well ventilated area of twenty-four square meters with a total of 1200 Kg of Biomass, plus 20 Kg of hand planes and saw dust, plus 40 liters of ethyl alcohol used as agent of ignition and immediate propagation, plus 60 liters of diesel oil, and 20 liters of lubricant burnt fossil oil used as agent for maintenance and transfer of flames and heat for the wood that after having the fuel load lit up generated a whirlpool of flames that reached 5 to 8 meters high.

The fuel loads burnt quickly and uniformly for ten minutes; enough time for incandescing all the wood. At this moment, a first and specific container that can hold 62 liters of the compound (24) and/or (146), and/or (147), with or without Crystals (40) was thrown inside and over the epicenter of the fire and the Starting Devices (31) were activated. The container blasted with the generation of high speed pressure obtained through the blasting reaction of the Chemical Compound that generates High Speed Pressure and the Propelled-Propellant Granules and/or Crystals (40) were thrown together with the spray of Fire Extinction Flow Compound (24) and/or (146), and/or (147), with or without Crystals (40) in a fully planned and controlled way. But with this proportion of incandescent mass, the 62 liters that were sprayed extinguished only 90% of the simulated fire and fire started again. It was necessary to throw after two minutes a second 62 liter container with the compound (24) that blasted following the same process and this time fully extinguishing the flames, dissipating gas concentration, promoting friction and re-cooling of the incandescent Biomass, lowering the temperature of the incandescent Biomass and of the environment from nearly 1500° C. to sheer 50° C. in tenths of a second, thus confirming the objectives herein proposed as new INVENTIONS. Everything properly filmed, photographed, and with the appropriate technical reports recorded for the necessary explanations and proof.

The following schematics and conceptual designs although out of scale, were attached to promote a better understanding of this current patent.

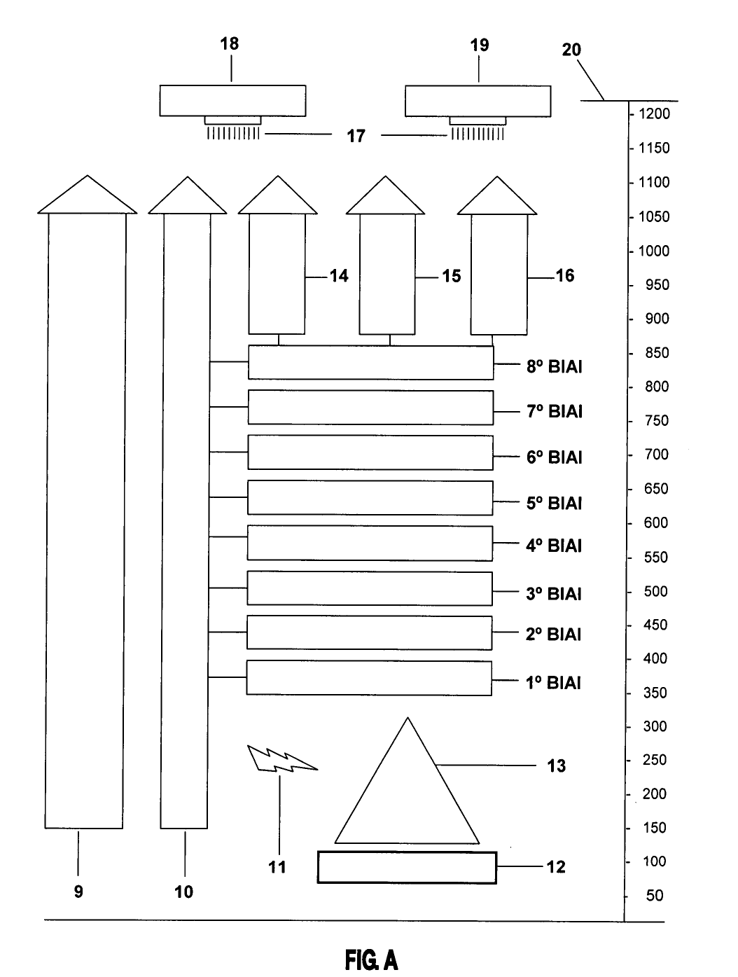

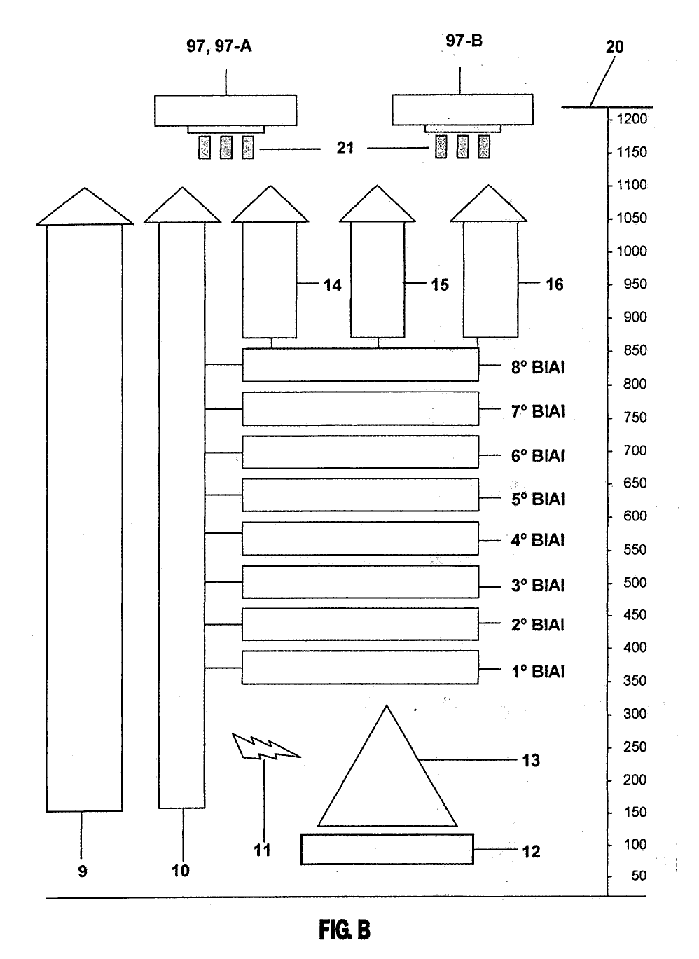

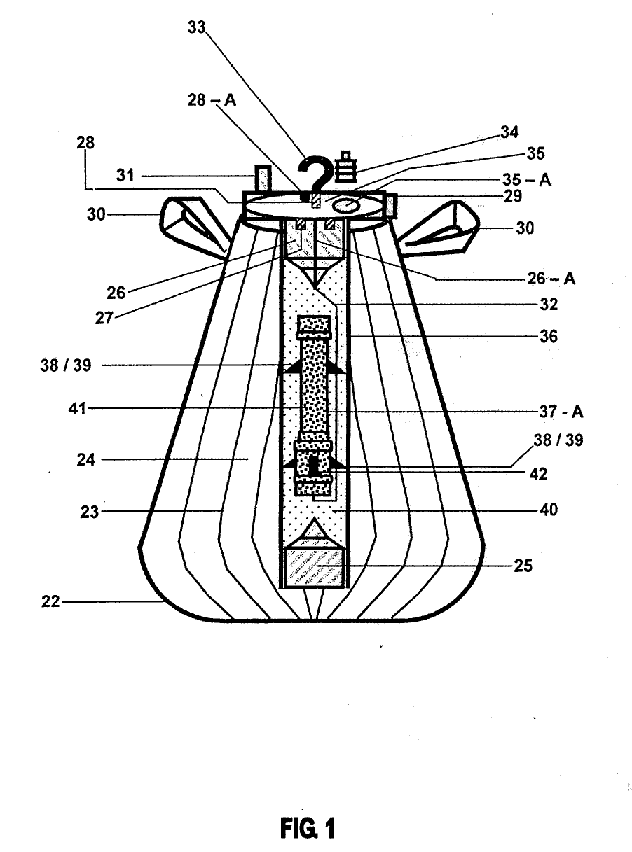

FIG. 1, that displays a schematic perspective of a cross-section of the equipment for fire extinction presented in this current patent and of the type Capsule (22), or Container (22-A) following the cone-trunk model with Support Belts and/or Guides and/or Transport Devices of programmed external longitudinal fragilities, equipped with its Option 1 Lid, its totally assembled Core Set and the Capsules (22) or container (22-A) already filled with the Fire Extinction Flow Compound and ready to use.

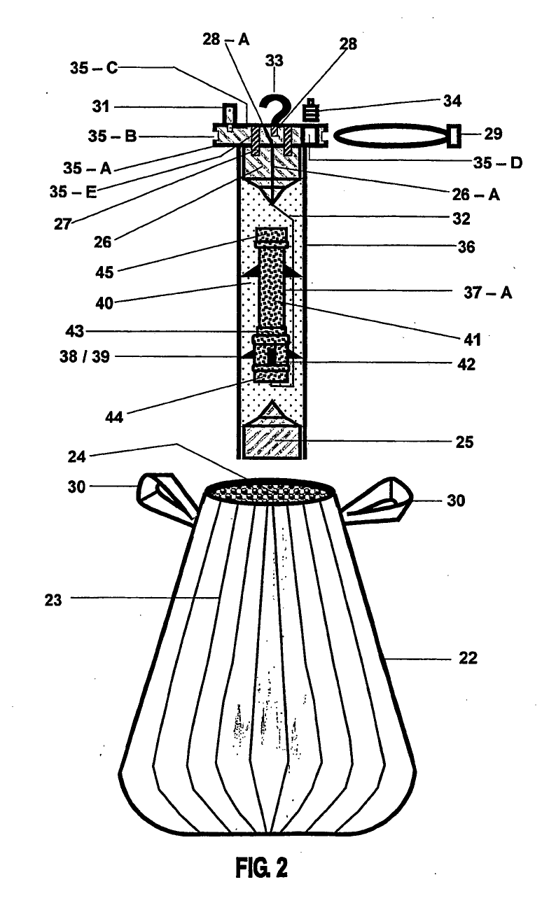

FIG. 2, that displays a schematic perspective of a cross-section of Option 1 Lid, of the Core Set, of the Capsule (22) supplied with the Fire Extinction Flow Compound following the trunk-cone model with programmed fragilities ready to receive or have the respective Lid applied with the Support Belts and/or Guides and/or Transportation Devices, plus the detail of a fastening Clamp, and/or adjustment clamp, and/or sealing clamp, and support and/or transportation hook plus its Core Set that is not introduced in the Capsules (22), or Containers (22-A), or (22-B).

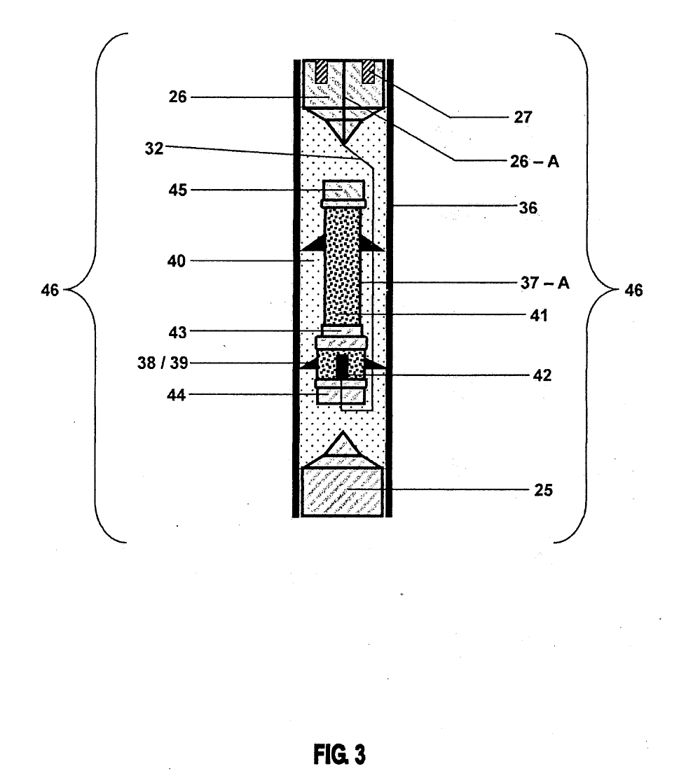

FIG. 3, that displays a schematic side view of the Core Set equipped with the Container to hold Explosives and/or mixture of explosives (52-2) with Propelled-Propellant Granules and/or Crystals, Upper Gäa-Kibele Vectorizer and Lower Gäa-Kibele Vectorizer ready to use whenever fastened to its respective Lid(s), introduced and connected to their respective Capsules (22), or Containers (22-A), or (22-B).

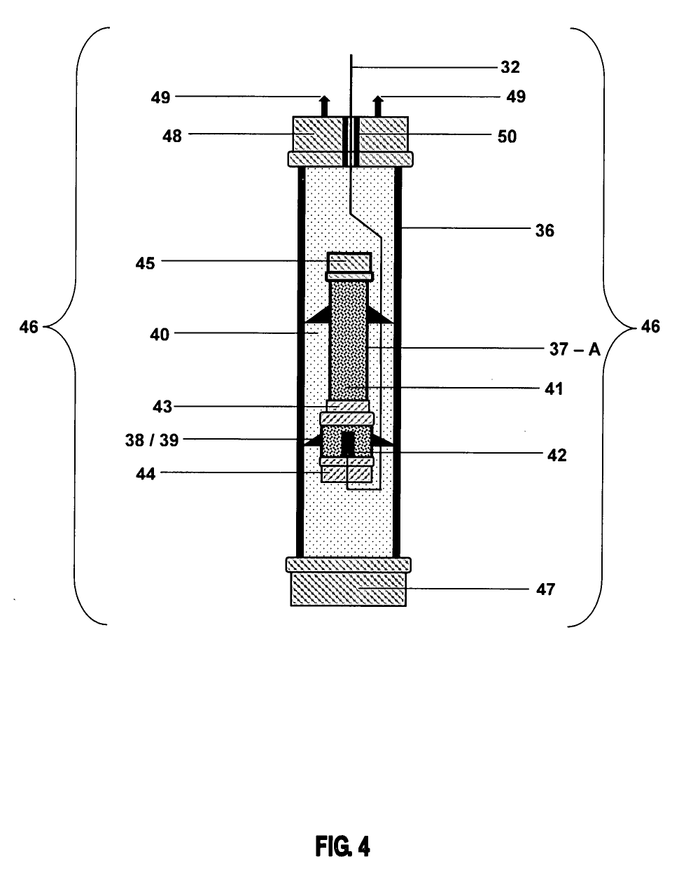

FIG. 4, that displays a schematic view on a cross-section of the Core Set with its Container to hold Explosives and/or mixture of explosives (52-2) with Propelled-Propellant Granules and/or Crystals with the choice of closing with Lower and Upper Caps with or without passage hole, and with or without pins on the upper Cap to fit and/or fix on their respective Lids and for the Core Set.

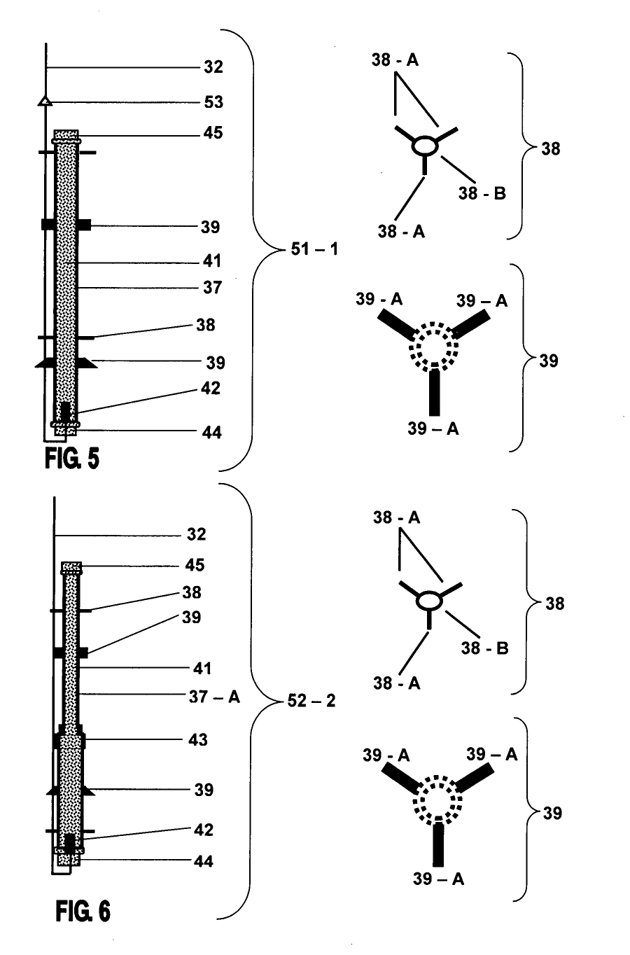

FIG. 5, that displays a schematic cross-section of Container to hold Explosives and or mixture of explosives (51-1), in a cylindrical shape with its Axle limiting Guides fixed with a rectangular, triangular, or trapezoidal shape, its Axle Limiting Rings, its Explosion-Train, delay Fuse or not, Explosives, and/or mixture of explosives; front view of the diverse Driver for Ignition with its flexible cone-type sealing adaptor with a central passage hole, in a cross-section, frontal view of the upper and lower Caps that belong to the Container (51-1), and with details on the upper view of the Axle Limiting Ring in a format of ring with three threads, and details of the Axle Limiting guides with three fins.

FIG. 6, that displays a schematic cross-section of, a Container to Hold Explosives and/or mixture of explosives (52-2) on a staggered cylindrical shape, its Axle Limiting Guides on a rectangular, triangular, or trapezoidal shape, its Axle Limiting Rings, its Explosion-Train, delay Fuse or not, Explosives, and/or mixture of explosives, and frontal view of the diverse Driver for Ignition, Upper and Lower Caps that belong to Container (52-2), a cross-section of the Staggered Reducing Adaptor, and with details on an upper view of the Axle Limiting Ring on a three thread ringed shape, and details of the Axle Limiting Guides with three fins.

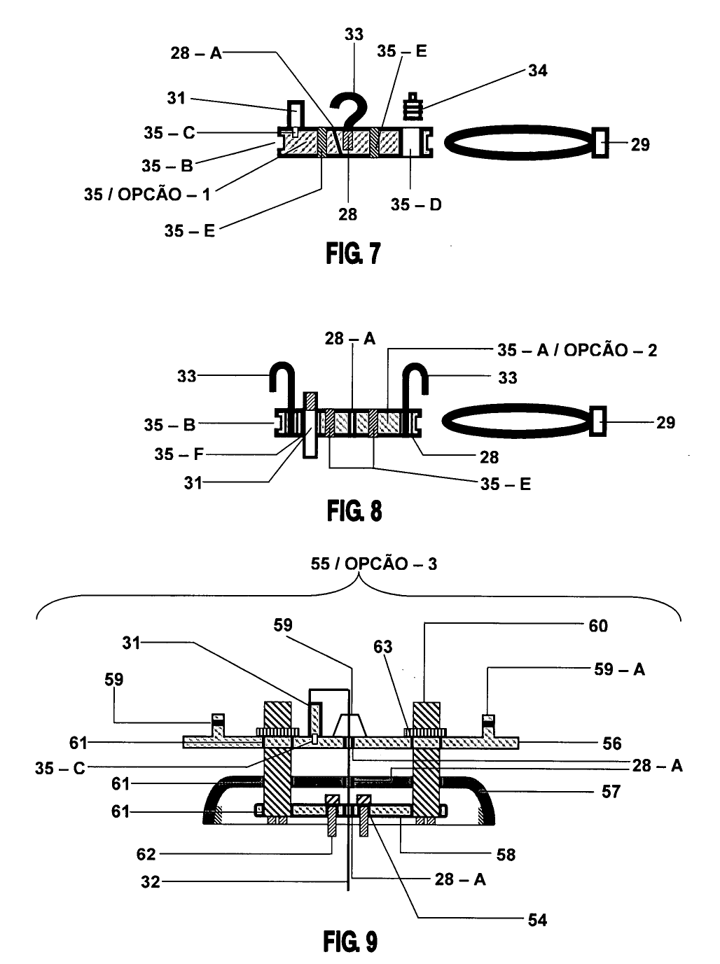

FIG. 7, that displays a schematic cross-section of Option 1 Lid in a simplified one-piece structure and to be deployed in Capsules (22), and/or Containers (22-A), with details on the Shoulder for Fastening and/or Adjusting, and/or Sealing the Clamps, with Support and/or Transportation Hooks with an Opening for filling the several containers, with Starting Devices, with a Screw Cap with a passage Hole for the different Driver(s) for ignition, and with passage holes or notches for fastening screw(s) for the Upper Vectorizers, Core Sets Caps for the Adaptors with external and/or internal threads with or without calibrating valves, Upper Cap with or without passage hole, and with or without fitting pins and with details on the Fastening and/or Adjustment, and/or Sealing Clamps with or without (73).

FIG. 8, that displays a schematic cross-section of Option 2 Lid, a variable of Option 1 Lid, with the Shoulder for Fastening, and/or Adjusting, and/or Sealing the Clamps, the Fastening and/or Adjustment, and/or Sealing Clamps with Support and/or Transportation Hooks, with Starting and Detonating Device(s) introduced and transfixed on the Lid with a passage hole for the different Drivers for Ignition, and with fastening holes through screws for the Adaptors with external and/or internal threads with or without calibrating valves, and for the Upper Vectorizer or Upper Cap with or without passage hole and with or without fitting pins and with details on Fastening and/or Adjustment, and/or Sealing Clamps, with or without (73).

FIG. 9, that displays a schematic cross-section of Option 3 Lid in a set of Lids to be used in Capsules (22) or in Containers (22-A) with the first lid defined as Adjustable Lid of Contention, Support, and Transportation; the second Lid in a threading model transfixed by the Disk for Fastening, Adjusting, and Contention with Starting, and/or Detonating Device(s) ready to receive/fasten via screws the Core Set leaving the Lid Set connected and adjusted via tightening, adjusting, and fastening nuts, ready to close the already replenished Capsules (22), or Containers (22-A), with or without (73).

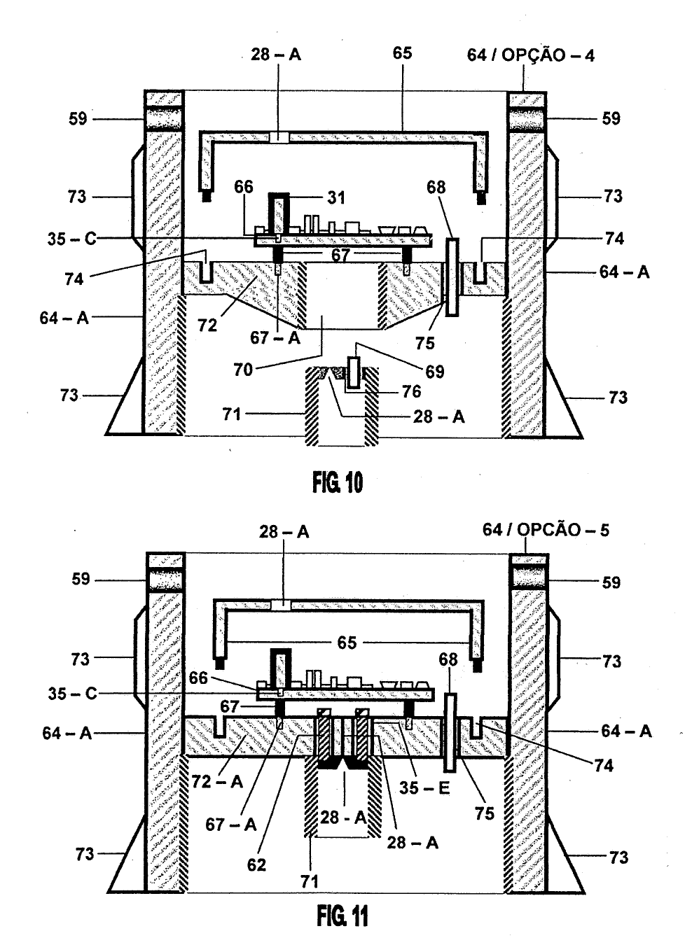

FIG. 10, that displays a schematic cross-section of Option 4 Lid to be used in Capsules (22) or in Containers (22-A) with a side edge of the body of the lid provided with internal threads, with a reinforced area and central opening threaded on the Body of the Lid, with Support and/or Transportation Holes, details on the Adaptor with internal and external thread and a calibrating valve, and for fastening the Core Set with a Conical hole for the passage of Different Drivers for Ignition for fastening the Core Set on the Lid via threads with Fastening and Holding Support for the Electronic Board(s) and their component(s) (s) and their component(s), with the Electronic Board(s) and their component(s) (s) and their component(s) and Starting, and/or Detonating Device(s) with a Removable Lid for the Protection of the Electronic Board(s) and their component(s) (s) and their component(s) on switched off position and with a passage hole for the Drivers with an Opening to introduce the Adaptor and/or Core Set and/or Fire Extinction Flow Compound or other compounds with calibrating valve for the Capsules (22), or Containers (22-A), and with notches on the Lid for fins or wings, or guidance spoilers, or for male and female target route guide set and set-up for the ignition of the Starting and/or Detonating Device(s), that are provided with rod(s) and speed control device(s) for the Capsules (22), or Containers (22-A), with or without (73).

FIG. 11, that displays a schematic cross-section of Option 5 Lid to be used in Capsules (22) or in Containers (22-A) with a side edge of the body of the lid provided with internal threads and without a central opening on the Body of the Lid with Support and/or Transportation Holes, with an Adaptor with internal and external threads fixed on the Lid via screw(s), with a conic hole for the passage of the Different Drivers for Ignition, so that the Core Set can be connected on the Lid, with a Fastening Support and support for the Electronic Board(s) and their component(s)(s) and their component(s), with the Electronic Board(s) and their component(s)(s) and their component(s), and Starting, and/or Detonating Device(s) with a Removable Lid for the Protection of the Electronic Board(s) and their component(s)(s) and their components on switched off position and with a passage hole for the Drivers, with holes for screws, with Calibrating Valve for the Capsules (22), or Containers (22-A), and with notches on the Lid for Fins, Wings or Guidance Spoilers, or for the Set of male and female Insertions for the target route and for starting the ignition of the Starting, and/or Detonating Device(s), with a rod(s) and Device(s) to control the speed for the Capsules (22), or Containers (22-A) with or without (73).

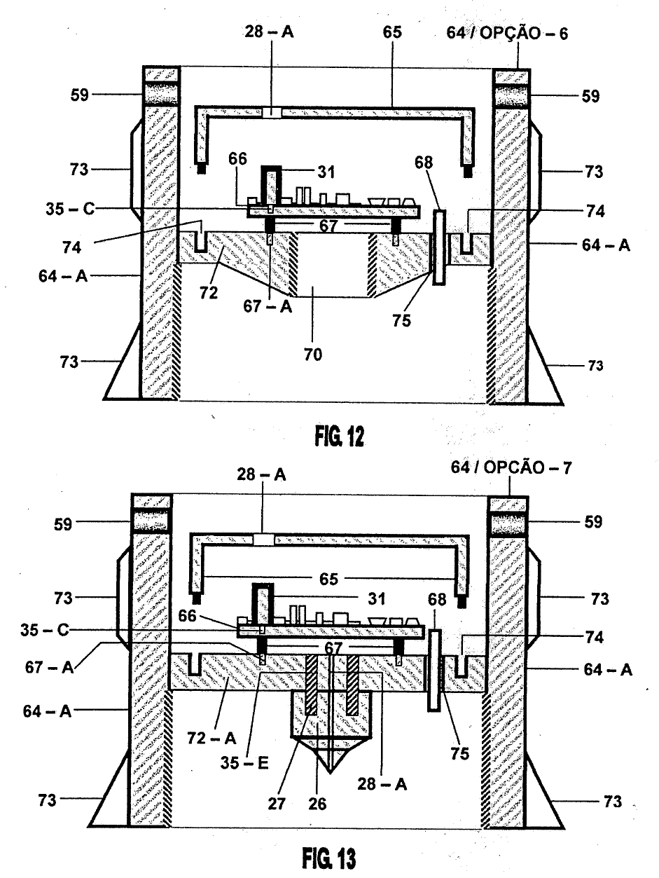

FIG. 12, that displays a schematic cross-section of Option 6 Lid to be used in Capsules (22) or in Containers (22-A) with a side edge of the body of the lid provided with internal threads with a reinforced central opening threaded on the Body of the Lid with Support and Transportation Holes with notches for fixation via threads of the Core Set on the Lid with a Fastening Support and support for the Electronic Board(s) and their component(s), with the Electronic Board(s) and their component(s) with a Removable Lid for the Protection of the Electronic Board(s) and their component(s), with a passage hole for the Drivers on switched off position and with Starting Devices with calibrating valve for the Capsules (22), or Containers (22-A), and with notches on the Lid for the Guidance Fins or Wings, or spoilers, or for the male and female Set for target route and for starting the ignition on the Starting and/or Detonating Device(s), with a rod(s) and Device(s) to control the speed for the Capsules (22), or Containers (22-A) with or without (73).

FIG. 13, that displays a schematic cross-section of Option 7 Lid to be used in Capsules (22) or in Containers (22-A) with a side edge of the body of the lid provided with internal threads and without a central opening on the Body of the Lid with Support and/or Transportation Holes, with Upper Gäa-Kibele Vectorizer fastened via screws to the center of the Lid for fastening the Core Set on the Lid, with passage hole for the Different Drivers for Ignition, with Fastening Support and fixation of the Electronic Board(s) and their component(s) with the Electronic Board(s) and their component(s) with a Removable Lid for the Protection of the Electronic Board(s) and their component(s), with a passage hole for the Drivers on switched off position and with Starting Devices with calibrating valve for the Capsules (22), or Containers (22-A), and with notches on the Lid for the Driving Fins and Spoilers, or for the male and female Set of Insertions of the target route and for starting the ignition on the Starting and/or Detonating Device(s), with a rod(s) and Device(s) to control the speed for the Capsules (22), or Containers (22-A), with or without (73).

FIG. 14, that displays a schematic cross-section of Option 8 Lid to be used in Capsules (22) or in Containers (22-A or 22-B) with a lower side edge of the body of the lid provided with external threads, with reinforced lower area and central opening threaded on the Body of the Lid, with external threads for fixation of containers on the lower external edge of the Lid, with Support and Transportation Holes, details of the Adaptor with internal and external threads plus a calibrating valve to connect the Core Set, Conic hole for the passage of the Different Driver(s) for Ignition, for the fixation via threads of the Core Set on the Lid, with Fastening and Support for the Electronic Board(s) and their component(s), with the Electronic Board(s) and their component(s) with a Removable Lid for the Protection of the Electronic Board(s) and their component(s), with a passage hole for the Drivers on switched off position, with an opening to introduce the Adaptor or the Core Set, or the Fire Extinction Flow Compound or other compounds, with calibrating valve for the Capsules (22), or Containers (22-A), or (22-B), and with notches on the Lid for the Drivers of the Fins or Spoilers, or for the male and female Set of Insertions of the target route and for starting the ignition on the Starting and/or Detonating Device(s), with a rod(s) and Device(s) to control the speed for the Capsules (22), or Containers (22-A), or (22-B) with or without (73).

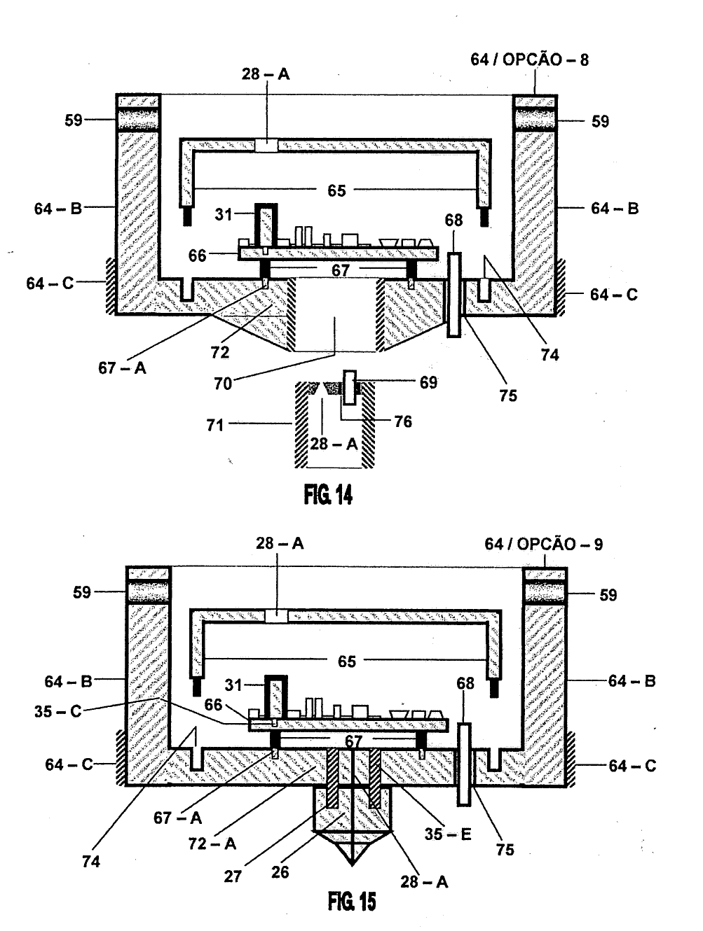

FIG. 15, that displays a schematic cross-section of Option 9 Lid to be used in Capsule(s) (22) or Containers (22-A or 22-B) with a lower side edge of the body of the lid provided with external threads and without a central opening on the Body of the Lid with external thread for fastening the Capsules (22), or Containers (22-A), or (22-B) on the lower external edge of the Lid, with Support and/or Transportation Holes, with Upper Gäa-Kibele Vectorizer fastened via screws to the center of the Lid for fastening the Core Set on the Lid, with passage hole for the Different Drivers for Ignition, with Fastening Support and fixation of the Electronic Board(s) and their component(s) with the Electronic Board(s) and their component(s) with a Removable Lid for the Protection of the Electronic Board(s) and their component(s), with a passage hole for the Drivers on switched off position and with Starting Devices with calibrating valve for the Capsules (22), or Containers (22-A), or (22-B), and with notches on the Lid for the Guidance Fins and Spoilers, or for the male and female Set of Insertions of the target route and for starting the ignition on the Starting and/or Detonating Device(s), with a rod(s) and Device(s) to control the speed for the Capsules (22), or Containers (22-A), or (22-B) with or without (73).

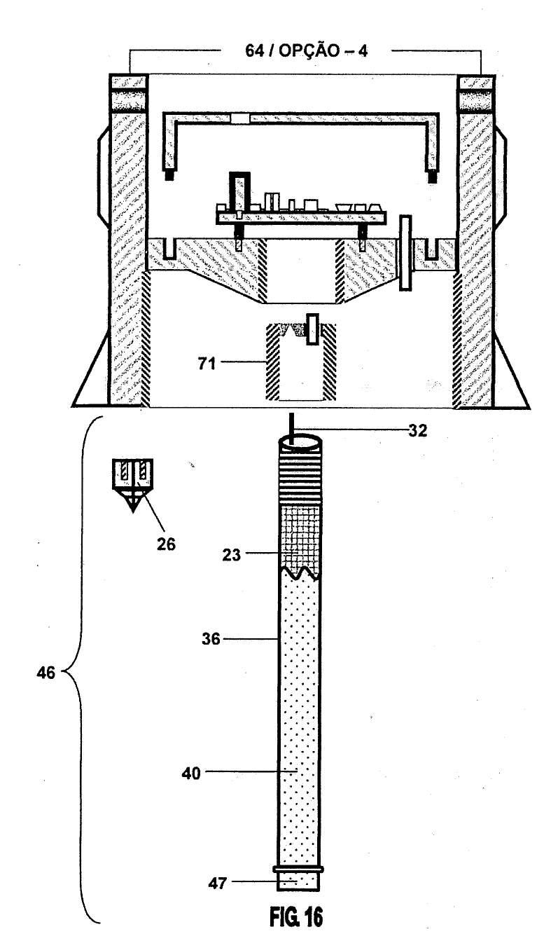

FIG. 16, that displays a schematic cross-section of the components to be assembled: Option 4 Lid, with side edge of the body of the lid with internal threads, the Body of the Core Set in a cylindrical format with external upper thread, with or without programmed fragilities, with details of the Propelled-Propellant Granules and/or Crystals inside the Core Set with the different Driver(s) for Ignition, the Adaptor with internal and external threads, with or without calibrating valve and conic passage hole for the Drivers, or passage holes for the Core Set, for the fixation of the Core Set on the Lid, cross-section of the Upper Gäa-Kibele Vectorizer, Lower Core Set Cap fastened on the lower part of the Core Set, and with notches on the Lid for the Guidance Fins, Wings, and Spoilers, or for the male and female Set of Insertions of the target route and for starting the ignition on the Starting and/or Detonating Device(s), with a rod(s) and Device(s) to control the speed for the Capsules (22), or Containers (22-A), or (22-B).

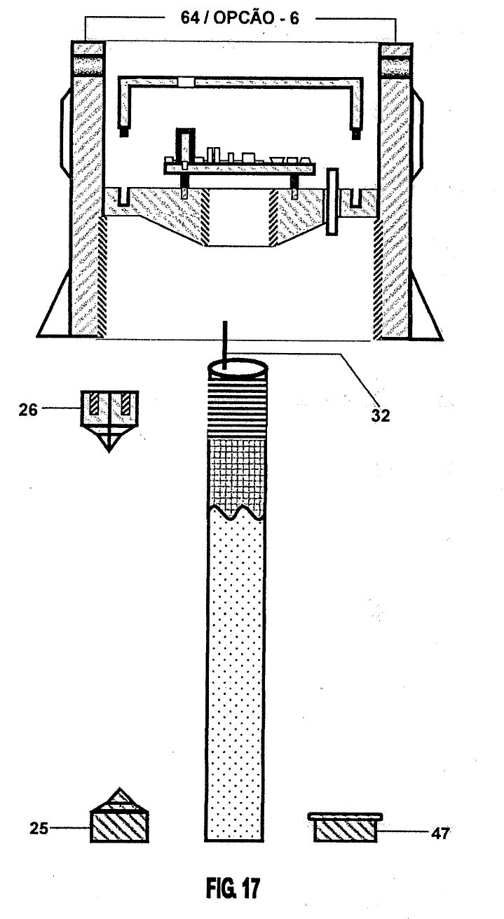

FIG. 17, that displays a schematic cross-section of the components to be assembled: Option 6 Lid, the Body of the Core Set in a cylindrical format with external upper thread, with programmed fragilities, and with details on the Propelled-Propellant Granules and/or Crystals inside the body of the Core Set. with the different Driver(s) for Ignition, details on the Upper and Lower Gäa-Kibele Vectorizer, placed at the side of the Core Set body, and with notches on the Lid for the Guidance Fins, Wings, and Spoilers, or for the male and female Set of Insertions of the target route and for starting the ignition on the Starting and/or Detonating Device(s), with a rod(s) and Device(s) to control the speed for the Capsules (22), or Containers (22-A), or (22-B) and with details on the Lower cap placed at the side of the Core Set body.

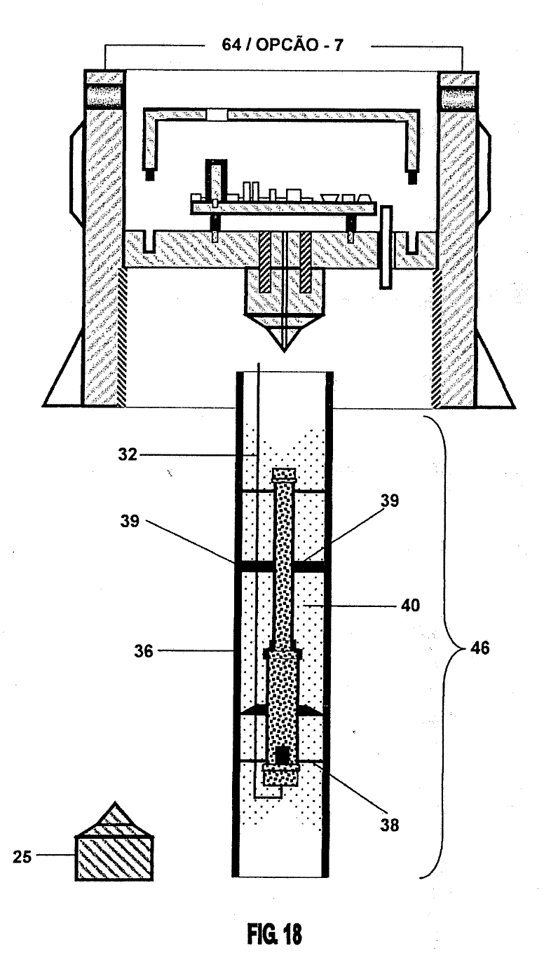

FIG. 18, that displays a schematic cross-section of the components to be assembled: Option 7 Lid, with the Body of the Core Set in a cylindrical format to be assembled equipped with Container to hold Explosive(s) and/or mix of Explosive(s) (52-2), in a staggered cylindrical format, with Axle Limiting Guides and Axle Limiting Rings, the different Driver(s) for Ignition, the delay Fuse(s) or not and/or Explosion Train, details on the Propelled-Propellant Granules and/or Crystals, Upper Gäa-Kibele Vectorizers fastened on the body of the Lid with screws, and details on the Lower Vectorizer placed at the side of the Core Sets body.

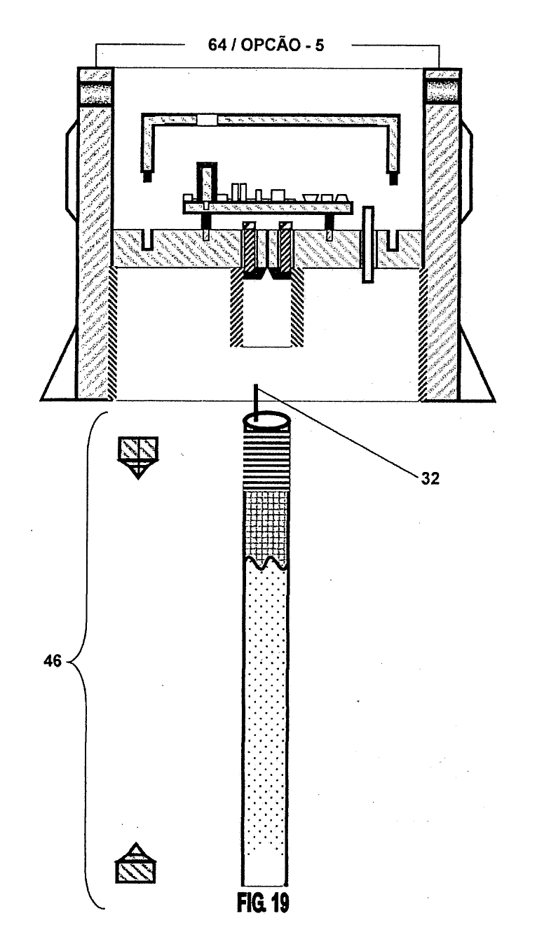

FIG. 19, that displays a schematic cross section of the components to be assembled: Option 5 Lid with the Body of the Core Set in a cylindrical format with upper external thread, programmed fragilities with details on the Propelled-Propellant Granules and/or Crystals different Drivers for Ignition, and details Upper and Lower Gäa-Kibele Vectorizers placed at the side of the body (36) of the Core Set.

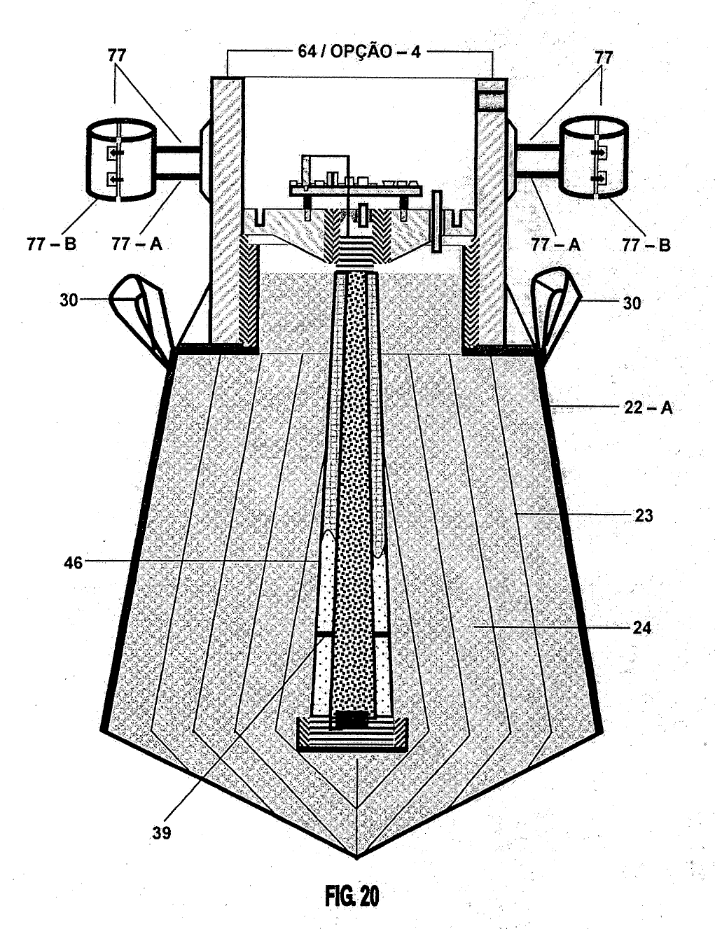

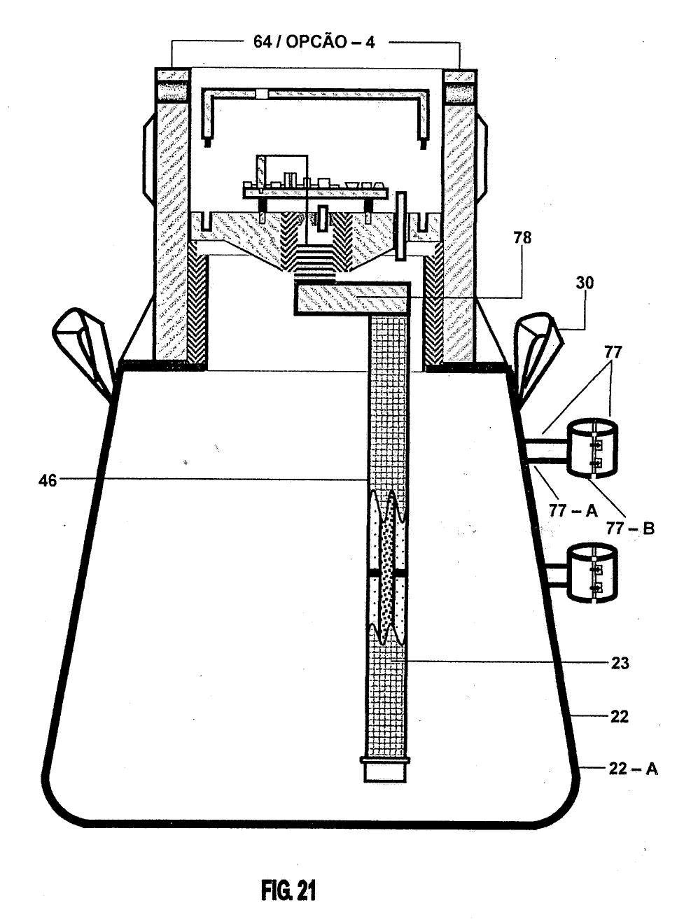

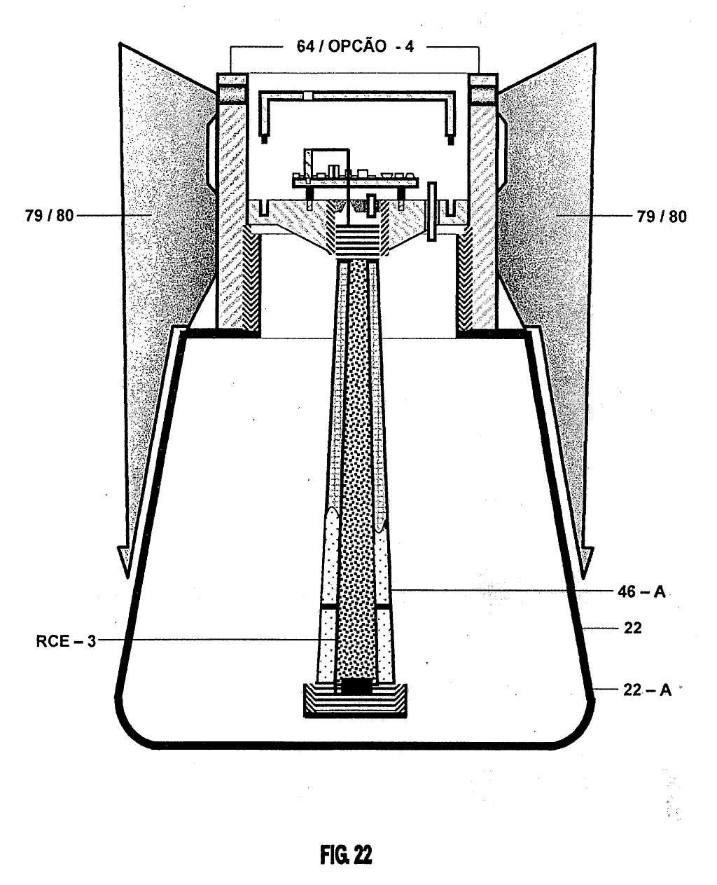

FIG. 20, that displays a schematic cross-section of the fire extinguishing equipment assembled of the Container (22-A) or Capsules (22) type in a cone-trunk model with a conic base and with support Belts, and/or Guides and/or Transportation filled with Fire Extinction Flow Compound with programmed fragilities, with Option 4 Lid, male and female Set of Insertions for the target route and starting device for the ignition of the Starting and/or Detonating Device(s) with a rod(s) and speed control Device(s) for the Capsules (22), or Containers (22-A), Core Set in a cone-trunk format with upper and lower threads, Lower cap for thread, and details on programmed fragilities, details on Propelled-Propellant Granules and/or Crystals, with Container (RCE-3)—Container to hold Explosives in a cone-trunk format with Axle limiting Guides, or Axle limiting Rings with Explosive(s) and/or mix of Explosive(s), with delay Fuses or not—Explosion Train, with different Drivers for ignition, all introduced into the Adaptor with internal and/or external threads with or without calibrating valve that fasten them on the Lid, and with lower Cap with thread on the lower side of the Core Set, without removable Lid for the Protection of the Electronic Board(s) and their component(s) with a passage hole for the Drivers, ready to use.

FIG. 21, that displays the schematic cross-section of the assembled extinguishing equipment to be used in Capsules (22) or in Containers (22-A or 22-B) in a cone-trunk model on a straight base with rounded corners and equipped with Option 4 Lid, and Hard Containers with Supporting Belts and/or guides, and/or Transportation, male and female Set of Insertions for the target route and the start-up of the ignition of the Starting and/or Detonating Device(s), with a rod(s) and speed control Device(s) for the Capsules (22), or Containers (22-A) or (22-B), with the Core Set with programmed fragilities, with Container (51-1), filled with explosives and/or mixture of explosives with Axle limiting Rings, delay Fuses or not—Train of Explosion, Different Drivers for Ignition, all in the cylindrical model, decentralized through the Decentralizing Adaptor for the Core Set, all fixed on Option 4 Lid, with removable Lid for the Protection of the Electronic Board(s) and their component(s) with a passage hole for the Drivers and on switched-off position, and without being filled with the Fire Extinction Flow Compound.

FIG. 22, that displays a schematic cross-section of the fire extinguishing equipment assembled in a Container (22-A or 22-B), or in Capsule (22) in a cone-trunk model with straight base and rounded corners, with Option 4 Lid, with the Core Set and programmed fragilities, with Lower cap provided with threads, (RCE-3)—Container to hold Explosives or Chemical Compound that generates High Speed Pressure and/or mixture of explosives all in the cone-trunk format fixed on Option 4 lid with its removable Lid for the Protection of the Electronic Board(s) and their component(s) provided with a passage hole for the drivers and on switched-off position, with target guidance fin(s), or wing(s), or spoiler(s) and without being filled with the Fire Extinction Flow Compound.

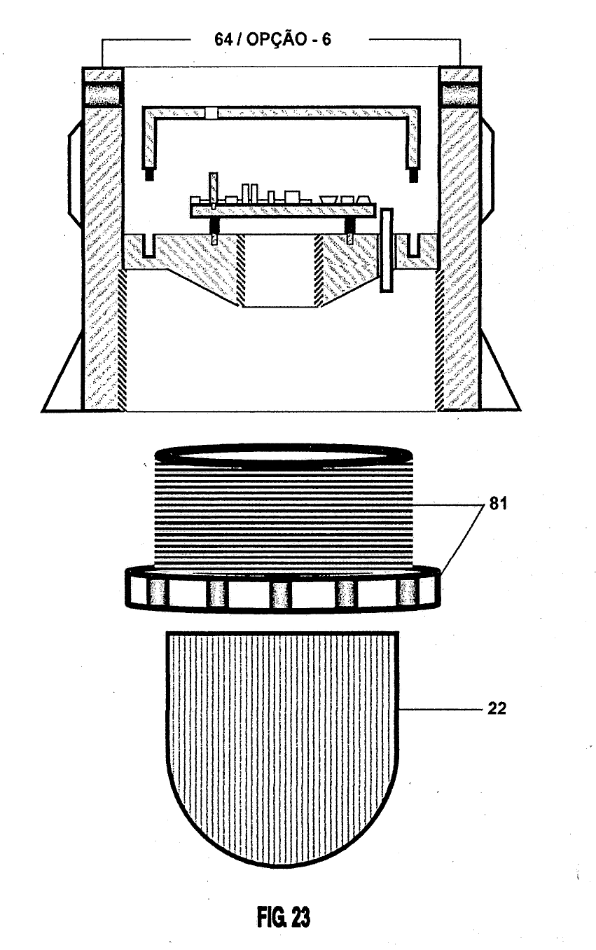

FIG. 23, that displays the schematic cross-section of the fire extinguishing equipment in this current patent with a Flexible Capsule (22) with programmed fragility to be vulcanized or connected still without Fire Extinction Flow Compound, and Option 6 Lid to be used in Flexible Capsules (22) with Special Vulcanized Adaptor with external threads and smooth internal area to vulcanize the Flexible Capsule (22).

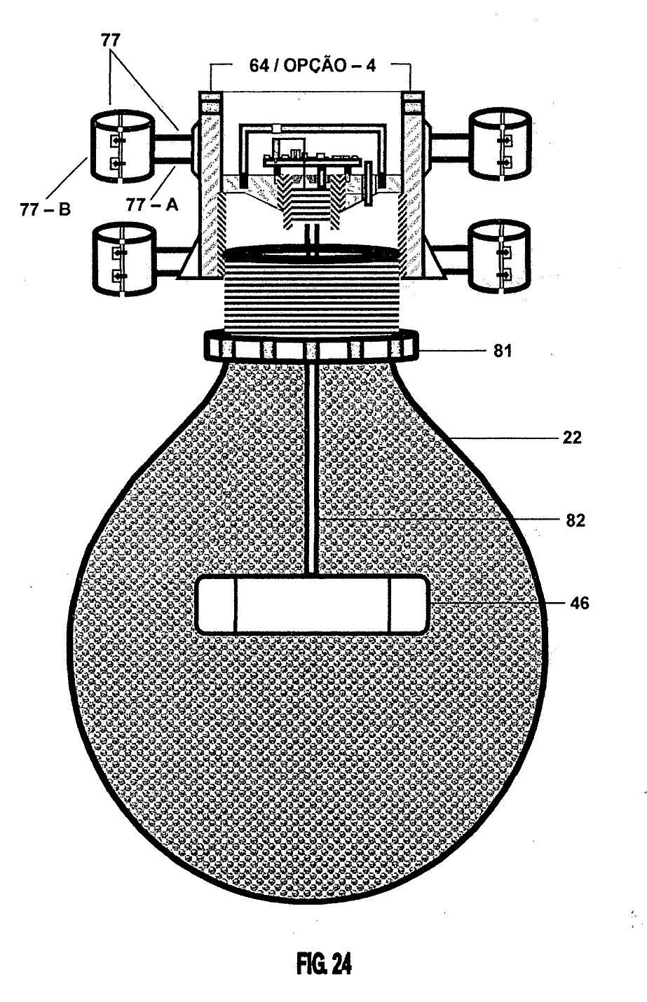

FIG. 24, that displays a schematic cross-section of the extinction equipment in this current patent already filled with the Fire Extinction Flow Compound, with Support Rod for the Core Set(s), Capsule Flexible (22) with programmed fragilities on a cylindrical format with Core Sets assembled on the Horizontal and Central position, and Option 4 Lid with male and female Set of Insertions for the target route and for the start-up of the ignition of the Starting and/or Detonating Device(s), with a rod(s) and speed control Device(s) for the containers (22-A or 22-B), to be used in Flexible Capsules (22) and in Containers (22-A or 22-B) all connected to the Lid through an Special Adaptor that can be Vulcanized, with external Threads and smooth internal area, and with its removable Lid for the Protection of the Electronic Board(s) and their component(s) with passage hole for the Drivers on switched on position, ready to use.

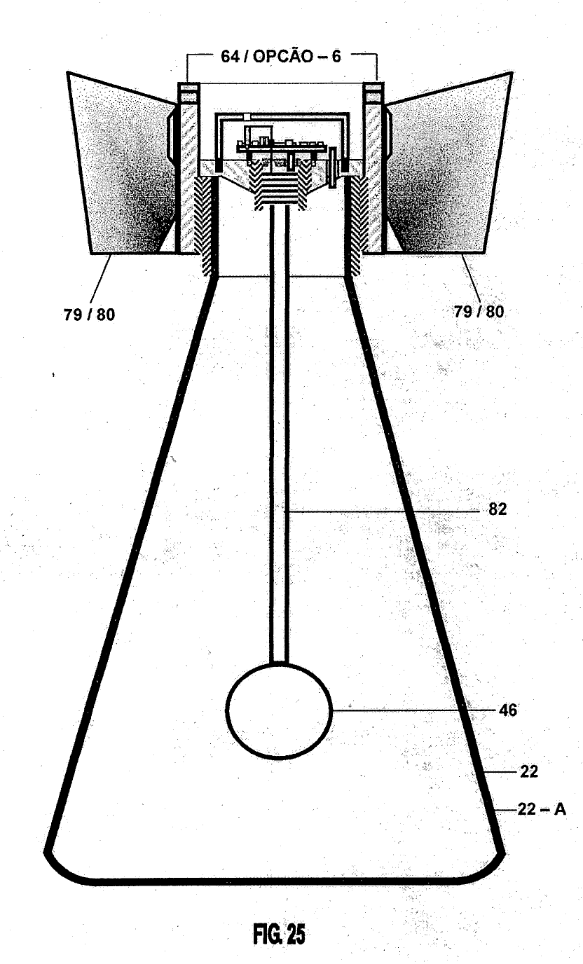

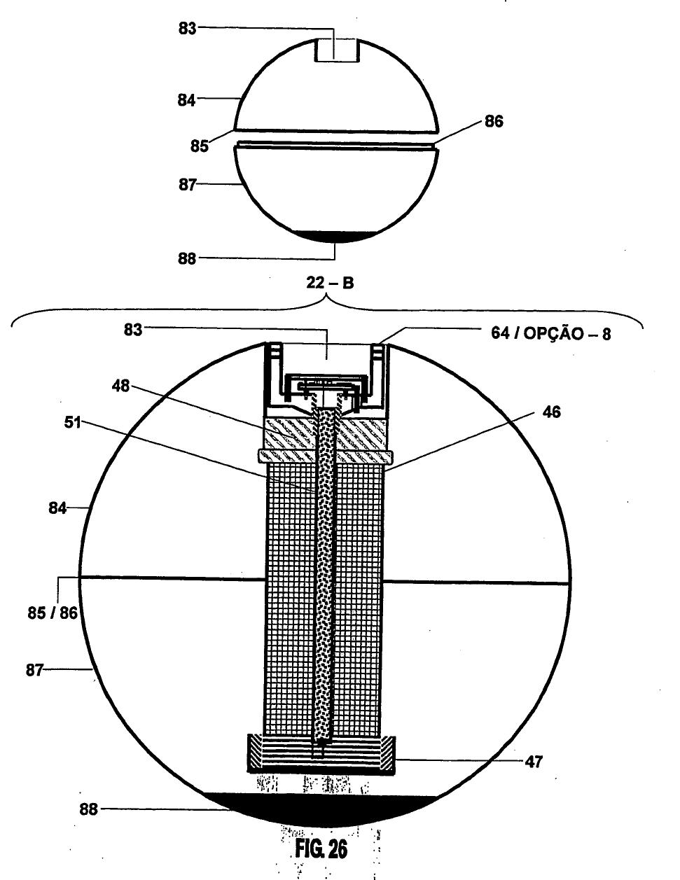

FIG. 25, that displays a schematic cross-section of the extinction equipment in the current patent in a cone-trunk model with straight base and rounded corners, with Support Rod for the Core Set, Core Set without programmed fragilities in a spherical model connected via Support Rod to Option 6 Lid, with its removable Lid for the Protection of the Electronic Board(s) and their component(s) with passage hole for the Drivers on switched-on position, and also to be used in Flexible Capsules (22) or in Containers (22-A or 22-B) with target guidance fins/wings/spoilers, and without being filled with the Fire Extinction Flow Compound.

FIG. 26, that displays a schematic cross-section of the fire extinguishing equipment in the current patent as a Container (22-B) in a spherical closing model, with the Core Set including programmed fragilities in a cylindrical model, with Container (51-1) filled with Explosive(s) and/or mix of Explosive(s), Core Set with Upper cap glued, and Lower cap with internal thread, Option 8 Lid, but without external threads on its lower edge, with its removable Lid for the Protection of the Electronic Board(s) and their component(s) including a passage hole for the Drivers on switched on position, with Plummet Maintenance Counterweight to be used in Containers (22-B), and without being filled with fire Extinction Flow Compound and with details on the upper spherical part, of the lower spherical part, and of its male and female accurate fitting systems.

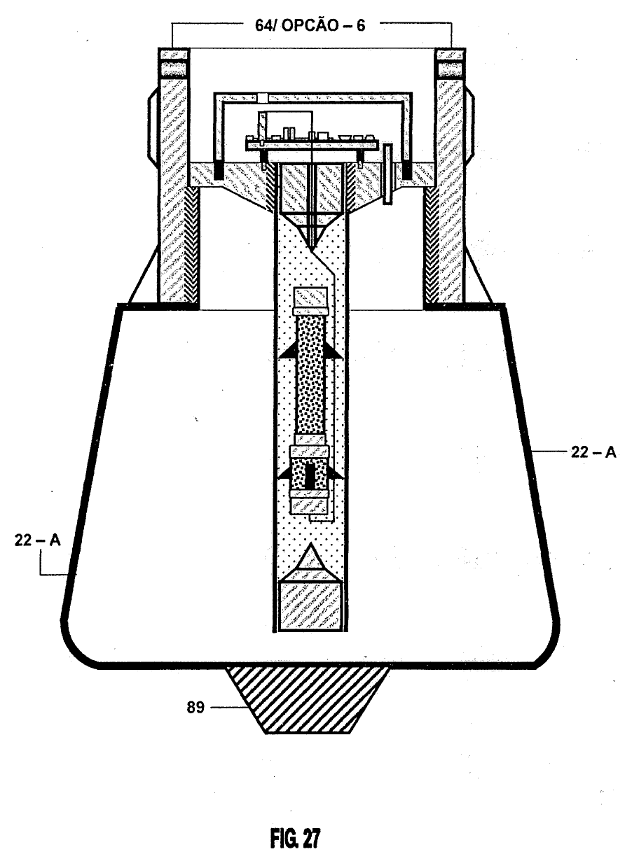

FIG. 27, that displays a schematic cross-section of the fire extinguishing equipment in the current patent as a Hard Container (22-A) in a cone-trunk model with straight base, with lower rounded corners, and without being filled with Fire Extinction Flow Compound, with Core Set in a cylindrical model, with Container to hold Explosive(s) and/or mix of Explosive(s) (52-2) filled with Explosive(s) and/or mix of Explosive(s), with Upper and Lower Vectorizers, with Propelled-Propellant Granules and/or Crystals, with Option 6 Lid to be used eventually in Flexible Capsules (22), more specifically in Hard Containers (22-A) with its removable Lid for the protection of the Electronic Board(s) and their component(s) including a passage hole for the Drivers on switched-on position, and with a Hard Cork(s) with or without whole jacket(s), and semi-jackets, and/or of other self-fastening materials and/or including other combined materials, and/or for fixation on the soil, and/or for different drills, with or without metal jacket, or combined semi jackets, and/or for an eventual fixation on the soil of the Capsules (22), or Containers (22-A) or (22-B) connected on the lower area of the Capsules (22), or Containers (22-A) or (22-B).

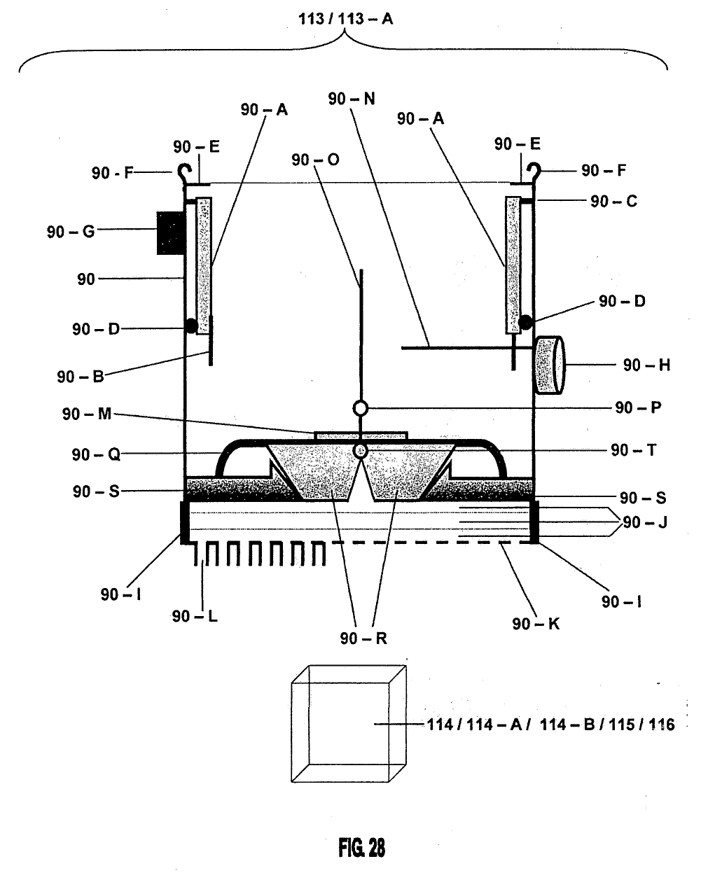

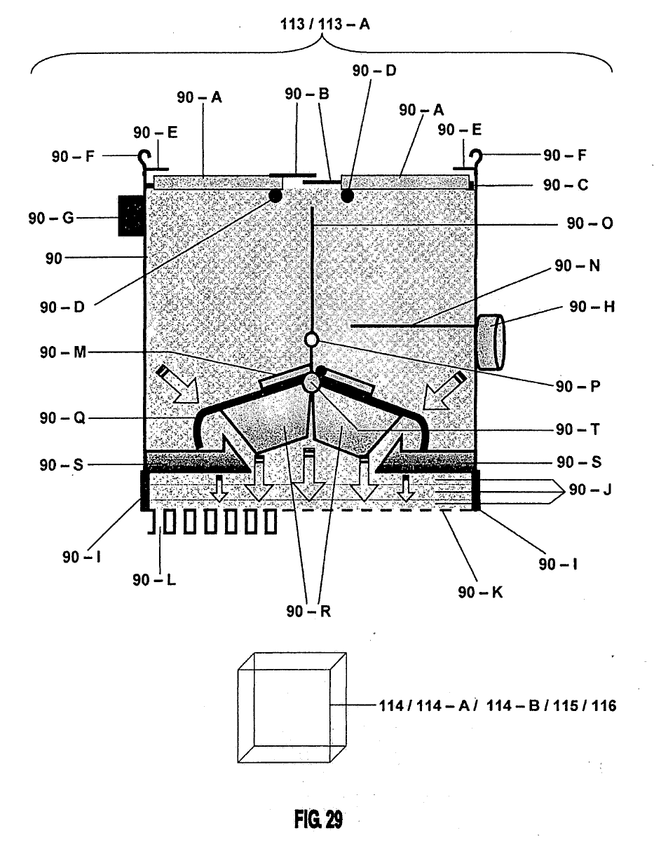

FIG. 28, that displays a schematic cross-section of a Refractory or Special Articulated Container (113 or 113-A) in the current patent, with a cable to run the opening and/or closure of the Valve(s) with a mechanical articulated arm for the opening and/or closure of the Valve(s), with an adjusting ring and fixation of the cable and/or arm with a sealing hinge for the Valve(s), with structural guide for the Valve(s), with a supporting and sealing, and fitting base for the Valve(s), with Valve(s), holes, and or water flushing tubes, ready to be replenished with water or other extinguishing compounds, with supporting, and/or fixation, and/or transportation Hooks with a counterweight for immersion, with a mechanical, electronic, electric or hydraulic motor, with fitting pins for the sprayers, with sprayers with holes on the side and lower areas, with spraying holes only on the lower area, with its Overlaying Automatic Floating Lids open including Floating Buoys, sealing Rims, Running or closing Valve motor or Cable, sealing hinge for the Valves, structural guide of the Valves, with Control Valves for Closed Spray, and with its valves in a closed state, and with details on the components that may or not be coupled whenever necessary, protection box for output pipe(s), with Mobile Reel, with water Pump(s), Special Hoses, and Nozzle or open/close spray valve.

FIG. 29, that displays a schematic cross-section of the same Refractory or Special Articulated Container (113 or 113-A) in the current patent, but highlighting the Control Valves for Spray in an Open state, with arrows pointing to the position of water flush or the flushing of other extinction compounds, and with details on the components that may or not be coupled whenever necessary, protection box for output pipe(s), with Mobile Reel, with water Pump(s), Special Hoses, and Nozzle or open/close spray valve.

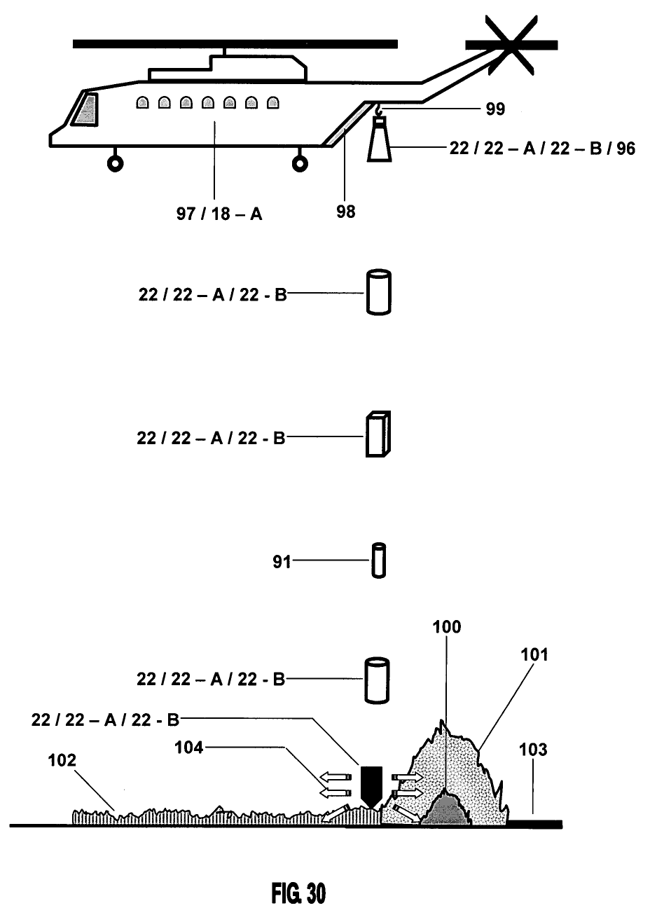

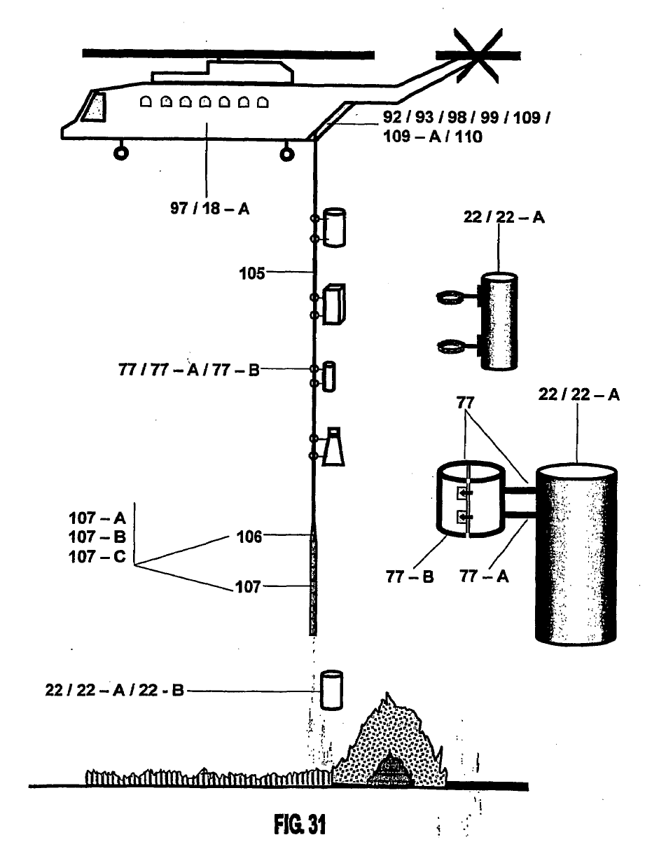

FIG. 30, that displays the Aerial Engineering Process performing consecutive or intermittent free launches of several Capsules (22), or Containers (22-A) or (22-B) or Mortar(s) (96), or only Bottle-type Containers (96-A) without using cable(s) or chain(s) as Capsules (22), or Containers (22-A) or (22-B) guides, totally assembled and ready to use to fight foci of heat, and/or forest fires, using specially equipped Helicopters provided with special guiding Rails for Helicopters and for storing, displacing, positioning, and throwing the Capsules (22), or Containers (22-A) or (22-B). Helicopters provided with Avionics, or with all instruments needed in their cockpit, that can hover in air and over foci of heat and/or fires, performing or adopting the process of launching Extinction Capsules (22), or Containers (22-A) or (22-B) through free fall on a target route on the first point of combat, inside and at the side of the fire, through Capsules (22), or Containers (22-A) or (22-B) with different formats that when on the height and direction determined for explosion and blasting, throw in a spray the Fire Extinguishing Flow Compound. The arrows showing the direction of the sprays exemplify this compound.

FIG. 31, that displays the Aerial Engineering Process, performing consecutive or intermittent launches of several Capsules (22), or Containers (22-A) or (22-B) of different formats, deploying one guide Capsules (22), or Containers (22-A) or (22-B) cable or chain; Capsules (22), or Containers (22-A) or (22-B) equipped or not with a male and female Set of Insertions for the target route and start-up of the ignition of the Starting and/or Detonating Device(s) with fixation rod, Capsules (22), or Containers (22-A) or (22-B) speed control Device(s) that cover the Cable or Chain Guide, and this cable or Chain may include or not of a rotating conical Dart used as a starter with a central hole for the connection of the cable/chain guide and that will help break the male and female guides and pull the starter that will start the explosion and blast the Capsules (22), or Containers (22-A) or (22-B) connected on the Pendulum Articulated Rod, a pendulum rod with or without joints, with or without electromagnetic fields, with a connection to the Darts and that are useful to identify and limit the Level and/or Distances from the soil to guarantee accuracy on the target route(s). The Capsules (22), or Containers (22-A) or (22-B) are connected to the special aircraft guiding Rails for storage, displacement, positioning, and launching of the Capsules (22), or Containers (22-A) or (22-B), also for storing the Capsules (22), or Containers (22-A) or (22-B) inside the helicopters. Helicopters provided with Avionics, or with all instruments needed in their cockpit. These Helicopters can always hover in the air and over foci of heat and/or fires, performing or adopting the process of launching Extinction Capsules (22), or Containers (22-A) or (22-B) through a Guidance Cable or Chain throwing them inside and at the side of the fire, with details on Flexible (22) or Hard Containers (22-A or 22-B), with or without male and female Set of Insertions for the target route and start-up of the ignition of the Starting and/or Detonating Device(s) including fixation rod(s) and container speed control Device(s) with details of an equipped Capsules (22), or Containers (22-A) or (22-B), highlighting the systems applied by two sets connected only to one of the sides of a Capsules (22), or Containers (22-A) or (22-B) and on the other connected only to one set on one side.

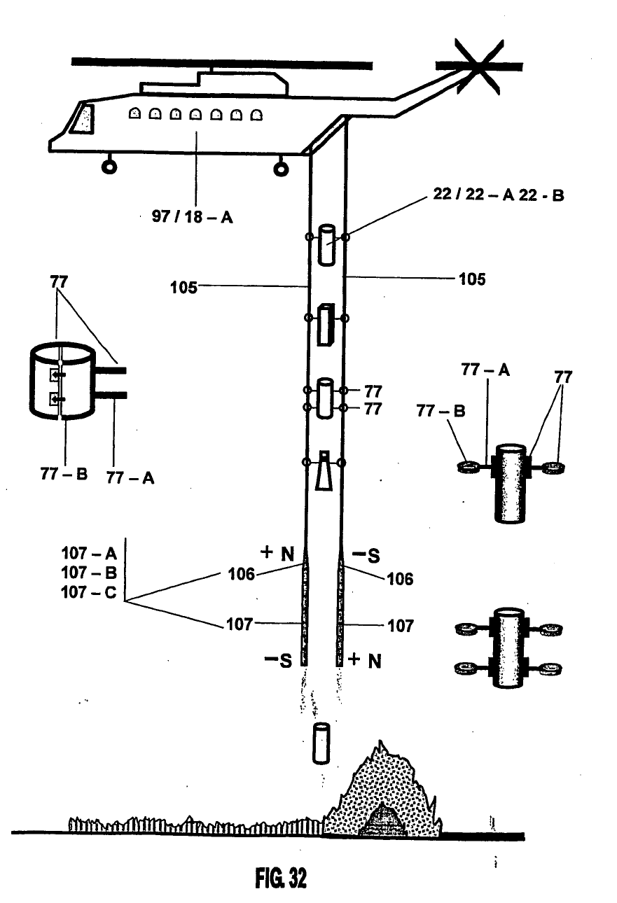

FIG. 32, which displays the Aerial Engineering Process performing consecutive or intermittent launches of several Capsules (22) containers (22-A or 22-B) in different formats, deploying two container guide cable(s) or chain(s). Capsules (22), or Containers (22-A) or (22-B) equipped with male and female Set of Insertions for target route and start-up of the ignition of the Starting and/or Detonating Device(s) including fixation rod(s) and Capsules (22), or Containers (22-A) or (22-B) speed control Device(s) for Capsules (22), or Containers (22-A) or (22-B). The Capsules (22), or Containers (22-A) or (22-B) are totally assembled and ready to use and can be used in fighting foci of heat and/or forest fires. Helicopters provided with special guiding Rails are used as a means of transportation, and they also have guides for storage, displacement, positioning, and launching of Capsules (22), or Containers (22-A) or (22-B). Helicopters provided with Avionics, or with all instruments needed in their cockpit. These Helicopters can hover in the air and over foci of heat and/or fires, performing or adopting the process of launching Extinction equipment through Two Cables and/or Guidance Chains. Details highlighting the set of guides and the other devices in one Capsules (22), or Containers (22-A) or (22-B), applied only on the upper part of it. Another detail showing the equipped Capsules (22), or Containers (22-A) or (22-B) and four sets; two on the upper external side, and two in the lower external side of each Capsules (22), or Containers (22-A) or (22-B).

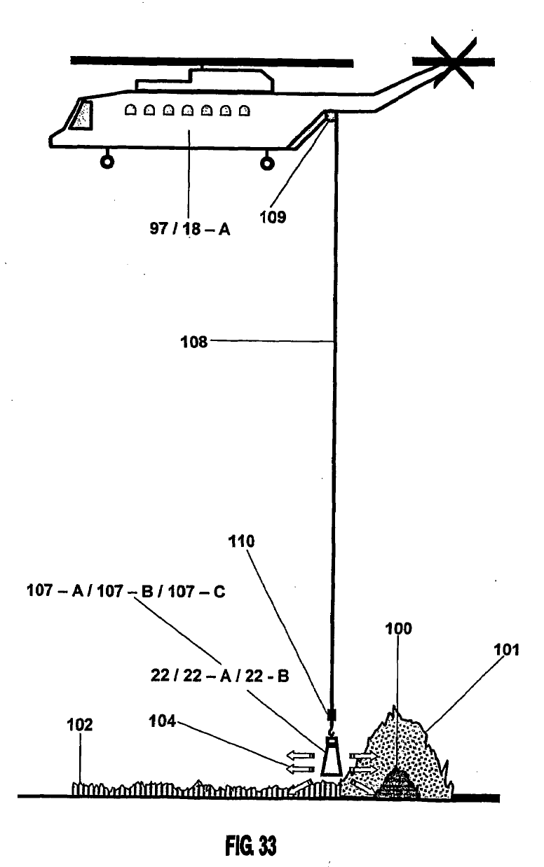

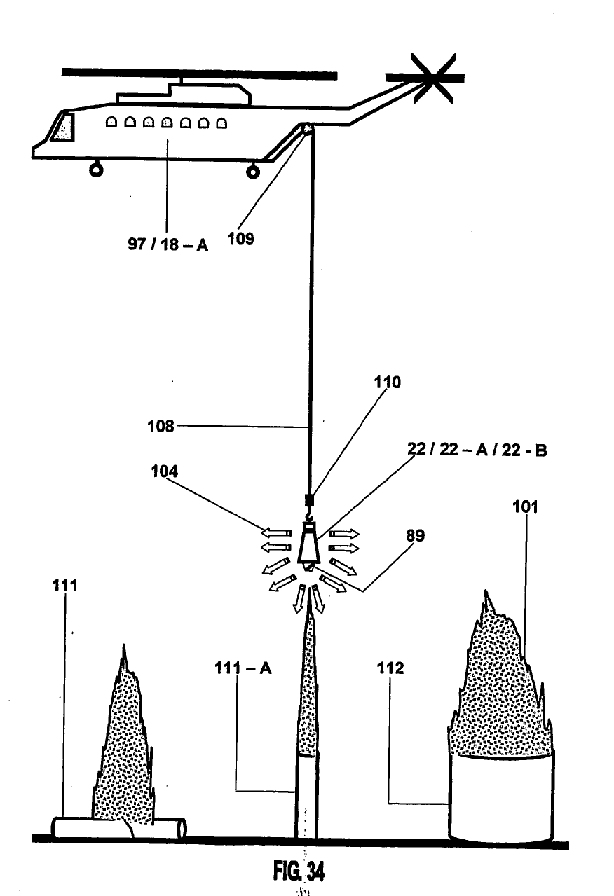

FIG. 33, that displays the Aerial Engineering Process performing individual lowering and hoisting procedures One at a time of the hard or flexible Capsules (22), or Containers (22-A) or (22-B) in different formats, totally assembled and ready to use and that will be used to fight foci of heat and/or forest fires. It deploys helicopters provided with special guiding Rails for aircrafts, and for storage, displacement, positioning, and launches of the Capsules (22), or Containers (22-A) or (22-B), will use electrical, mechanical, and hydraulic hoist with cables or chains and pulleys. These Helicopters are provided with Avionics, or with all instruments needed in their cockpit. These Helicopters can hover in the air and over foci of heat and/or fires, performing or adopting the process of lowering and hoisting Capsules (22), or Containers (22-A) or (22-B). For this process the Helicopter is equipped with special hoists connecting One Cable and/or Driving Chain that are equipped with a rotating system to the cables and/or chains for the maintenance of the alignment of the hook, to determine the Distances from the Soil, to guarantee target route inside and at the side of the fire highlighting the Capsules (22), or Containers (22-A) or (22-B) in a cone-trunk format already on a height and directions established for the blast and launching or spraying its Fire Extinction Flow Compound exemplified by the spray direction arrows.

FIG. 34, that displays the Aerial Engineering Process performing individual lowering and hoisting procedures, One at a time of Capsules (22), or Containers (22-A) or (22-B) totally assembled and ready to use in fighting foci of heat and/or Fires in pipelines, gas lines, oil wells, and inflammable chemical products reservoirs, using special aircraft guide Rails Helicopters, and for storage, displacement, positioning, and lowering of Capsules (22), or Containers (22-A) or (22-B). Electric, mechanical, or hydraulic hoist, cables, and or chains through pulleys control Capsules (22), or Containers (22-A) or (22-B) lifting and lowering. These Helicopters are provided with Avionics, or with all instruments needed in their cockpit. These helicopters can hover in the air and over foci of heat and/or flames, and/or specific points to perform or adopt Lowering and Hoisting Procedures, One at a time of the extinction Capsules (22), or Containers (22-A) or (22-B), through a Guidance Cable and or chain with a Hook and a rotating system. The cable and/or chains are connected to the special electric and/or electronic, and/or mechanic, and/or hydraulic hoist, to lift and lower the Capsules (22), or Containers (22-A) or (22-B) individually, thus establishing the Distances from the Soil and to guarantee target route accuracy at the exact point where flames have to be fought and extinguished. The lowering of the cone-trunk format Capsules (22), or Containers (22-A) or (22-B) is highlighted, as well as the Hard Cork coupled to the lower external area with or without a metal Jacket and/or semi-jacket, and/or mixed with other combined materials that will be used on drills and/or for sealing purposes on a conic format or others. The highlighted Capsules (22), or Containers (22-A) or (22-B), when on the appropriate height and direction of blast, launches its Hard Cork and its Fire Extinction Flow Compound, spraying it as shown by the spray direction arrows.

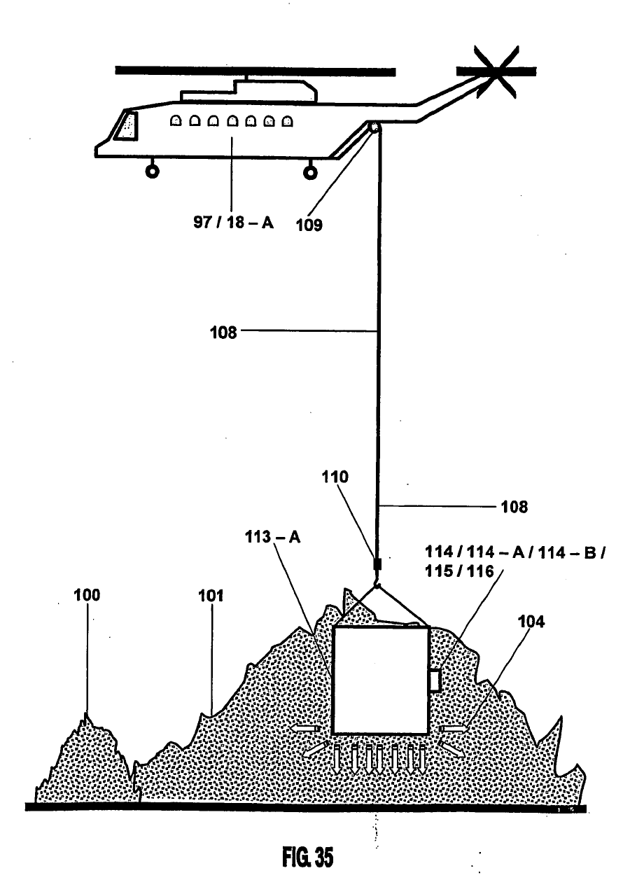

FIG. 35, that displays the Aerial Engineering Process using Helicopters (97) provided with Avionics or with all instruments needed in their cockpit, that hover in the air and over foci of heat and/or flames, and/or specific points performing the Process of Water Launch and of other extinction Compounds through the Special Articulated Container for Fire Extinction (113-A), the Container supported and controlled via Cable and/or Guidance Chain, with a Hook, rotary system to articulate or lower, or lift the Container through electric, mechanical, hydraulic special hoists fixed on the Helicopter to determine the Distances from the Soil, with Valve control cable for throwing water, showing its sprays and directions through spray direction arrows carrying out the extinction of foci of heat and/or Forest fires.

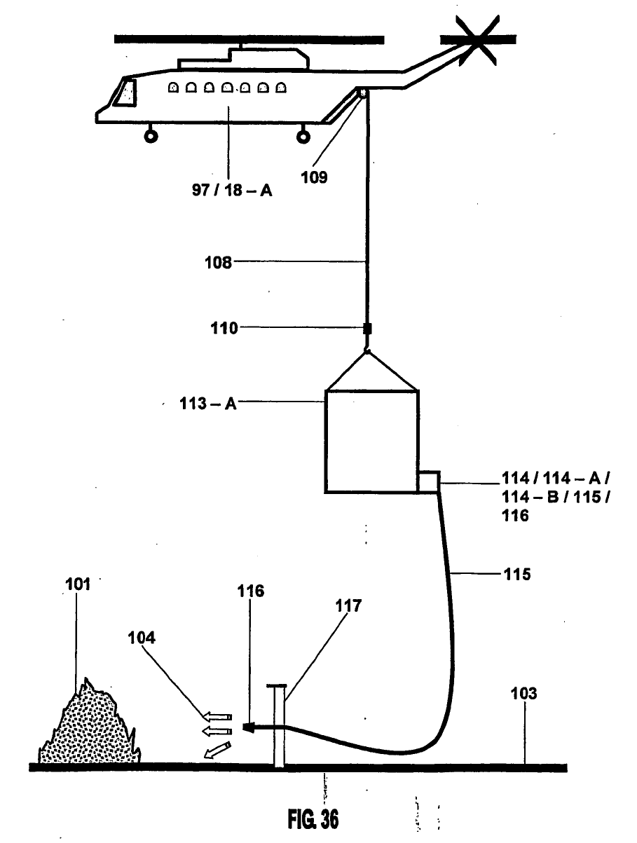

FIG. 36, that displays the Aerial Engineering Process combined with terrestrial engineering, using Helicopters (97) provided with Avionics or with all instruments needed in their cockpit, that hover in the air and over foci of heat and/or flames, and/or specific points performing the Process of Water Launch and of other extinction Compounds through the Special Articulated Container for Fire Extinction (113-A), the Container supported and controlled via Cable and/or Guidance Chain, with a Hook, rotating system to articulate or lower, or lift the Container through electric, mechanical, hydraulic hoists fixed on the Helicopter, container including water pump(s) or for other fluids, a mobile and retractable Reel with a Waste Pipe for Hoses that connects and supports the special Hose with a spray nozzle or an open/close spray valve, used for spraying/squirting the water through Operators that provide the necessary directions both to the hose and for the water jets towards the foci of heat and/or forest fires, and/or other types of fire.

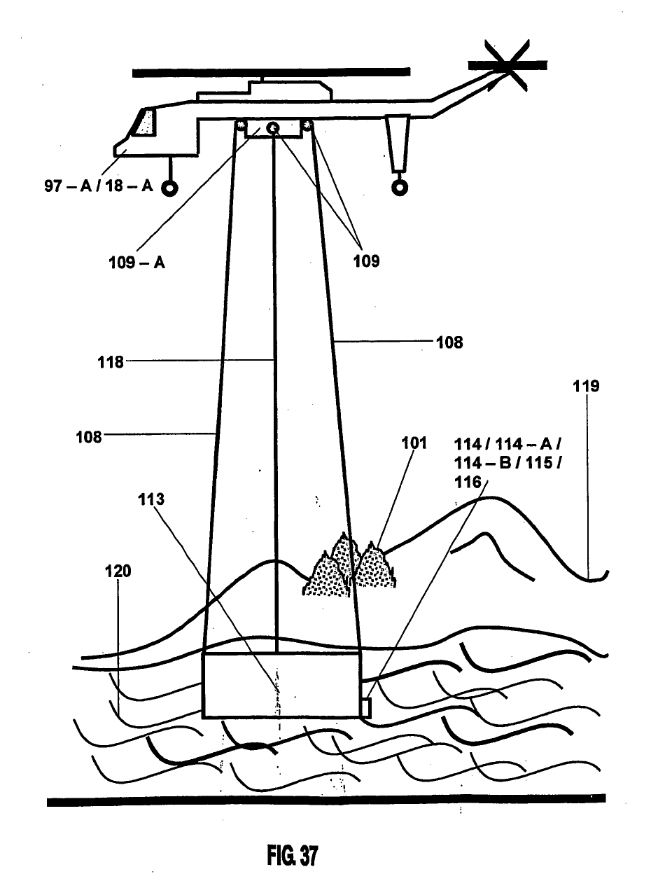

FIG. 37, that displays the Aerial Engineering Process for fighting foci of heat and/or fires, using a Crane type Helicopter (97-A), provided with Avionics, hovering and supplying the Fire Extinction Refractory Articulated Container (113). The Helicopters are provided with special hoists to perform the lifting and lowering through cables and/or support chain, pulleys, with a closing and/or opening control cable for water flow for the special hose, or Valves, highlighting that its spray Control Valves are Closed and the Container is replenished in a lake close to the fire.

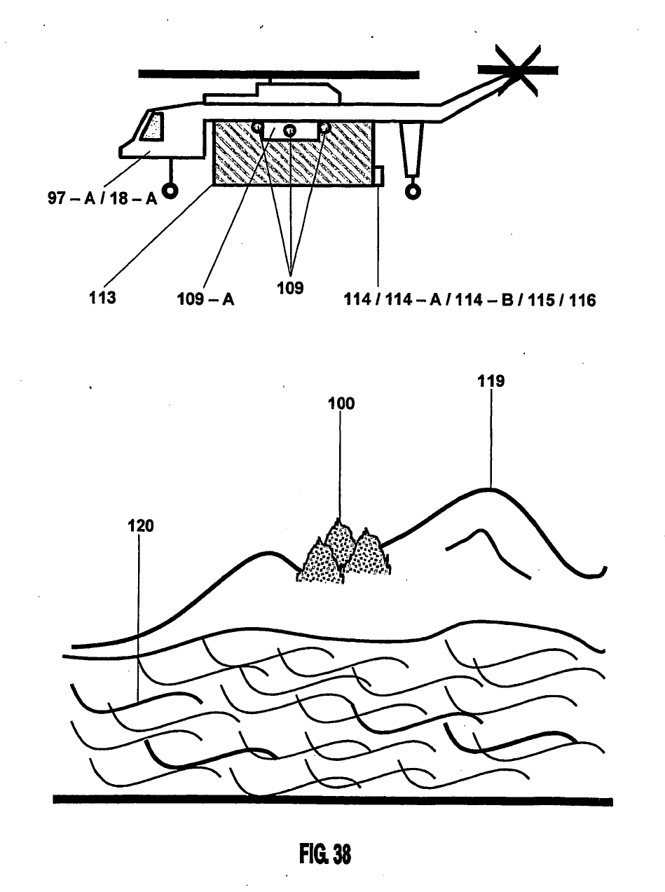

FIG. 38, that displays the Aerial Engineering Process for fighting foci of heat and/or fires, using Crane type Helicopter (97-A) provided with Avionics hovering with the Extinction Refractory Articulated Container (113) coupled to its body through special hoist(s) with pulleys for lifting and lowering the Container that is filled with water or other compound, with its spray Control Valve Closed. The helicopter is with the refractory container totally coupled to its body, ready to fly over the foci of fires and extinguish them.

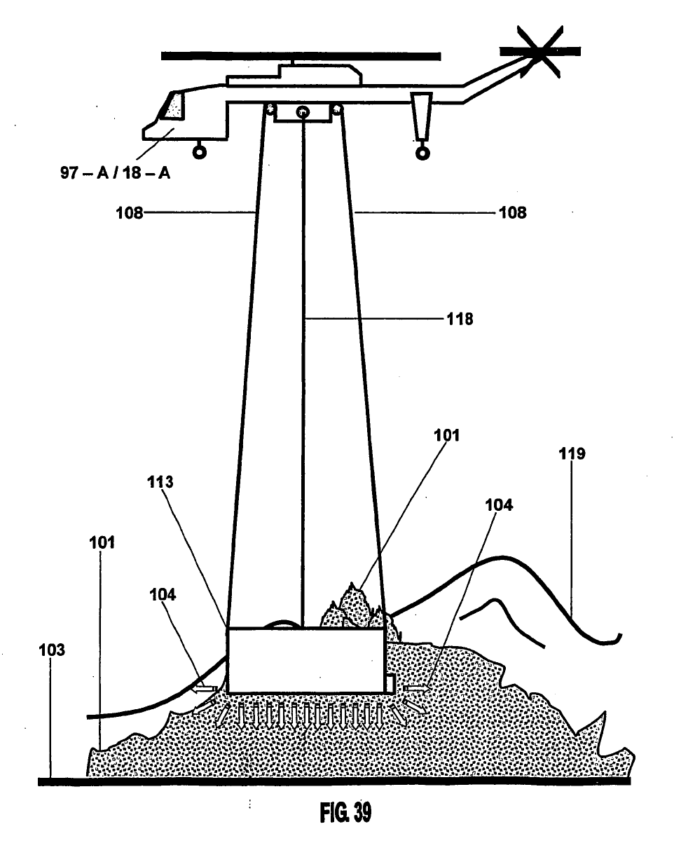

FIG. 39, that displays the Aerial Engineering Process for fighting foci of heat and/or fires using Crane type Helicopter (97-A) provided with Avionics with lifting and lowering hoists, pulleys with support cables and/or chains, with a control cable for opening and closing content flow Valves. The helicopter hovers, supporting, and guiding the Fire Extinction Refractory Articulated Container (113), and this container is provided with refractory coating or materials (144) to avoid deformation of its body when it is lowered into the flames and/or foci of heat with its spray Control Valves Open, throwing/spraying its content inside the fire according to directions identified by the spray direction arrows.

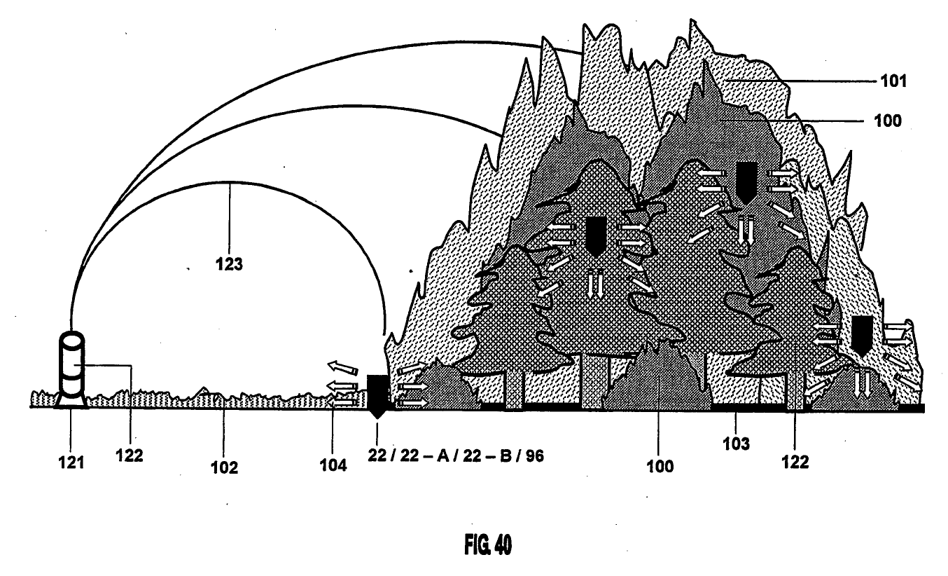

FIG. 40, that displays the Terrestrial Engineering Process for fighting foci of heat and/or Forest fires using Catapult Launchers, throwing Fire Extinction Mortars (96) and your Bottle-type Containers (96-A) inside the foci of heat and fires with the First Bottle-type Containers (96-A) blasted at the soil surface and the other Bottle-type Containers (96-A) blasted before reaching the soil fighting tree-crown fire and with its sprays identified by the spray direction arrows.

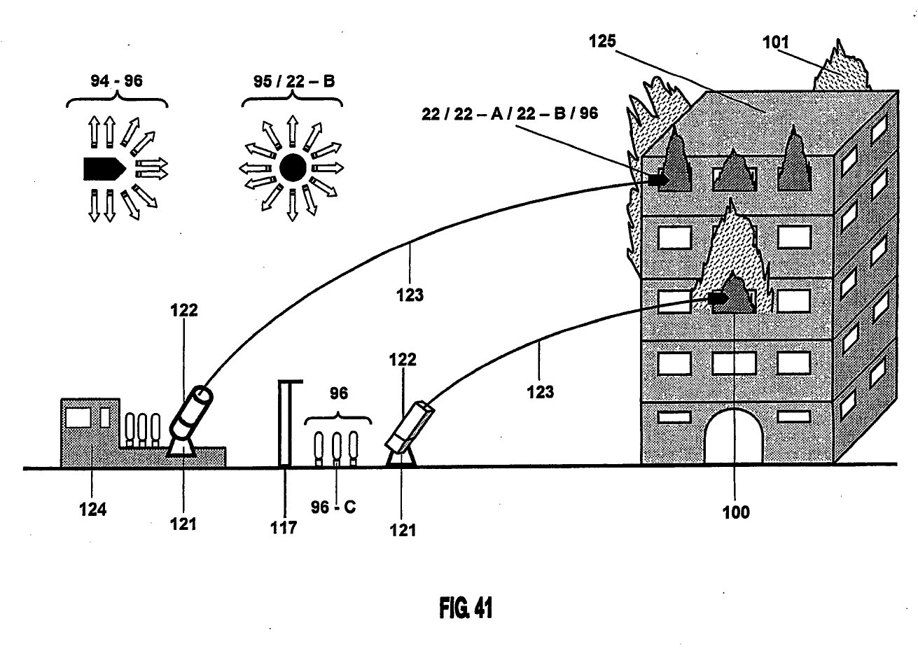

FIG. 41, that displays the Terrestrial Engineering Process for fighting foci of heat and/or fires using catapult launchers coupled to their respective tripods for support and alignment overlaying on terrestrial vehicles, or fixed to the soil, launching Mortars (96), or capsules (22), or Containers (22-A), or (22-B) inside buildings and fire foci with details of the capsules (22), or Containers (22-A), or (22-B) on a cylindrical format with a cone, and on the spherical format with their sprays identified by the spray direction arrows.

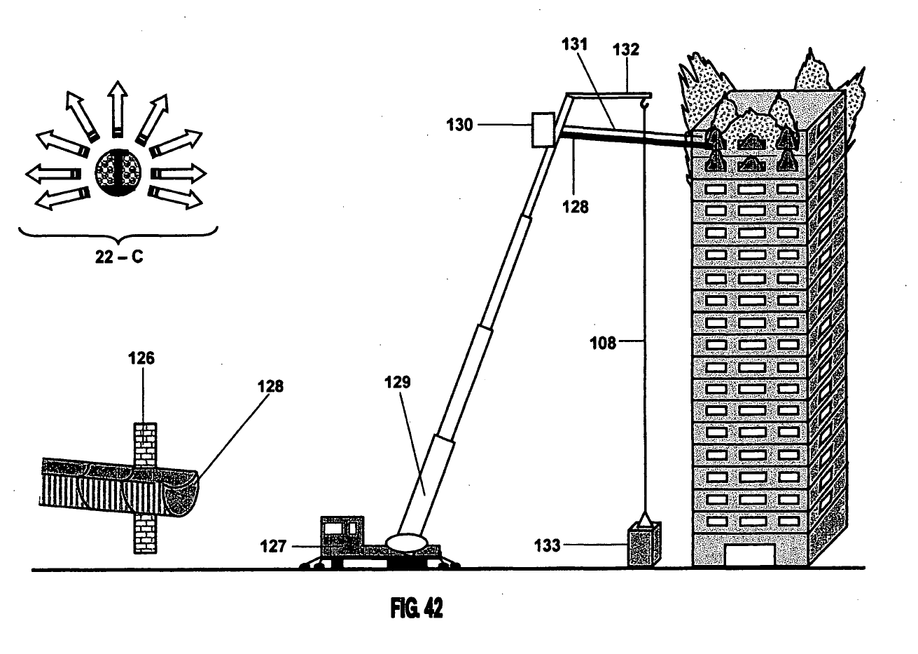

FIG. 42, that displays the Terrestrial Engineering Process for fighting foci of heat and/or fires using a specially equipped Cranes coupled to terrestrial vehicles, lifting a thermal booth (133) to transport any casualty or Extinction Equipment also equipped with a control Booth (130), a telescopic arm for support and guide, lifting and lowering hoist, Telescopic Troughs for launching the containers (22-B) into a building, or for the transportation of Casualties towards of the respective thermal Booth (133), a lifting tackle, a hook, and details on the Launching Trough and Casualties Transportation, plus details of the spherical container and its Core Set, its Counterweight for Plummet Maintenance and with the sprays identified by spray direction arrows.

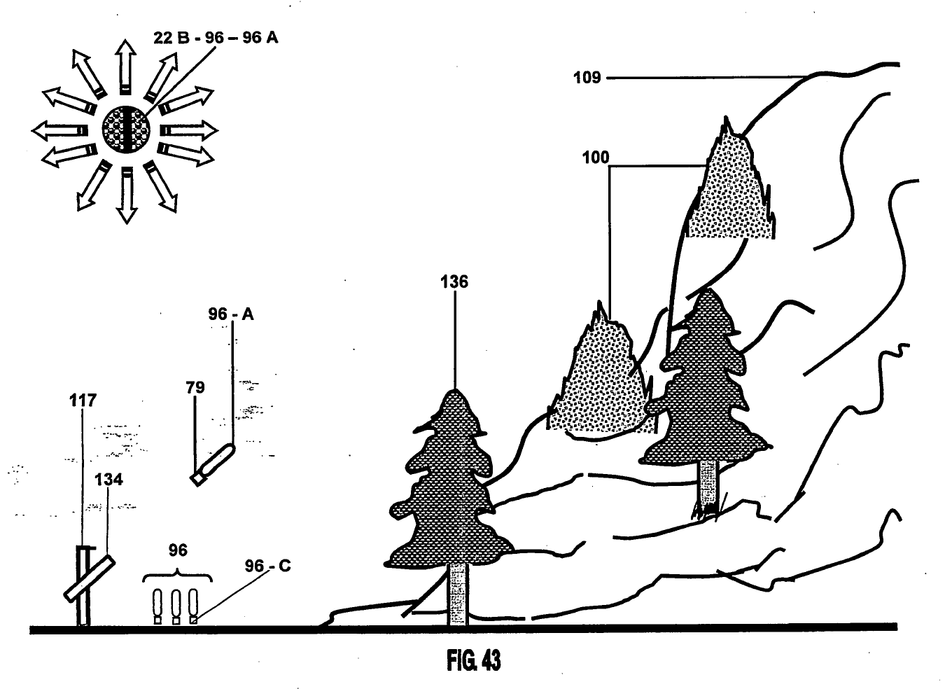

FIG. 43, that displays the Terrestrial Engineering Process for fighting foci of heat and/or fires, with operators using Portable, reusable, and/or disposable Bazooka type Launchers, throwing one of the Bottle-Shaped Container (96-A) models of Mortars into the foci of heat or Forest Fires, or other fires.

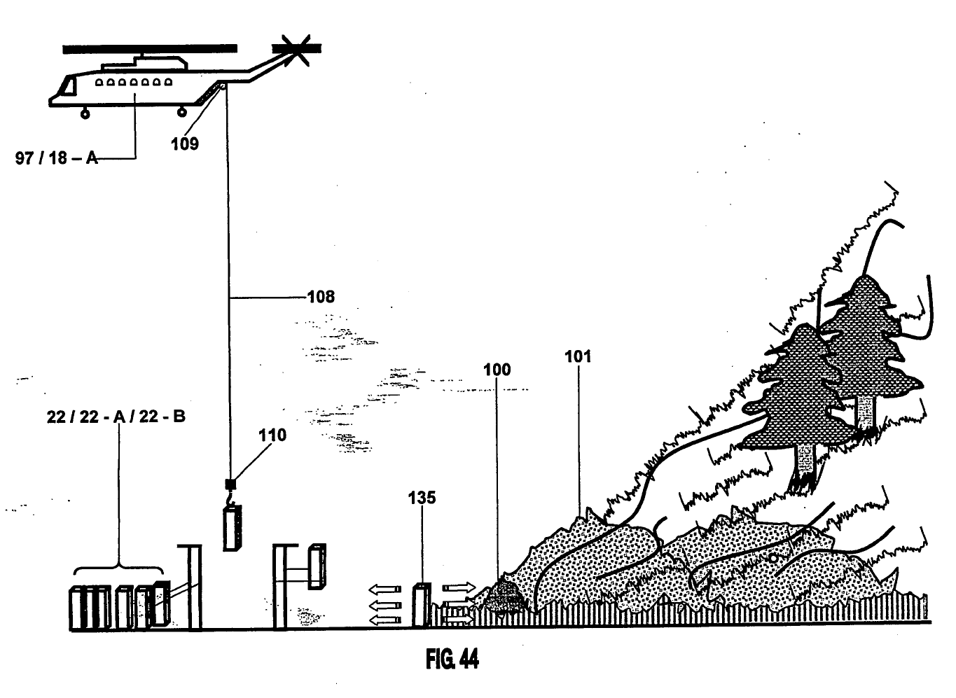

FIG. 44, that displays the Aerial Engineering Process combined with Land Engineering and performing the transportation and replenishment via One to One lowering of capsules (22), or Containers (22-A), or (22-B) totally assembled and ready to use in fighting foci of heat and/or forest fires, using a Helicopter equipped with special guiding Rails that are used for storage, displacement, and lowering capsules (22), or Containers (22-A), or (22-B) and/or equipment, and/or operators, with hydraulic, mechanical, electrical hoists, cables and pulleys in Helicopters provided with Avionics or with all instruments needed in their cockpit, and that can hover in the air performing the Process of supplying capsules (22), or Containers (22-A), or (22-B) to be used by the operators, lowering and lifting Fire Extinction Hard Containers (22-A or 22-B), and/or Fire Extinction Flexible Capsules (22) through One Cable and/or Guidance chain provided with a Hook, and a rotating system that established the Distances from the Soil, with capsules (22), or Containers (22-A), or (22-B) placed away from the fire, an operator to store them, with operators close to the point where fire fighting occurs, with an operator to carry extinction capsules (22), or Containers (22-A), or (22-B) close to the fire, with a container placed close to the fire, with height, and distance, and direction determined and awaiting to be activated via operators or other systems, giving place to its blast, with a launch or spray of its Fire Extinction Flow Compound exemplified by the spray direction arrows, and for fighting the foci of heat and/or fires.

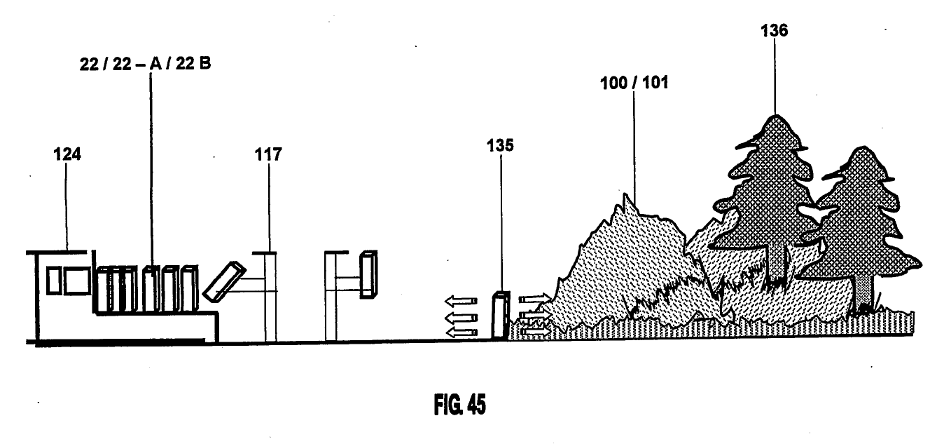

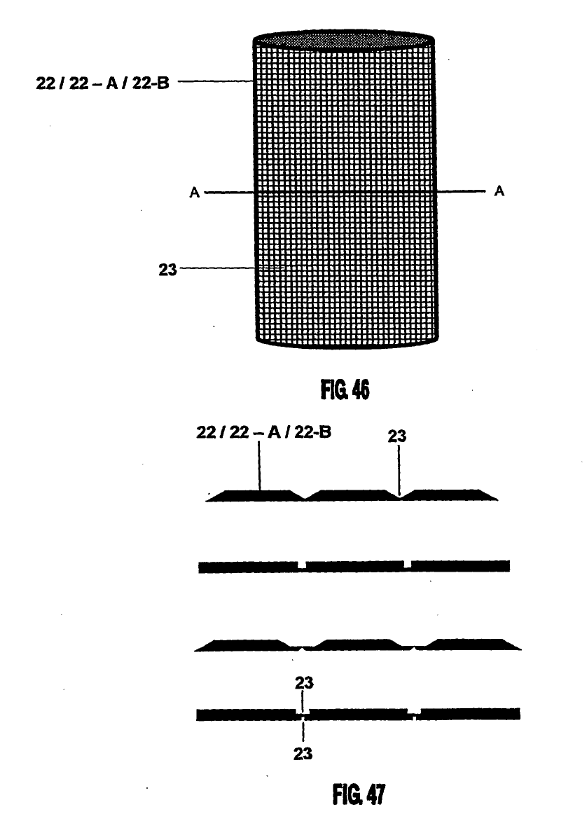

FIG. 45, that displays the Land Engineering Process with transportation of capsules (22), or Containers (22-A), or (22-B) that are ready to use on the land vehicles, with an operator to transport the equipment of extinction close to the fire, with a capsules (22), or Containers (22-A), or (22-B) placed close to the fire on a waiting mode, or for throwing them inside fires or focus of heat, with height, distance, and direction established, so that the operators may activate the blasting process, with the launch or spray of its Fire Extinction Flow Compound exemplified by the spray direction arrows for fighting foci of heat and/or fires.

FIG. 46, that displays a frontal view of the external area of the hard or flexible containers (22, 22-A, 22-B) with programmed fragilities for total release of the plates of the capsules (22), or Containers (22-A), or (22-B), and details on the container cross-section (AA).

FIG. 47, that displays an upper view of the cross-section of the external area of the Fire Extinction containers (22, 22-A, 22-B) with External programmed fragilities performed in a triangular format, or on a squarer format, or External and Internal fragilities.

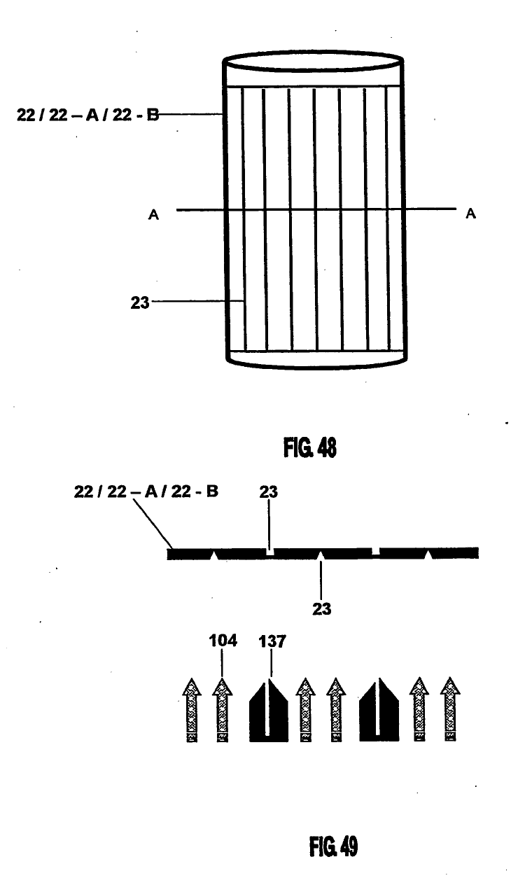

FIG. 48, that displays a frontal view of the external area of the hard or flexible Containers (22, 22-A, 22-B), with programmed fragilities for Partially Guided Release of Plates in a Sole block of the capsules (22), or Containers (22-A), or (22-B), and details on the container cross-section (AA).

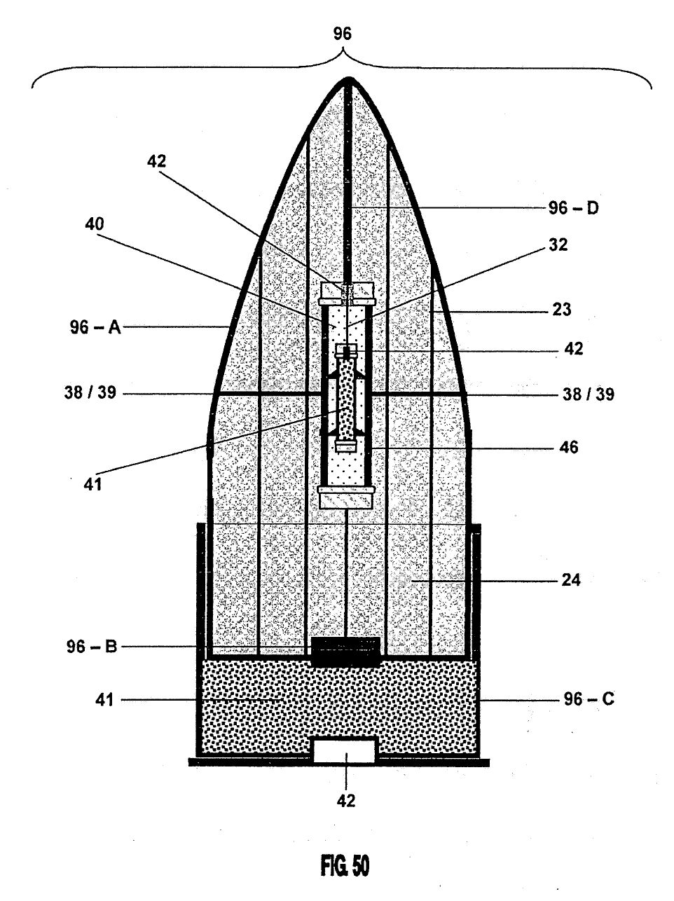

FIG. 49, that displays an upper view of a cross-section of the external area of Fire Extinction Equipment with internal triangular grooves, and external rectangular grooves modeled before Break-up or Blast, and with blasted triangular grooves just like rectangular, frame, rim, doors twisted to the external side of the container creating fins or wings and transforming it in a sole block housing after the break-up or blast in the direction of the spray direction arrows.

FIG. 50, that displays a frontal cross-section of the Fire Extinction Mortar with its Reinforced and Reusable Metal Capsule, with its Percussion Fuse, with its Explosive and/or mixture of Explosives, with its Bottle Type Container plus lid, programmed Fragilities, covered by a Metal Jacket or not, or by a Semi-metal Jacket of hard materials, filled with the Fire Extinction Flow Compound with its Core Set provided with a Percussion Pin of activation connected hoist respective Activation Fuse, or Delay Fuse or not, or explosion train by Impact on the soil ready to be introduced in its Launchers, performing the launches over and inside the fire.

The description of these new lines of Equipment receive the following technical titles:

Fire Extinction Flexible Capsules (22);

Fire Extinction Hard Containers (22-A);

Spherical Fire Extinction Hard Containers (22-B);

Fire Extinction Mortars (96);

Refractory Fire Extinction Articulated Container (113);

Special Fire Extinction Articulated Container (113-A);

Fire Extinction Flow Compound (24) and/or (146), and/or (147), with or without Crystals (40).

Construction Process for Fire Extinction Flexible Capsules (22), and Fire Extinction Hard Containers (22-A):

Both Fire Extinction Flexible Capsules (22), and the Fire Extinction Hard Containers (22-A) may or may not, according to the dynamics of fires being extinguished, include: Container (51-1), or (52-2), or (RCE-3), which consists of containers to hold explosive(s) and/or a mixture of explosives (41) that have a nesting body to hold these explosive(s) and/or Chemical Compound that generates High Speed Pressure and/or a mixture of explosives (41) inside of one of the bodies (37) or (37-A), (37-B) and these bodies can have a cylindrical format, a polygonal prismatic format, or a spherical format that can be combined or not; they can be positioned in any position, placed vertically, horizontally, or tilted, and are made of a hard or flexible material to contain inside in an airtight and resistant receptacle explosive(s) and or a mixture(s) of explosives and/or Chemical Compound that generates High Speed Pressure (41). This (these) explosive(s) Chemical Compound that generates High Speed Pressure (41) will have different speeds, they will be pressed or not inside either of the bodies (37) or (37-A), (37-B). The delay fuses or not and/or the explosion train (42) to be used will be connected and/or placed in any position in the body (37) or (37-A), or (37-B), and they will be connected to their respective different drivers for ignition (32) and that can be electric or not electric. The Containers (51-1) or (52-2) or (RCE-3) will have or not whenever necessary connected to their external areas their axle limiting rings (38), that match the formats of the bodies (37) or (37-A), and have three or more rods (38-A) with lengths that match the necessary measurements that are compatible with the internal measurements of the Core Set body (36), and can also have axle limiting guides (39), that have tree or more fins (39-A) with a rectangular prismatic or trapezoidal shape with sizes and quantities that match the internal measurements of the body (36) of the respective Core Sets (46), (46-A), (46-B). After the nesting bodies (37) and (37-A), and (37-B) receive their Rings (38) and/or their Guides (39), and the upper cap (45) is connected to their upper end, bodies (37) and (37-A), or (37-B) are filled with their respective explosive(s) and/or Chemical Compound that generates High Speed Pressure (41), after which they will receive the lower cap (44) for closing the body (37), (37-A), and (37-B). Lower and upper caps that belong to bodies (37), (37-A), and (37-B) have a shape that matches the format of their body (37), (37-A), and (37-B). These lower and upper caps can be threaded, glued, or connected through any other conventional means. The staggered adaptor reducer (43) is only used in the construction of the body (37-A), and utilized whenever staggering is necessary, when its size and shape will match the shape of the respective body (37-A). After bodies (37), (37-A), and (37-B) are assembled they are defined as Container (51-1), or (52-2), or (RCE-3) respectively, and if needed, one can be introduced inside the respective Core Sets (46). Capsules (22), and/or Containers (22-A), and/or Spherical Containers (22-B), can be utilized deploying their respective Core Sets (46), (46-A), or (46-B) or these same Capsules (22) or Containers (22-A or 22-B) can only be deployed with their respective Containers (51-1), or (52-2), or (RCE-3), or without using the respective Core Set, without using the Container (51-1), or (52-2), or (RCE-3), i.e., Capsules (22) or Containers (22-A or 22-B) can be utilized and launched without any explosives in its interior. They can also be utilized with or without the use of the respective Core Sets, with or without, Containers (51-1), or (52-2), or (RCE-3) when their Extinction Flow Compounds (24) and/or (146), and/or (147), with or without Crystals (40) are on a frozen state.

Capsules (22), or Container (22-A, or 22-B), or their Lid(s), or Hard Cork(s) (89) may optionally hold or not sensor(s) for different identifications and/or for scanning (107-A), and they can also be connected, when necessary, to flashing lights or not, signaling Bulbs that flash or not, or Light Emitting Devices (107-B), or reflecting Devices or fluorescent Devices (107-C), adhesive or not, for signaling, identification, and place setting. The flashing Bulb(s) (107-B) or Reflective Devices, or Fluorescent Devices (107-C) can be connected on the external or internal area, or embedded in some external or internal area, being powered by solar radiation, batteries, electric power or other conventional and necessary means.

Capsules (22) or Container (22-A), or spherical Container (22-B) can be launched, rolled, or placed inside the foci of heat or fires or not via aircrafts/helicopters, cranes (129), robots (138), or by other robotic or cybernetic means, or by telescopic arm (132), or by other means of safe access. Their Fire Extinction Flow Compound (24) and/or (146), and/or (147), with Propelled-Propellant Crystals and/or granules (40) or not, can be in the gelid state or not, or in other states. They can be used with or without the respective Core Sets (46), or (46-A), or (46-B), with or without the Container (51-1), or (52-2), or (RCE-3) or without the Core Sets (46), or (46-A), or (46-B).

The Capsules (22), Containers (22-A), and (22-B), the Bottle Type Containers (96-A) that belong to the Mortars (96), or the Hard Corks (89), may optionally or not receive in their external area(s) Whole Metal Jacket (89-A) or a Semi-jacket of a Hard Material (89-B). These Jackets (89-A) or (89-B) may or not be provided with Programmed Fragilities (23). The Jackets (89-A) or Semi-jacket of a Hard Material (89-B) may whenever necessary be provided or not with Programmed Fragilities (23). The Jacket(s) (89-A) or (89-B) will have the respective external format of the respective Capsules (22), and/or Containers (22-A), and/or (22-B), the form of the respective Cork(s) (89), and these Jackets (89-A) and (89-B), or the Bottle Type container (96-A) will have the thickness and quantity of the Programmed Fragilities (23) that match the technical needs imposed by the dynamics that arise from the fires.

The Programmed Fragilities (23) can be carried out in the internal part or external part of the Capsules (22), and/or Containers (22-A), and/or (22-B), with different depths and in one or more directions with the format of a trough or whenever necessary in the polygonal prismatic, semi-spherical, semi-egg shaped, and mixed formats and that will take part in the planned blasts for the Capsules (22) or Containers (22-A or 22-B) or combined sets. They will take part on the blasting of the Capsules (22) or Containers (22-A or 22-B) when the explosion via explosive(s) Chemical Compound that generates High Speed Pressure (41) occurs, in plates, and/or mono blocks, and/or in windows (137), or when only by impact on the soil. These Programmed Fragilities (23) will be applied or used whenever necessary.

The operational mechanism and the effects of extinction of foci of heat and/or fires through the detonation of explosives Chemical Compound that generates High Speed Pressure (41) and the eventual blasts, may or not generate a controlled shock wave that creates or not a turbulent flow formed by crystals or granules (40) that are pulverized and thrown leading the fire extinction flow compound (24) and/or (146), and/or (147), with or without Crystals (40) into projected and guaranteed directions thanks to the vectorizers (25) or (26) promoting or not displacement effects and the extinction of the flames, smoke and heat, capture, dispersion, and separation of inflammable gases, planned fragmentation of active fuel loads through the spray of the turbulent flow with compound (24) and/or (146), and/or (147), and with or without crystals or granules (40), promoting shock, collision, friction, and rebound over the surfaces of the active fuel loads, decompressing and decomposing them and reducing the extremely high temperatures to values around 50° C., and promoting the formation of a layers of inert gases and Bio-Gel covers (146) over the active fuel loads, temporarily isolating them and thus avoiding re-ignition.

The Core Sets (46), (46-A), or (46-B) have a body (36) on a cylindrical, prismatic polygonal, or spherical shape; they may have connected to their lower end its lower Gäa-Kibele vectorizer (25). This lower vectorizer (25) has its contact area in a shape that matches the shape of the body (36), and also has a cone-trunk shape, and a cone in its other area or part. Also, the core set body (36) can have connected to its lower end its lower cap (47) that belongs to the core set body (36). This lower cap (47) has a shape that matches the shape of body (36). Both the lower vectorizer (25) and the lower cap (47) are conventionally connected to the core set (36) body. In the core set (36) body, connected to its lower vectorizer (25) or to its lower cap (47) part of the Propelled-Propellant Granules and/or Crystals (40) is introduced, and afterwards its corresponding Container (51-1), or (52-2), or (RCE-3) is introduced to hold the explosive(s) and/or the mixture of explosives, Container (51-1), or (52-2), or (RCE-3), respectively, leaving outside the body of the core set (36) the different conductor(s) for ignition (32), and then the internal part of the body is concluded (36) with the rest of the Propelled-Propellant Granules and/or Crystals (40) when the body (36) is closed with a conventional connection on its upper part by upper Gäa-Kibele vectorizer (26) also with a cone-trunk shape, and cone in its internal part, and it is provided with a cylindrical hole (26-A) for the passage of the different driver(s) for ignition (32) in a circular shape, or with a hole or holes (27) for fastening or fitting the upper vectorizer(s), to be threaded or fit and placed on the external face of the cylindrical area of the vectorizer (26) or closed by the upper cap of the core sets (46), (46-A), or (46-B) that conventionally closes the body (36), with a hole (50) for the passage of the driver(s) (32), and with one or more pins (49) of the upper cap for fitting and/or fastening, thus forming the core sets (46), (46-A), or (46-B). These Core Sets are fitted or connected, or fixed on their respective option lids (1, 2, 3, 4, 5, 6, 7, 8, and 9), when they are connected on the internal and/or external upper area of their respective capsules, or of its respective containers (22-A or 22-B), when these Capsules (22), and/or Containers (22-A), and/or (22-B), are supplied with water, or of the respective fire extinction flow compound (24) and/or (146), and/or (147), with or without Propelled-Propellant Crystals and/or Granules (40), or other chemical products, having them ready to use. Capsules (22) or Containers (22-A or 22-B) will use one of the respective option lids (1, 2, 3, 4, 5, 6, 7, 8, and 9).

The Core Sets (46), (46-A), (46-B) when introduced in the Bottle Type Container (96-A) and relative to Mortars (96) receives or have connected in the body (36) external area as many Guides (39), or their Rings (38) as necessary to guarantee their disposition inside the Bottle Type Container (96-A).

The traditional Starting and/or Detonating Device(s) (31), with protection and fastening box, connected to the Drivers (32). The devices (31) can be fixed in any place on the upper face of option 1 lid, or in other areas on the other options of Lids or of Capsules (22), and/or Containers (22-A), and/or (22-B).

The capsule (22) can be made of a cylindrical shaped flexible material, or it may have a cone-trunk, or be egg-shaped, or have a prismatic polygonal, or semi-spherical shape, or a combination of all these shapes, with or without internal or external programmed fragilities (23) with different depths and in one or more directions, with or without two or more supporting, and/or guiding, and/or transportation belts (30). These belts (30) can be made of a support material and consolidated both on a Capsule (22) as in containers (22-A) or (22-B). These belts are connected on the upper part of the Capsules (22) or Containers (22-A), and eventually, if necessary, in the spherical Containers (22-B), being placed close to option lids (1, 2, 3, 4, 5, 6, 7, 8, 9);

All the Capsules (22), and/or Containers (22-A), and/or (22-B), can be supplied with their respective fire extinction flow compound (24) and/or (146), and/or (147), with or without Crystals (40) distributed inside their respective Capsules (22), and/or Containers (22-A), and/or (22-B). This compound (24) and/or (146), and/or (147), with or not, Propelled-Propellant Crystals and/or Granules (40) can be made of water, with or without other products or chemical compounds for the extinction or fires, or a combination of all of them. These compounds can be found in different physical states;

The Capsules (22), and/or Containers (22-A), and/or (22-B), because of the dynamics of fires can utilize any option of Lid (1, 2, 3, 4, 5, 6, 7, 8, 9) exactly because they can be connected to any kind of Capsules (22), and/or Containers (22-A), and/or (22-B). All the Lids, as well as any place of the external areas of the Capsules (22), and/or Containers (22-A), and/or (22-B) may or not hold or receive in any part of their body or area, support and/or guide, and/or transportation belts (30), insertions for fins or wings (79), Spoilers and/or stabilizers (80), Male and Female Set of Insertions (77), fixation Rods (77-A), with or without Speed Control Device(s) (77-B) or other devices needed for target route accuracy and control.

Construction Process for the Spherical Fire Extinction Hard Container (22-B):

The spherical containers (22-B) are made of different hard materials, or built in only one body, or built in two parts as exemplified in FIG. 26. The spherical containers may utilize body (22-B) with a spherical shape built in only one piece or in two parts, and if built in two parts it will include: a semi-spherical shaped upper part (84) with a cylindrical shaped hole (83) on the upper edge to connect option lids (1, 2, 3, 8, 9) and a female insertion (85) on the lower edge, a lower part (87) on a semi-spherical shape with a male insertion (86) on the upper edge, and with a plummet maintenance counterweight (88) consolidated on the internal lower part (87), or consolidated on other parts or areas. This plummet maintenance counterweight (88) may be magnetized or not. The spherical containers (22-B), after being supplied with the fire extinction flow compound (24) and/or (146), and/or (147), with or without Crystals (40) can have their fragilities programmed (23) or not, or they can have their fragilities whenever necessary, receiving their respective Core sets, properly connected to one of its lids as exemplified in FIG. 26. The ignition of the explosives Chemical Compound that generates High Speed Pressure (41) will occur by remote control via programmed timers, or by wicks. The spherical containers (22-B) may be launched or not, rolled or not, placed inside the foci of heat or fires or not, via aircrafts/Helicopter, via Telescopic Trough (128), cranes, robots (138), or by other robotic or cybernetic means, or by telescopic arms (131), or by other means of safe access. Their Fire Extinction Flow Compound (24) and/or (146), and/or (147), with or not Propelled-Propellant Crystal and/or Granules (40), may or not be on a frozen physical state or in other states. They can be utilized with or without the Core Sets (46), (46-A), (46-B) with or without the Container (51-1), or (52-2), or (RCE-3) only, with or without Core Set (46), or without Container (51-1), or (52-2), or (RCE-3).

Containers (22-B), or their Lid(s) may optionally contain or not sensor(s) for the different identification and/or scanning (107-A), as well as have connected if necessary, flashing lights or not, signaling Bulb(s) or Light Emitting Device(s) (107-B), or Reflective or Fluorescent Device(s) (107-C), adhesive or not, for signaling, identification, and their place setting. The Flashing lights or not (107-B) or the Reflective or Fluorescent Devices (107-C) can be connected on the external area, in a lower place, or embedded in some external or internal area and they will be supplied by solar radiation, batteries, power supply, or other traditional but necessary means.

Construction Process of, Fire Extinction Mortars (96):

The, Fire Extinction Mortars (96), are assembled on reinforced and reusable metal capsules (96-C) of a cylindrical or prismatic polygonal shape matching with the format of a launcher (122), and provided with a percussion fuse (42) or an electric activated, or an electronically activated, or a mechanically activated fuse, placed on their lower part, and that is connected to the propulsion explosive (41) to shoot and launch the Bottle Type containers (96-A) that can have a shape that matches to the shapes of the reinforce and reusable metallic capsules (96-C). The Bottle Type containers (96-A) have a lower and/or external lid (96-B) that can be connected via thread, or glue, or other traditional means, and can be on a smaller size, or of the same size of the body of the Bottle Type Container (96-A) internal side or external side, and they will be utilized for closing them, and for supplying them of fire extinction flow compounds (24) and/or (146), and/or (147), with or without Crystals (40) or other chemical products. The Bottle Type Container (96-A) may have programmed fragilities or not (23) that will be placed in different directions and found in the external or internal area. The Bottle Type container (96-A) can be built of a hard material, or whenever necessary of a flexible material, and in the flexible state, it will receive a full metal jacket (89-A), or a partial semi-jacket (89-B). The Bottle Type containers (96-A) will hold water or fire extinction flow compound (24) and/or (146), and/or (147), with or without Propelled-Propellant Crystals and/or Granules (40) or other chemical products for fire extinction, and will hold or not in their interior the core sets, with their starting fuse (42) that can be a delay fuse or not belonging to the Core Sets (46) (46-A), or (46-B), that is activated initially by the percussion pin (96-D) by impact on the soil and after the first explosion of this fuse, transfers the ignition through drivers (32) to the other fuse (42) that belongs to the Container (51-1), or (52-2), or (RCE-3), which on its turn explodes and blasts the Bottle Type container (96-A) via timer or when it hits the soil releasing the spray of fire extinction compounds together with the Propelled-Propellant Granule and/or Crystals (40) as shown in FIG. 50.

The Bottle Type containers (96-A) that belong to Mortars (96) may or not be launched, or placed inside the foci of heat or fires by bazookas, airplanes/Helicopters, special telescopic cranes (129), robots (138), or by other robotic or cybernetic means or by other means of safe access. Their Fire Extinction Flow Compounds (24) and/or (146), and/or (147), with Propelled-Propellant Granule and/or Crystals (40) or not, may or not be on a frozen state or in other states. They may or not be provided with Core Sets, with or without the Container (51-1), or (52-2), or (RCE-3) only, with or without whole metallic Jackets (89-A), or Semi-jackets (89-B) covering the Bottle Type Containers (96-A) whenever necessary.

The Bottle Type containers (96-A) that belong to Mortars (96) may optionally hold or not sensors for different types of identification and/or scanning (107-A), or also have connected when necessary flashing lights or not, signaling Bulb(s) or Light Emitting Device(s) (107-B), or Reflective or Fluorescent Device(s) (107-C), adhesive or not, for signaling, identification, and place setting. The flashing lights or not (107-B), or the Reflective or Fluorescent Device(s) (107-C) can be connected on the external area, or on a lower place, embedded in some external or internal area and they will be supplied by solar radiation, batteries, power supply, or other necessary traditional means.

These Mortars (96) can be operated by, cannon, bazookas (134), impellers, arbalests, jets, special rifles, different launchers (122) specially developed to throw the Bottle Type containers (96-A) or optionally via aircrafts/Helicopters, and with the appropriate offsets for the Bottle Type containers (96-A) curve or angular trajectory route, they can reach the point(s) more vulnerable in the fires with surgical accuracy. This prevents the physical presence of an expert on the fire area and the fire can be controlled, extinguished at a distance, and in this case with the deployment of land vehicles (124) and/or by the use of aircrafts/Helicopter as explained in FIGS. 40, 41, 43, 50.

Construction Process of the Refractory Fire Extinction Articulated Container (113) and Special Container (113-A):

The Refractory Container (113) and Special Container (113-A) have a spherical, prismatic, cylindrical, cone-trunk or egg shape made of the body (90), of the lids (90-A), with its sealing rims (90-B) made of rubber or different materials to hold the water and the fire extinction flow compound (24) and/or (146), and/or (147), with or without Crystals (40), with its hinges (90-C), and its buoys/floating devices (90-D), supporting and/or fastening hooks (90-E), counterweight (90-G) for immersion, motor (90-H) and/or electric, electronic, mechanical, hydraulic rotating system, insertion pin, and fastening pin (90-I) for and from the sprays (90-J) of the same shape of the body (90) of the Refractory Container (113) and Special Container (113-A), and with output holes (90-K) or pipes (90-L) for the water and/or other liquids on the side and lower areas, and/or only on the lower area, with or without the male and female insertion set that overlay the valves for sealing the water and other liquids (90-M), angle bars (90-E) to limit the lids, optional cable(s) (90-O) for opening and/or closing the valve(s) (90-R), articulated axle of the motor (90-N), and/or rotating system to control valves (90-R), a ring (90-P) to adjust and fasten the cable(s) (90-O), sealing hinges (90-T) for the valves (90-R), structural guides (90-Q) for the valve(s) (90-R), support base (90-S) and sealing and fitting of valve(s) (90-R), valve or valves (90-R), output holes (90-K) for the water, and/or other liquids on the side and/or lower areas, output tubes (90-L) for the water and other liquids only on the lower area, and male and female insertion set for the overlay of the sealing valves (90-M), as in FIGS. 28 and 29.

Body (90) of Refractory Container (113) when provided with the pieces of equipment, the protection Box for the output Pipe(s) (114), with or without water Pump(s), and/or other Cooling Fluids, and/or Extinguishing (114-B) fluids pumps, Retractable Mobile Reel (114-A), special Hoses or flow pipes (115), and Nozzle and open/close spray Valve (116) becomes the Special Container (113-A) where its compound (24) and/or (146), and/or (147), can receive Crystals (40) or not as shown in FIG. 36.

Therefore the Refractory Container (113) and Special Container (113-A) can throw the water and other liquids through its sprayers (90-J) via its output pipes (90-L) and/or output holes (90-K). Only Special Container (113-A) is provided with two ways of throwing the water, and in addition to launching or throwing its content over or inside the fire using the method explained above, it can, whenever necessary, throw its water or other liquids through the equipment in the Protection Box for output pipes (114) that may or not hold water Pump(s), or for other Cooling Fluids or for Extinguishing liquids (114-B), it may hold the Retractable Mobile Reel (114-A) that will store the Special Hoses or pipes (115) for declivity flow, or pressure flow that may launch water jets or of fire extinction flow compound (24) and/or (146), and/or (147), with Propelled-Propellant Crystals and/or Granules (40) whenever necessary, that will run as abrasives, dampers, extinguishers and coolers of the incandescent fuel loads in flames (100), as shown in FIG. 36.

The Refractory Fire Extinction Articulated Containers (113) or Special Containers (113-A), may receive a refractory protection or a mechanical protection and are internally or externally covered with refractory or anti-flame materials or products that will protect against deformities and will offer resistance to the high temperatures from the foci of fire and other types of fires.

The Refractory Containers (113) are connected, fixed, or transported on the body of the respective helicopter, or (97-A) and can be lowered inside the fire as exemplified in FIGS. 35, 38, and 39. It must be highlighted that the Refractory Container (113) will be transported connected to the body of its respective helicopter (97-A). Like this, it is possible to achieve the helicopter total speed, approximately 300 km/h, whereas on the traditional methods of load transportation via cable, speed can reach safely approximately 80 km/l.

Refractory Containers (113) as well as Special Container (113-A) may optionally hold or not sensor(s) to identify different things and/or for scanning (107-A), and may also have connected whenever necessary, flashing lights or not, signaling lights, or Light Emitting Devices (107-B), or reflecting devices, or fluorescent devices (107-C) that can be adhesive or not, for signaling, identification, and location of their position. The flashing lights or not (107-B), or the Reflecting Device(s), or the fluorescent Device(s) (107-C) can be connected on the external area, or on a lower position, or embedded in some external or internal area of the containers, and will be supplied by solar radiation, batteries, electric power or other necessary traditional means.

The Construction Process, or the Process by which the Components of the Fire Extinction Flow Compounds (24) are Formed:

The fire Extinction Flow Compounds (24) and/or (146), and/or (147), with or without Crystals (40) may include water, or specially designed compounds or not, developed and combined with other chemical products with Propelled-Propellant Crystals and/or Granules (40) that will not originate any kind of hazardous residual contamination to the environment, and that in addition to cooling down isolates the fuel load of the fire that is burning (100) throwing layers of interference gas, or of Refractory Gel and/or Bio-Gel (146) over the combustion processes, as well as soil recovery elements (147). Among these emulsifiers, isolators, dispersants, and Coolers and/or extinguishers we highlight: Foam Generating Liquid, BIO-Natural Anti-Flame, Bio-Gel (146)—Roots and others, Refractory Gel (146), —Soil Recovery Elements (147), natural and/or chemical fertilizers, different seeds for reforestation, special gel capsules to coat the seeds with nutrients, or fertilizers, and/or other elements, different kinds of anti-flame chemical powder(s) and/or Herbicides.

This Fire Extinction Flow Compound (24) and/or (146), and/or (147), may or may not be pressurized via compressed air and/or other gases and/or liquids, and may or may not be in a solid state, a liquid state, a paste, powder, gelatin, gelid, encapsulated clusters, gas state, cold or warm with Propelled-Propellant Crystals and/or Granules (40) or not.

This new Fire Extinction Flow Compound (24) and/or (146), and/or (147), with Propelled-Propellant Crystals and/or Granules (40) or not, when utilized in fire fighting, and/or in fighting foci of heat, etc, may be in variable densities and in variable quantitative and qualitative compositions and physical states, always depending on the type of fire or foci of heat to be extinguished and also considering all the operational difficulties, that will be identified and determined by the teams inside the aircrafts, and/or land teams that like this may put into practice the methods defined using the necessary and appropriate equipment.

Construction Process of the Lids:

Option 1 Lid (35) has a cylindrical format or a prismatic polygonal format, or a semi-sphere format, with or without fastening shoulder (35-B), and/or for adjustment(s), and/or for sealing the clamp(s) on its external, central lateral part. It has a passage hole (28-A) for the different driver(s) (32) for ignition. These drivers (32) have different formats and are connected, whenever necessary, to their respective Starting and/or Detonating device(s) (31). These starting devices (31) have a hole (35-C) for their fitting and or fastening. These holes match the external format of the starting device (31). This Option 1 Lid has an input for the supplies (35-D) for the Capsules (22), and/or Containers (22-A), and/or (22-B), and this hole has a cylindrical and/or polygonal prismatic format, with or without internal thread for fastening its screw cap (34), and this option 1 lid has a hole (28) for fastening or fitting the hook(s), and this hole has a running through cylindrical format or not, or with internal thread, with support or transportation hook(s) (33). This option one lid has one or more running through holes (35-E) for fastening and/or fitting the fastening screw(s); these screws fasten the upper vectorizer (26) or the upper cap (48), or the adaptor with internal and/or external (71) to fasten the Core Sets (46) or (46-A) or (46-B); this adaptor (71) has a cylindrical and/or polygonal prismatic format. The screw cap (34) that belongs to option 1 lid is traditionally threaded or for fitting in. The hook(s) (33) of option 1 lid are traditionally thread, and the lid fastening clamp(s) (29) used for fastening, and/or adjustments, and/or sealing, is utilized adjusting or sealing the upper opening of the Capsules (22), and/or Containers (22-A), and/or (22-B), at the external central lateral part on the lid. And these lids have fittings (73) or not.

Option 2 Lid (35-A) is a variable of option 1 lid, and it is made in a cylindrical or polygonal prismatic format, or in a semi-sphere format with or without fastening, and/or adjustment, and/or sealing shoulder (35-B) that is placed on the external central lateral part of the lid, with passage hole (28-A), to different ignition driver(s) (31). This hole (28-A) has a cylindrical format. Option 2 Lid has another fitting and/or fastening hole (35-F) for the Starting and/or Detonating Device(s) (31). This hole (35-F) has a format that matches the external format of the Starting and/or Detonating Device(s) (31). Option 2 Lid also has one or more fastening and/or fitting holes (28) for hooks (33) for support and/or transportation. Holes (28) have a cylindrical format and internal thread. Option 2 Lid also has one or more running through holes (35-E) for the passage, or fastening, or fitting of the upper vectorizers (26), or of the upper cap(s) (48), and/or of the adaptor (71) with internal and/or external thread for the connection of the Core Sets (46) (46-A), or (46-B); it has traditionally threaded support and/or transportation hook(s) (33); it has ordinary fastening, and/or adjusting, and/or sealing clamp(s) (29), that circles the upper rim of the Capsules (22), or of the containers (22-A), that adjusts, fastens the whole set on the external central lateral part of all lids providing a sealing effect. These lids are provided with fittings (73) or not.

Option 1 Lid (35) or Option 2 Lid (35-A) used in Fire Extinction Flexible Capsules (22), can also be used in Fire Extinction Hard Containers (22-A, 22-B). Also the following options of lids can be utilized for the respective Capsules (22) and/or Containers (22-A):

Option 3 Lid(s) (55) set is made of several lids where the fastening and retention disk (58) is made of a hard material that has a cylindrical or polygonal prismatic format with a passage hole (28-A) for the different ignition drivers (32), with one or more running through holes (54) for screw(s) (62) for fastening the Disk (58) to the upper vectorizer(s) (26), or the upper cap(s) (48), and or adaptor with internal and/or external thread (71) that help fasten the respective Core Sets, and another three or more running through holes (61) for screws (60) for adjusting the set of lids (55) between the Lid (56), the adjusting, retention, fastening, and transportation lid consolidated on disk (58), screws (60) that also run through the lid(s) of experimental containers (57). Hard lids (57) made of polymers that belongs to test Capsules (22) or to Containers (22-A or 22-B). Screws (60) that also run through the lid (56) and that are tightened by the check nut (63) adjusting and fastening the set of lids. The control lid (56) for retention and transportation has a polygonal prismatic format with rims (59-A) to reinforce the structure of Lid (56) with support and transportation holes (59) of the Capsules (22) or Containers (22-A or 22-B), with running through hole (28-A) for driver (32), and with hole(s) (35-C) for fitting and/or fastening the Starting and or Detonating Device(s) (31), and with a lid (57) made of hard polymer and with a format that matches the formats of the Capsules (22) or of the Containers (22-A or 22-B), and with a running through hole (28-A) for driver (31). This set of option 3 lids (55) may be provided with fitting(s) (73) or not.

Option Lid 4 (64) has a hollow cylindrical format with a reinforced base (72) to dampen the impact or pressure resulting from the explosion, with central hole (70) to introduce the fire extinction flow compounds (24) and/or (146), and/or (147), with or without Crystals (40) or to fasten the adaptor (71) with internal and/or external threads, with or without calibrating valve (69), with or without conical running through hole (28-A) for the driver(s) (32), with or without running through hole (75) for fastening the calibrating valve (68) of the Capsules (22) and Container (22-A or 22-B). These valves (68) have a cylindrical format. Option 4 Lid has fitting or fastening hole (74) for lid (65) that is moveable and used for protection of the Electronic Board(s) and their components (66). The Electronic Board(s) and their components (66) have support and fastening pin(s) (67) and fittings for one or more holes (67-A) for fastening and/or fitting the pin(s) (67). Option 4 Lid has two or more support and transportation holes (59) for the Capsules (22) or Container (22-A or 22-B) and these holes (59) have a cylindrical format with or without fitting (73) for fin(s) or wing(s) (79) or spoiler(s) (80) that provide direction towards the target and are also used in the male and female guiding set for target route direction and for starting ignition pull (77) of the Starting and Detonating Device(s) that are provided with fastening rod(s) (77-A) and speed control device(s) (77-B) for the containers. This lid is also provided with an adaptor (71) with internal and/or external thread with a cylindrical format and upper closure and that contains on this upper closure hole (28-A) for running through the different ignition drivers (32) e with or without running through or fastening hole (76) for the calibrating valve (69) of the Core Sets, with or without calibrating valve (68) of the Capsules (22) and Container (22-A or 22-B), with one or more support cylindrical pin(s) (67) for the board(s) (66); Electronic Board(s) and their component(s) (66), with control, reception, signal transmission electronic components and other components, with a cylindrical articulated lid (65) for the protection of the Electronic Board(s) and their component(s)(s) (66) that is closed on the upper part and provided with a running through hole (28-A) for the drivers (32) connected to the Starting and/or Detonating Device(s) (31);

Option 5 Lid (64) is an Option 4 Lid (64) variable that is also made on a hollow cylindrical shape but with a central partition (72-A) with no reinforcement and no central opening on the body of the lid; it is provided with a central running through hole (28-A) for the cylindrical format driver (32) with one or more cylindrical holes (35-E) providing support and fastening the adaptor (71), with or without its calibrating valve (68) fitting hole (75) for an eventual calibration of the Capsules (22) or Container (22-A or 22-B); this valve has a cylindrical format with fitting hole (74) with a circular format to fit the protection articulated lid (65) of the Electronic Board(s) and their component(s) (66) that has one or more holes (67-A) to fit its (their) support and fastening pin(s); this lid also has two or more cylindrical support and fastening holes (59) with or without fittings (73) for fin(s) or wing(s) (79) or spoiler(s) (80) that direct the containers to the target or for the male and female guiding set for the target route and for starting the pull (77), provided with fastening rod(s) (77-A) and speed control device (77-B) for the Capsules (22), and/or Containers (22-A), and/or (22-B). This lid is also provided with an adaptor (71) with internal and/or external thread with a cylindrical format and upper closure and that contains on this upper closure a conical running through hole (28-A) for the driver(s) (32) with or without calibrating valve (68) of the body of the Capsules (22) or Container (22-A or 22-B), with one or more support cylindrical pin(s) (67) for the board(s) (66); Electronic Board(s) and their component(s) (66), with control, reception, signal transmission electronic components and other components, with a cylindrical articulated lid (65) for the protection of the Electronic Board(s) and their component(s) (66) that is closed on the upper part and provided with a running through hole (28-A) for the driver(s) (32) connected to the Starting and/or Detonating Device(s) (31);

Option 6 Lid (64) is an Option 4 Lid (64) variable, also with a cylindrical hollow format and a lid (72) reinforced base to dampen the impact or pressure from the explosion and a central opening (70) to introduce the fire extinction flow compounds (24) and/or (146), and/or (147), with or without Crystals (40) and to fit the adaptor (71) or the respective Core Sets (46), (46-A), or (46-B) with or without hole (75) for fitting the calibrating valve (68) for the eventual calibration of containers Capsules (22) and Container (22-A or 22-B), with fitting hole (74) for the articulated lid (65) for the protection of the Electronic Board(s) and their component(s)(s) (66) and with a circular format and with one or more holes (67-A) for fitting the support and fastening pin(s) (67) of board (66) with two or more support and transportation cylindrical holes (59) with or without fittings (73) for the fin(s) and/or wing(s) (79) or spoiler(s) (80) that direct the Capsules (22), and/or Containers (22-A), and/or (22-B) to the target or for the male and female guiding set for the target route and for starting the pull (77), provided with fastening rod(s) (77-A) and speed control device (77-B) for the Capsules (22), and/or Containers (22-A), and/or (22-B),

Option 7 Lid is an Option 5 Lid (64) variable that is made of a cylindrical hollow format but with a straight base on the lid (72-A) without reinforcement and without a central opening on the body of the lid, with central running through hole (28-A) for the driver (32) with one of more support and fastening holes (35-E) for supporting and fastening upper vectorizer (26) or the upper cap (48) or the adaptor (71), all of them with running through hole (28-A) with or without hole (75) for fitting the calibrating valve (68) for the calibration of Capsules (22), and/or Containers (22-A), and/or (22-B), with fitting circular hole (74) to fit the protection lid (65) of the Electronic Board(s) and their component(s) (66), and with one or more holes (67-A) to fasten the support (67), to fasten and support the board (66) with two or more cylindrical support and transportation holes (59), with or without fitting(s) (73) on the external area of the body of the lid (64-A) to fasten the fin(s) or wing(s) (79), or spoiler(s) (80) that direct the Capsules (22), and/or Containers (22-A), and/or (22-B), to the target or for the male and female guiding set for the target route and for starting the pull (77), provided with fastening rod(s) (77-A) and speed control device (77-B) for the Capsules (22), and/or Containers (22-A), and/or (22-B), with upper vectorizer (26) or upper cap that belong to the Core Sets, and that have a running through hole (28-A) for the driver (32) until the starting device(s) (31);

Option 8 Lid (64) is an Option 6 or an Option 4 Lid variable and it is made on a cylindrical format with a central opening (70) and reinforced base (72) to dampen the impact or pressure from the explosion, with a central opening (70) to fit the adaptor (71) in a cylindrical format with internal and external thread with or without fitting hole (76) for the calibrating valve (69) for an eventual calibration of the Core Sets, with or without a hole (75) to fit the calibrating valve (68) for an eventual calibration of Capsules (22) and Container (22-A or 22-B) with a fitting hole (74) for the removable lid (65) on a cylindrical format closed on the upper part and provided with a running through hole (28-A) for the driver (32) until the starting device (31) for the protection of the Electronic Boards and their components (66). The Electronic Board(s) and their component(s) (66), with control, reception, signal transmission electronic components and other components, withheld by the hole where the support (67) is fixed, for fastening and supporting the board (66) with two or more support and transportation holes (59) with a cylindrical format and with threads (64-C) on the external lower areas of the body of the lid (64-B) to fasten the Capsules (22) or Container (22-A or 22-B) with a cylindrical format adaptor (71) with an upper closure threaded externally and/or internally and holding on the upper closure a running through conical hole (28-A) for the driver (32) with or without fitting(s) (73).

Option 9 Lid (64) is an Option 8 Lid (64) variable made of a hollow cylindrical format with a straight base on the lid (72-A) without reinforcement and without central opening, with central running through hole (28-A) for the driver (32) with one or more support and fastening holes (35-E) for the upper vectorizer (26) or for the upper cap (48) or for the adaptor (71) with or without a calibrating valve (68) fit hole (75) for the calibration of Capsules (22) and Container (22-A or 22-B) with fitting hole (74) on a circular format for fitting the protection lid (65) for the Electronic Board(s) and their component(s) (66) and with one or more support fitting holes (67-A) to fasten and support the board (66) with two or more support and transportation holes (59) with a cylindrical format and threads (64-C) on the lower external areas of the body (64-B) of the lid to fasten the Capsules (22) or Container (22-A or 22-B) with upper vectorizer (26) or upper cap (48) to fasten the respective Core Sets, Electronic Board(s) and their component(s) (66) with control, reception, signal transmission electronic components and other components, articulated lid (65) on a cylindrical format closed on the upper part and provided with a hole (28-A) for the eventual passage of the driver (32) until de starting device (31). With or without fitting(s) (73) as shown in FIGS. 7, 8, 9, 10, 11, 12, 13, 14, 15.

All the Lids may contain or receive or not in any place on their body or area, fittings (73), support and/or guide and/or transportation belts (30), fittings for the fin(s) or the wing(s) (79), spoiler(s) (80), Male and Female Guiding Set (77), fastening Rods (77-A) with or without Speed Control Device(s) (77-B) or other devices necessary to control and provide accuracy to target routes.

All the Lids and their options may optionally hold or not sensor(s) for different identifications and/or for scanning (107-A), and they may also have connected whenever necessary flashing lights or not, signaling light(s), or Light Emitting Devices (107-B), or Reflecting or Fluorescent Device(s) (107-C), adhesive or not, for signaling, identification, and location of their position. The flashing lights or not (107-B), or the Reflecting Device(s), or the fluorescent Device(s) (107-C) can be connected on the external area, or on a lower position, or embedded in some external or internal area of the Capsules (22) or Containers (22-A or 22-B), and will be supplied by solar radiation, batteries, electric power or other necessary traditional means.

Staggering Containers (51-1), or (52-2), or (Rce-3) Construction Process:

Container (51-1) with cylindrical formats and different hard materials receiving its Rings (38) and/or their Guides (39) and that when ready to use guarantee the features that help in the process of obtaining the standardization of the emission of the shock waves because they determine a perfect center for the accommodation inside the Core Sets (46) through the axis central stoppers, as shown in item (37-A) exemplified in FIG. 3, 4 or 5.

Container to hold explosives (52-2) on staggered formats follow a staggered proportion always according to the need of reaching or guarantee a controlled spray to meet the need of imposing a greater strength or high pressure speed for of the spray effect on flows (24) and/or (146), and/or (147), with or without Crystals (40) withheld on the internal part of the Capsules (22) and Container (22-A or 22-B) and also guarantee a strength of a lesser power on the upper part of these same Capsules (22) or Containers (22-A or 22-B) as shown in FIG. 6.

Container (RCE-3) to hold explosives with a cone-trunk format always built according to the need of reaching or obtaining a controlled spray to meet the need of imposing a greater strength of spray on the lower part of the Capsules (22) and Container (22-A or 22-B) and a strength of a lesser power on the upper part as shown on its cone-trunk format in FIGS. 20 and 22.

Container (51-1), or (52-2), or (RCE-3), may or not contain programmed fragilities (23) whenever necessary.

The Explosives or mix of Explosives, or Chemical Compound that generates High Speed Pressure (41) when used in the explosion and blast of the Capsules (22), Container (22-A or 22-B) and on Mortars (96) can be: Low Explosive or Propellant that generate speeds below 2000 m/s; and/or High Explosive or Blasting that generate speeds above 2000 m/s. They can be accommodated separately or in combinations inside the Container (51-1), or (52-2), or (RCE-3).

The delay fuse or not, or explosion train (42) can be utilized in Container (51-1), or (52-2), or (RCE-3), in the Core Sets (46), (46-A), (46-B), and may be used whenever necessary in Capsules (22), Container (22-A or 22-B) and in Mortars (96), they can have traction, and/or electric, and/or electronic, and/or percussion, and/or spark, and/or shock wave, and/or waves starters, or other traditional physical means, instantaneously or delayed, in variable quantities associated or not to other traditional elements to form the explosion train, such as boosters or detonating strings.

Composition of, Propelled-Propellant Crystals and Granules: The, Propelled-Propellant Crystals and Granules (40) may include any type of solid hard matter, with or without defined forms, that absorbs water or not, or other products or compounds that can have a natural origin, and/or be synthetic, and/or semi-synthetic, that can be combined compositions or not with delaying compounds, addictives, gel, emulsions, water that may form compounds inside one or different granulometric measures, although restricted inside the measurements of the particles on One micron until 50 millimeters.

Core Set Construction Process: The, Core Set(s) (46), (46-A), or (46-B) have body (36) of the core set in the cylindrical, cone-trunk, polygonal prismatic, and spherical body made of hard materials that can be bio-degradable or not, milled, injected, molded, extruded, blown or manufactured by other traditional mechanical means, hollow, include different materials or not, and several parts with programmed internal and/or external fragilities (23) or not, pressurized or not with pressurized air and/or another gas and/or liquids through its specific calibrating valve (69).

The lower vectorizer (25) and the upper vectorizer (26) can be built with hard materials that can be biodegradable or not, milled, injected, molded, blown, extruded, or manufactured by other traditional mechanical means, hollow or whole, including different materials or not, and by different parts with the internal part on a conical format with angular measures that vary from 15° up to 179° with the internal part in a cone-trunk format with the angular measures varying from 17° up to 179°, a cylindrical traditional part, and with hard faces to offer mechanical resistance to pressure, temperature, and shock that comes from Propelled-propellant Granules and Crystals (40) thrown and of the products resulting from the explosion of the Container (51-1), or (52-2), or (RCE-3), as well as dividing and or decentralizing and redirecting these pressures or shock received. The body of the core set (36), the Propelled-Propellant Granules and/or Crystals (40) with the lower vectorizer (25) or the lower cap (47) and the upper vectorizer (26) or the upper cap (48) when associated to the Container (51-1), or (52-2), or (RCE-3) with their Rings (38) and/or their Guides (39) bring together the properties of maintenance for the axis center to flexibilize and absorb, hold, and standardize, equalize, and thus propagate the shock waves from the detonation of the explosives or mix of explosives or Chemical Compound that generates High Speed Pressure (41) in a controlled way as shown by the Core Sets (46) and according to FIGS. 3, 4, or the Core Sets (46-A) or (46-B) according to FIGS. 20, 22, and 25.

The Starting and/or Detonating device(s) (31) may have a traditional format, or start by percussion with a warhead, pull hook, spring, pin, percussion, electric, electronic, spark, shock wave, and/or waves, and guide fuse, and/or by remote control, and/or other traditional physical means. The starting or ignition may occur instantaneously or may be delayed in variable amounts associated or not to traditional elements.

Fragilities of the body of the Core Sets (46), (46-A), or (46-B), and of the Container (51-1), or (52-2), or (RCE-3): Containers (51-1), or (52-2), or (RCE-3) bodies, the bodies of the Core Sets (46), (46-A), or (46-B); the bodies of the Capsules (22), or of Containers (22-A), (22-B), and of the Mortars (96) and on Bottle Type containers (96-A) may or not include internal and/or external programmed fragilities (23) with different depths and in one or more directions with triangular, rectangular, semi-circular formats, or combined formats privileging their planned blasting from the inside to the outside, so as to obtain at the explosion their total or partial planned fragmentation forming a mono block with windows, or doors, or pathways for fire extinction flow compounds (24) and/or (146), and/or (147), with or without Crystals (40) with the other chemical products, or products resulting from the explosion because of the Programmed Fragilities (23) exemplified in FIGS. 1, 20, 23, 46, 47, 48 and 49.

Variables of the Decentralizing Adaptor (78): Capsules (22), Containers (22-A), and (22-B), may use the decentralizing adaptor (78) in a cylindrical, polygonal prismatic formats, hollow, with or without internal threads placed in areas to fit the Core Sets (46), (46-A), or (46-B), or only for fitting the Container (51-1), or (52-2), or (RCE-3), directly or through an adaptor (71) with internal and external thread in a non-centralized position promoting whenever necessary the decentralization of the Core Sets (46) or the Container (51-1) or (52-2) or (RCE-3).

Rod(s) (82) on a cylindrical, polygonal prismatic format, hollow, with or without internal and/or external threads with measurements that match the measures of the Capsules (22) or Containers (22-A or 22-B) or of the lids and are used to fasten, support, and/or decentralize the special Core Sets or not, and utilized whenever necessary in Capsules (22), Container (22-A), (22-B) or to fit one or more Core Set(s) (46), (46-A), or (46-B) of alternate formats that are non vertical to the adaptor (71).

The use of the special vulcanizable adaptor (81): the Capsules (22) may deploy a special vulcanizable adaptor (81) with a cylindrical format, hollow, with external thread and reinforcement on its lower external area to fit the tool and with its internal area smooth to fasten the upper open edge of Capsule (22) as exemplified in FIGS. 23 and 24.

The use of Hard Corks (89) made of a self-screwed hard material with a conical, cone-trunk, or pyramidal, or trapezoidal prismatic format with or without a Whole Metal Jacket(s) (89-A) or a Hard Material Semi-jacket(s) (89-B) for the Containers (22-A) and/or Mortars (96): Containers (22-A) and (22-B) or Mortars (96) and/or Bottle Type Container (96-A): after they have been fully assembled and are ready to use may receive a Whole Metal Jacket(s) (89-A) or a Hard Material Semi-jacket (89-B) on their body. In the case of a Hard Cork (89), they can be hard, self-screwed, with or without Whole Metal Jacket(s) (89-A), and/or a Hard Material Semi-jacket(s) (89-B), and other self-screwing materials, and these jackets (89-A) or (89-B) will cover whenever necessary the body of Capsules (22) Container (22-A or 22-B) or of the Hard Cork (89), which after being ready will be fixed on the external lower parts of the Capsules (22) or Containers (22-A or 22-B) that will be used to open or blast mechanical Barriers that might make fire extinction difficult, or they can also be used to close or cover with a lid sealing the wellheads of oil wells in flames, or to fasten the Capsules (22) or Containers (22-A) or (22-A) on the soil.

The Hard Corks (89) may optionally hold or not sensor(s) for different identifications and/or for scanning (107-A), and they may also have connected whenever necessary flashing lights or not, signaling light(s), or Light Emitting Devices (107-B), or Reflecting or Fluorescent Device(s) (107-C), adhesive or not, for signaling, identification, and location of their position. The flashing lights or not (107-B), or the Reflecting Device(s), or the fluorescent Device(s) (107-C) can be connected on the external area, or on a lower position, or embedded in some external or internal area of the Capsules (22), and/or Containers (22-A), and/or (22-B), and will be supplied by solar radiation, batteries, electric power or other necessary traditional means.

Devices or identification systems for: Capsules (22), or Containers—(22-A), (22-B), or Hard Corks (89), or Refractory Container (113), or Special Container (113-A) or Mortars (96) may optionally hold or not sensor(s) for different identifications and/or for scanning (107-A), and they may also have connected whenever necessary flashing lights or not, signaling light(s), or Light Emitting Devices (107-B), or Reflecting or Fluorescent Device(s) (107-C), adhesive or not, for signaling, identification, and location of their position. The flashing lights (107-B) or not, or the Reflecting Device(s), or the fluorescent Device(s) (107-C) can be connected on the external area, or on a lower position, or embedded in some external or internal area of the containers, and will be supplied by solar radiation, batteries, electric power or other necessary traditional means.

Accessories for directions and routes for Capsules (22), and/or Containers (22-A), and/or (22-B), all option Lids (1, 2, 3, 4, 5, 6, 7, 8, 9) will be used in Capsules (22), and/or Containers (22-A), and/or (22-B), that can have in any area of the Lids as in any external area of the containers whenever necessary coupled to their fittings (73) fins or wings (79) or spoiler(s) (80) that provide direction towards the target, made of the same material of the Capsules (22) or Containers (22-A or 22-B) or of the lid, and in traditional formats, or they can have coupled on these Lids whenever necessary the male and female guiding set for target route and pull (77) with one or more fastening rod(s) (77-A) or whenever necessary with a speed control device(s) (77-B) that can be made of hard material and have a cylindrical or polygonal prismatic format, or the format of a fluting with fittings in between, and that may hold inside a liner or brake lining covering the Cable(s) or guiding Chain(s) (105) to guide or direct the containers Capsules (22) and Container (22-A or 22-B), and the Cable(s) or Chain(s) that may hold or not a Starting rotating conical Dart(s) (106), and/or Detonators or starter(s) connected on the pendulum Articulated Rod(s) (107) that may or not be magnetized to generate absolute parallelism between them.

The Starting rotating conical Dart(s) and/or the Detonators and/or starter(s) are made of hard material with measurements according to the Cable(s) or Chain(s) (105) of the speed control device(s) (77-B) with a conical format on the upper part and a cylindrical format with threads on the lower part for the connection on the Rod(s) (107) with a running through central hole for the passage and fastening of cable(s) and/or chain(s) (105) and rotating devices introduced inside the threaded lower part, and they can be magnetized or not. FIGS. 31 and 32.

The pendulum Articulated Rod(s) (107) can be made of a hard or flexible material with a conical or polygonal prismatic format, hollow or not, with or without internal and/or external threads and lengths according to the measures of the Dart(s) (106) made of parts that interconnect to each other to facilitate an eventual articulation during assembly and changes on the length, and that may or may not be magnetized when they have magnets introduced inside, or when they are made of magnets to generate opposite magnetic fields and provide absolute parallelism between them, as the respective items shown in FIGS. 31 and 32.

Optionally on the Cable(s) or Guide Chain(s) (105), on the rotating, conical Darts (106), and on the pendulum Articulated Rods, Sensor(s) may be installed for different identifications and/or for scanning (107-A), and also have connected whenever necessary flashing lights or not, signaling light(s), or Light Emitting Devices (107-B), or Reflecting or Fluorescent Device(s) (107-C), adhesive or not, for signaling, identification, and location of their position. The flashing lights or not (107-B), or the Reflecting Device(s), or the fluorescent Device(s) (107-C) can be connected on the external area, or on a lower position, or embedded in some external or internal area of the Capsules (22), and/or Containers (22-A), and/or (22-B), and will be supplied by solar radiation, batteries, electric power or other necessary traditional means.

Fin(s) or wing(s), or spoilers for the Mortars (96): the Bottle Type container (96-A) that belongs to the Mortars (96) may or may not, according to the dynamics of fires, be provided with fins or wings (79), or with spoiler(s) (80) that provide direction towards the target always in the appropriate shape and quantities enough to throw them and make them reach the planned distances.

Special land vehicles (124) or (127), spherical containers (22-B) after ready to use will be deposited and hoisted by the thermal booth (133) by the Special Telescopic Hoist (129) that is coupled to its respective terrestrial Vehicle (127) and that will transport them up to the telescopic Trough (128) that will be positioned inside the windows of the buildings (125) and in a descending position, so that when the spherical containers (22-B) are deposited or placed on the telescopic trough (128) towards the interior of the buildings (125) through their windows or other openings, the ignition of the explosives or Chemical Compound that generates High Speed Pressure (41) that belong to the spherical containers (22-B) will occur via remote control by a programming timer or electronic timer, or analog timer, or by wick or other means as exemplified in FIG. 42.

Cable(s) or Chain(s) for the Target Route Guide with rotating conical Dart(s), Pendulum Rod(s) that can be magnetized or not: the Cable(s) or Guide Chain(s) (105) for route direction during Capsules (22), and/or Containers (22-A), and/or (22-B) launch, or the Cable(s) or Chain(s) for lowering (108) to deposit or overlaying the Capsules (22), and/or Containers (22-A), and/or (22-B) over the foci of heat and/or fires, or the Cable(s) or Chain(s) (108) to support during lowering process and/or lifting process of Capsules (22), and/or Containers (22-A), and/or (22-B) or of Refractory Containers (113) or Special Container (113-A), or the optional Cable(s) (118) to control the valves operations (90-R) will be controlled by special electric, electronic, mechanical, or hydraulic hoists (109-A) with pulleys (109) that are connected inside or to the body of the Helicopter(s) (97 or 97-A). The Cable(s) or Chain(s) (108) may be provided with a rotating device (110), mobile articulated hook(s) (99) on their far end to the aircraft/helicopter, or the Cable(s) or Guide Chain(s) may have whenever necessary starting rotating conical Dart(s) (106) that may be connected or not to the pendulum articulated Rod(s) (107) that may or not be magnetized to generate absolute parallelism between them, and that may or not hold sensors for different identifications. Through this set of equipment it is possible for the operator of the properly equipped aircraft/helicopters to accurately control the distance from the soil and target route precision for launching, exploding, and blasting the Capsules (22), and/or Containers (22-A), and/or (22-B), with surgical accuracy.

The Cable(s) or Chain(s) (105) may be utilized without the Dart(s) and without the Pendulum, Articulated Rod(s) (107), or they may be only equipped with the Dart(s) (106). They can be equipped with sensor(s) for different identifications and/or for scanning (107-A), and they may also have connected whenever necessary flashing lights or not, signaling light(s), or Light Emitting Devices (107-B), or Reflecting or Fluorescent Device(s) (107-C), adhesive or not, for signaling, identification, and location of their position. The flashing lights or not (107-B), or the Reflecting Device(s), or the fluorescent Device(s) (107-C) can be connected on the external area, or on a lower position, or embedded in some external or internal area of the Rods (107), and will be supplied by solar radiation, batteries, electric power or other necessary traditional means.

### Assembly Sequence for Container (51-1), or (52-2), or (RCE-3):

One of the bodies (37, 37-A, 37-B) of the Container (51-1) or (52-2) or (RCE-3) is prepared to receive whenever necessary the Programmed Fragilities (23);

(38) rings and/or (39) guides are connected in determined parts on the external area;

The upper cap (45) that belongs to the bodies (37, 37-A, 37-B) from the respective Container (51-1) or (52-2) or (RCE-3) is fastened;

The explosives, or mix of explosives and/or a Chemical Compound that generates High Speed Pressure (41) is introduced inside the bodies (37, 37-A, 37-B) compacting them up to the level of the opposite edge;

The already dented explosion-train/delay fuse or not (42) is fixed to its respective different driver (32) for ignition in the center of the lower cap (44);

The lower cap (44) already equipped with the fuse on the side that is still open is connected and becomes Container (51-1), or (52-2), or (RCE-3) ready to use.

This sequence is shown in FIGS. 5, 6, 20 and 22.

### Assembly Sequence for the Core Set:

Body (36) of the Core Set (46), (46-A), or (46-B) is prepared to receive or not whenever necessary the programmed fragilities (23), and to receive the connection to the lower vectorizer (25), or of the lower cap (47) that belong to the Core Set (46), (46-A), or (46-B) in one of its openings;

### Part of the Crystals (40) is Introduced:

One fully assembled Container (51-1), or (52-2), or (RCE-3), is introduced according to the position shown in FIGS. 5, 6, 20 and 22.

The body of the Core Set (36) is completed with the remainder of the Crystals (40) leaving driver (32) outside the Core Set (36) body;

Driver (32) is introduced by hole (26-A) of the upper vectorizer (26), or of the hole (50) of the upper cap (48), or the hole (28-A) of the adaptor (71) that is introduced connected to the upper part of the body that belongs to Core Set (36), thus obtaining the Core Set (46), (46-A), or (46-B) ready to connect to its respective lid ready to be introduced in the respective Capsules (22) or Containers (22-A or 22-B) as shown in FIGS. 3, 4, 20 and 22.

### Air and Land Engineering Processes:

These operations with these new equipment to fight Forest Fires, Urban Fires, Industrial and Technical Fires receive the following classification, namely:

Air Engineering;

Land Engineering;

Air Engineering combined with Land Engineering.

To fight all kinds of fires, aircrafts (97-B) or special helicopters (97) and (97-A), will be deployed, all provided or not with the pieces of equipment and other equipment described in items (18-A, 92, 93, 98, 99, 109, 109-A, 110), and also special land vehicles (124, 127), or Launcher(s) (122), (134). When the Capsules (22) or Containers (22-A or 22-B) are utilized without the need of aircrafts/Helicopters, they will be deposited and utilized directly over the soil, with or without the use of the Tripod for support and alignment (121) through which the applications and deployment of the respective Capsules (22), or Containers (22-A), or eventually spherical Containers (22-B), and/or whenever necessary for the Mortars (96) occurs. The containers hold the respective Fire Extinction Flow Compounds (24) and/or (146), and/or (147), with or without Crystals (40) and/or other chemical anti-flame products and may or not utilize explosives or Chemical Compound that generates High Speed Pressure (41) or mix of explosives as explosion agent, or blasting agent to obtain the spray effect the appropriate and necessary alignments to match the alignments with the soil surface.

Specifically in the case of Mortars (96), these can be launched by aircrafts (97-B) or helicopter (97), robots (138), or by special launchers (122) coupled to the support and alignment Tripod(s) and supplying or not land vehicles (124) equipped with launchers (122), bazookas (134), cannons, and other (122). After the Bottle Type Containers (96-A) are launched by the Bazookas (134) they reach the soil and start their ignition device; these can also be started on their impact on the soil, or by other traditional means with timers. The Refractory Container (113) and Special Container (113-A) can be hoisted, lowered via hoists (109-A), pulleys (109), Cables or Chains (108) that are connected inside the respective helicopters (97-A) or (97).

The Special Container (113-A) is partially connected to the body of the aircraft/Helicopter and remains hanging very close to the aircraft (97-B), or Helicopter (97) and after the Special Container (113-A) is fully supplied and transported by the respective helicopter (97) it can be lowered far from the fire, and in this case its Another Cooling System and/or Extinction system is run, specially when the Special Container (113-A) is provided with and only using its output Pipe (114) in a protection box with or without Bomb(s) (114-B), retractable mobile Reel (114-A) with Special Hose(s) or pipes (115) with a Nozzle and/or open/close valve (117), and the water will flow through discharge or through the pressure of the water Pump(s), and/or Pumps for other Cooling and/or extinguishing Fluid(s) and/or (146), and/or (147), with or without Crystals (40) towards the foci of heat or fires, as exemplified in FIG. 36.

As an option, the jet or the spurt of the water launched by the Nozzle or open/close spray valve (116) may or may not have the addition of the Crystals (40), in the state of particles (powder and/or granules) that are then mixed by dosing devices, mixing the Crystals (40) in the water jets of the Nozzle or open/close spray valves (116), belonging to the Special Container (113-A).

As part of this new technology the Crystals (40) can have a broader application in the extinction of foci of heat and/or fires, through the use of these same crystals in the diffusing nozzles connected to the fire-fighting truck hoses or as a “dosing sachet”, or for its use by other systems and/or fire extinction equipment, such as pressurized water cylinders and blowers with water.

In the case of the Refractory Container (113), this one will be fully coupled to the body of the helicopter (97-A) as shown in FIG. 38. During the fight against fires through the use of the Refractory Container (113) or Special Container (113-A), these will be lowered from the body of the aircraft/Helicopter by the crane (109-A), and the pulleys (109). These aircrafts/Helicopters will be hovering, at a minimum secure distance from the target, foci of heat or fires maintaining the Refractory Container (113) within the fire, when their valves (90-R) will open up to launch the water with or without diverse additional chemical products, that may be added during the water discharge, thus becoming fire extinction flow compounds (24) and/or (146), and/or (147), with or without Crystals (40), to spill them, or to spray them, or launch them in a completely controlled fashion and directed to or into the foci of heat or fires, as is shown in the example in FIGS. 28, 29, 35, 37, 38 and 39.

When the helicopter (97-A) has already been equipped with and is carrying the Refractory Container (113) in its body, the helicopter (97-A) can take off at high speed, enabled precisely because of the coupling of the Refractory Container (113) to its body. It will then go to the site of the fire, maintain a safe distance, and remains hovering over the site, when it will begin to lower the Refractory Container (113), through the cables or the chains (108), attached to and controlled by the electrical and/or mechanical winches (109-A) by dropping the Container into the fire. This is when the pilot or operator will open, in a controlled way, the outlet or discharge valves. (90-R), thus initiating the fire extinction and making full use of the Cooling and/or Extinction liquid(s) (24) and/or (146), and/or (147), with or without Crystals (40), on account of the Refractory Container (113), being placed in a site where the Barriers presented in Figures (A) and (B) will no longer decompose or evaporate the water and/or the other compounds contained in them. These outlet or discharge valves (90-R) are opened in a controlled fashion to determine the amount of water flow, as a function of the type of fire which exists at the site. The helicopter (97-A) will begin its flight for controlled and assisted displacement, guiding the hanging and lowering of the Refractory Container (113), through the helicopter (97-A) and the Special Container (113-A) through the helicopter (97) in the direction of the fires, or the proximities of the fire, thus making the best possible use of all of the operation which are part of these processes.

To be able to use and put the Refractory Container (113) or Special Container (113-A) into operation, helicopters (97-A) or helicopters (97) may be used, equipped with items (18-A, 92, 93, 98, 99, 105, 106, 107, 108, 109, 109-A, 110), making them specially equipped to enable the lowering to fill the containers with water, hoist them when they have been completely filled up, for the full or total coupling into the helicopter's body (97-A), when we are dealing with the Refractory Container (113) or when we are dealing with the Special Container (113-A), by merely bringing it closer to the body of the Helicopter (97).

The Assembling Sequence for Capsules (22) and Containers (22-A) and their Going into Operation:

The Capsules (22) and Container (22-A) are prepared, and when necessary, these will undergo programmed fragilities (23). It is possible to carry out these fragilities horizontally as well as vertically, from the outside as well as from the inside, or even on both sides of the Capsules (22), and/or Containers (22-A). There will be the formation of plates, in sufficient numbers according to the dynamic needs of the fire that is being contained. Whenever necessary, they will also be equipped with Support Belts (30).

The Capsules (22) or Container (22-A) are hung by the Belts (30) thus enabling these to be filled with water or their fire extinction flow compounds (24) and/or (146), and/or (147), with or without Crystals (40) and closed with a lid;

The respective Core Set (46) (46-A) or (46-B) is connected to one of the respective Lid options (1, 2, 3, 4, 5, 6, 7, 8, 9);

The Lid equipped with its respective Core Set (46, 46-A, 46-B). It is connected to the Capsules (22) or Container (22-A);

Whenever necessary, connected to the lid, or when necessary in the external areas of the Capsules (22) or Container (22-A) are the male and female guide set (77) with fixation rods (77-A), with or without Speed Control devices (77-B) or whenever necessary, connected or not to fin(s) or wing(s) (79) or spoiler(s) (80);

Whenever necessary, connected to the Lid(s) and/or to the Capsules (22), and/or Containers (22-A), are the Cable(s) or Chain(s) (105), provided with the conical rotating Dart(s) (106) and the Pendulum Rod(s) (107), all equipped with the sensor(s) for diverse identifications and/or for scanning purposes (107-A), and/or the Flashing lights or not, signaling Bulb(s), or the Light Emitting Device(s) (107-B) and/or Reflective or Fluorescent Device(s) (107-C), whether adhesive or not, for signaling, identification and location.

after having been partially or totally assembled, the Capsules (22) or Container (22-A), may or may not, depending on the need, be kept in freezers to freeze their Fire Extinction Flow Compounds (24) and/or (146), and/or (147), with or without Crystals (40).

the Capsules (22), and/or Containers (22-A), whether frozen or not, with or without Container (51-1), or (52-2), or (RCE-3), with or without Core Sets (46) (46-A) (46-B), will be stored inside the helicopters (97) or the aircrafts (97-B), all equipped or not with the item (18-A, 19-A, 92, 93, 98, 99, 105, 106, 107, 108, 109, 109-A, 110), hung on their trolley (92) which will be connected to a special guiding rail (93) for aircrafts (97-B) or Helicopters (97) and for storage, displacements, positioning and the launching of Capsules (22), and/or Containers (22-A).

these guiding rails (93), have at one of their extremes, located at the end of the door (98) of the aircraft/Helicopter and on the sides of this end a connection to other pulleys (109) and alongside with the end of the rail (93) there will also be a hook or systems to launch the Capsules (22), and/or Containers (22-A).

the Capsules (22), and/or Containers (22-A), will be loaded inside the aircraft/Helicopter through the use of a winch (109-A), or through other conventional means.

the aircraft/Helicopters that stores the Capsules (22), and/or Containers (22-A), will take off and move in the direction of the fires, and will hover over the focus or foci of heat and/or of fire.

with the helicopter/aircraft in a hovering position, at a safe height, the process to launch the Capsules (22) or Container (22-A) will then begin.

without the use of the Cable(s) or the Chain(s) through the free launching process for Capsules (22), and/or Containers (22-A), as illustrated in FIG. 30.

or through the consecutive launching process, by means of One or Two guiding Cable(s) or Chain(s) (105), as seen in FIGS. 31 and 32.

or by lowering and hoisting the Capsules (22), and/or Containers (22-A), through a process of lowering them one at a time, using the Cable(s) or Chain(s) (108), as seen in FIGS. 33 and 34.

these launchings can also take place through other means that can help reduce the weight transported by the aircrafts/Helicopters.

for any type of launch, hoisting or lowering of the Capsules (22), and/or Containers (22-A), to take place, the Capsules (22), and/or Containers (22-A), will necessarily have to be stored on the rail (93) and be displaced by means of the rail (93), thus leaving them at the point of launch within the aircraft/Helicopter. This displacement can be carried out or not, through the use of operators (117), robots (138), or through other means.

for the consecutive launching process specifically, through the use of One or Two Guiding Cable(s) or Chain(s) (105), the operator or another system or device will place the Cable(s) or Chain(s) inside the male and female set (77).

to put into operation the consecutive launching process specifically, through the use of One or Two Guiding Cable(s) or Chain(s) (105), the Capsules (22) or Container (22-A) will be launched guided through the Cable(s) or Chain(s) (105) hanging from the aircraft, that may or may not have one of the ends hanging, with the Dart(s) (106) that may or may not be connected to its Rod(s) (107) that can be magnetized or not, and when and/or if the sets (77) are connected to the Lids or the containers pass through the Dart(s) (106) and the Rod(s) (107), they will pull the Initiating Device(s) (31) which will be connected to the respective Lid, which is when the explosion and blasting of the Capsules (22) or Container (22-A) will take place. What will then happen is a subsequent release of plates when they will spray their content in the manner and in the direction planned, whether within the fire or very close to the foci of heat.

in the free launching process of Capsules (22), and/or Containers (22-A), the Cable(s) or Chain(s) (105) (108) are not used.

in the one at a time process to lower the Capsules (22), and/or Containers (22-A), through the use of a Cable(s) or Chain (s) (108), their ignitions can occur by pulling or through a programmed timer or remote control, to trigger the explosion and the breakup of Capsules (22), and/or Containers (22-A), with the occurrence of subsequent release of plates, which is when they will spray their content in the manner and direction planned, within the fire or very close to the heat foci.

for Capsules (22) or Container (22-A) to be put into operation for the free launching process, they can, whenever necessary, be equipped with aerodynamic systems through the fin(s) or wing(s) (70) or spoiler(s) (80), to guarantee precision on the path to the target, where their explosions can occur either by impact with the soil, through a programmed timer, through remote control or traction or pulling.

when necessary, Capsules (22), and/or Containers (22-A) can have fixated to their lower side self-screwing Hard Corks (89) with or without Whole Metal Jacket(s) (89-A) or Semi-Jacket(s) made of Hard Material (89-B) which will also be directional and/or breakers, with the aim of helping on the path to the target, breaking the Barriers, especially the mechanical ones, also operating as a fixation system on the ground for the Capsules (22), and/or Containers (22-A), on stand-by.

when the Capsules (22), and/or Containers (22-A), are used, by being placed or fixated on the ground, they will act as preventive stand-by Capsules (22), and/or Containers (22-A), or when they are lowered or hoisted by Cable(s) or Chain(s) (108) from the helicopter (97), they will act to extinguish eventual fires and/or for the technical fight of fires on oil wells, fuel deposits, fire in tree crowns (136) or wherever it becomes necessary to have this breaking system, or more robust and capable fire extinction processes.

after all of these operations, what is put into place are operations to extinguish the foci of heat and/or any type of fire, especially forest fires, and forest fires with fires in tree crowns.

Sequence for the Assembly of Spherical Containers (22-B) and their Operations:

there are the containers (22-B) in the spherical format, made up of a single piece, or two parts.

the programmed fragilities process (23) is carried out or not in the body of the Containers (22-B), whenever necessary, whether it be internally or externally.

equipped with an upper part (84) with a semi-spherical shape with an orifice (83), with a cylindrical format located at the upper edge and with a female insertion or fitting (85).

equipped with a lower part (87) with a semi-spherical format, with a male insertion or fitting (86).

whenever necessary, a Plummet Maintenance Counter-Weight (88) that can be connected or not and may or may not be magnetized, in the inside lower part of the spherical part.

whenever necessary, the respective Core Set(s) can be connected or not in the lower part of the respective Lid.

the female edge (85) is connected in the edge of the lower part (86) closing the spherical container (22-B).

through the opening hole (83) water or Fire Extinction Flow Compounds (24) and/or (146), and/or (147), are introduced, with the addition or not of Crystals (40) or other chemical extinction products.

one of the lid options (1, 2, 3, 8, 9) is connected and then this Lid is connected to its respective Core Set, or merely to the Container (51-1) or (52-2) or (RCE-3).

whenever necessary, there is a connection to the Lid(s) and/or the spherical containers (22-B) of the sensor(s) for diverse identification purposes and/or for scanning(s) (107-A) purposes and/or the flashing light or not, signaling Bulb(s) or the Light Emitting Device(s) (107-B) and/or Reflective or Fluorescent Device(s) (107-C), adhesive or not, for signaling, identification and location.

after the spherical containers (22-B) have been loaded with water or their fire extinction flow compounds (24) and/or (146), and/or (147), with or without Crystals (40), the container (22-B) is closed with its respective lid, with or without the core set, which is when, if necessary, these can be placed in freezers to freeze the water or compound (24) and/or (146), and/or (147), with or without Crystals (40).

the Containers (22-B), with frozen water or not, or with the frozen compounds or not, with the Core set introduced or not, or with merely one of the Container (51-1), or (52-2), or (RCE-3), will be transported and place in special land vehicles or inside the aircrafts/Helicopters which will launch them in the hovering position.

in the aircrafts/Helicopters containers (22-B) will be stored in the special guiding rails (93), through the trolleys (92) or the trolley winch, after which they will be guided by operators or through other means up to the point of launch, when they will be launched by the process of free launching, without the use of Cable(s) or Chain (s) (105), or, whenever necessary, through the one at a time process, hanging from a Cable(s) or a Chain(s) (108), being lowered into the target or over the foci of heat or forest fires, urban or technical.

after being made ready to use, the spherical containers (22-B) in the special land vehicles (124) or (127) will be placed and hoisted by the thermal booth (133), by the Special Telescopic Winch (129) which is coupled to its respective land vehicle (127) and transported to the height of the telescopic Trough (128) which will be positioned inside the windows of the buildings (125) and in the sloping position, in such a way that when the containers (22-B) are placed on the telescopic trough (128), they will be led, by the force of gravity downwards into the trough (128) to the inside of the buildings (125), through the windows or other openings, as can be observed in FIG. 42.

the ignition of explosives and/or a Chemical Compound that generates High Speed Pressure (41) that will blast the containers (22-B) will be carried out through remote control, through a programmed timer or electronic or analog timers, or through the use of a wick, or even through other means.

Sequence to Assemble the Refractory Container (113) and Special Container (113-A) and their Operations:

the body (90) of the Refractory Containers (113) and Special Container (113-A) has the shape of a prism, a cylinder, a sphere, a conical trunk or can be egg-shaped.

the lids (90-A) are connected to the body (90). These have already been connected to their buoys/floaters (90-D), that already have their sealing rims (90-B) made of rubber or a diversity of other materials, and that act to contain water or the fluid compounds for the fire extinction (24) and/or (146), and/or (147), with or without Crystals (40).

the lids (90-A) are connected and articulated through their hinges (90-C) and delimited by the Delimiting Angle Bars (90-E) for the Lids (90-A).

this connects to the body (90) the hooks (90-F) for support and/or fixation, the counter-weight (90-G) for immersion, the motor (90-H) and/or an electrical, electronic, mechanical or hydraulic rotating systems, the pin(s) for insertions or fittings and fixation (90-I), pins (90-I) and in these pins one of the types of sprayers is connected (90-J), one that has the shape of the body (90) and that has holes at the outlet (90-K) or (90-L) for the water and/or the other compounds (24) and/or (146), and/or (147), with or without Crystals (40). These sprayers will be positioned on the side or at the bottom of the body (90), and/or only in the bottom.

a set of male and female insertions or fittings is installed overlaying the valves (90-R) that will act to seal off the water and other products (90-M) over the valves (90-R).

into the optional cable(s) (90-O) there is a connection to drive the opening and/or closing of the one or many valves, in the mobile axis of the motor (90-N) and/or the rotational system for the valve control (90-R), through a ring (90-P) for adjusting and fastening of the cable(s) (90-O) and the arm and/or rod (90-N).

the hinges (90-C) are installed over the valves, a structural guide (90-Q), the ring (90-P), so that when the motor is started up (90-H), where the valves (90-R) are fixated and supported and run over a structural base, the valve(s) (90-R) will open and close.

whenever necessary, connected to the body of the Refractory Container (113) or Special Container (113-A) or to the Cable(s) or Chain(s) (108), are the sensor(s) for a diversity of identifications and/or for scanning purposes (107-A), and/or the flashing lights or not, signaling Bulb(s), or the Light Emitting Device(s) (107-B) and/or Reflective or Fluorescent Device(s) (107-C), adhesive or not, for signaling, identification and location.

whenever necessary, a motor is installed (90-H), which when activated will open or close the valves, and through the side areas and/or through the bottom of the tubes (90-L) will spurt out the water and/or the other compounds (24) and/or (146), and/or (147), with or without Crystals (40), as can be seen in FIGS. 28 and 29.

in the specific case of the Special Container (113-A), as an option, in the body (90) is installed equipment for the Housing of the discharge Pipe(s) (114) in protective Housing, with or without a water Pump(s) (114-B) and with or without a Mobile and Retractable Reel, equipped with discharge pipe(s) (114-A), for the Special Hose(s) (115) or discharging pipe(s) by gravity, with or without a reinforcement mesh and with or without anti-flame coating, and with a Nozzle or open/close spray valve (116). When the body (90) is not equipped with the water Pump(s), it is necessary to highlight that the water with or without other compounds (24) and/or (146), and/or (147), with or without Crystals (40) will be disposed of by discharge or the force of gravity, becoming specifically transformed into Special Container (113-A).

to make the Refractory Container (113) operational, it will always be coupled, supplied, hoisted and lowered through the helicopters. (97-A)

the helicopter (97-A) will take off and move towards the lakes or pools (120) lower the Refractory Container (113) into the lake (120), supplying it with water.

the Refractory Container (113), will have been filled and hoisted up to the point of its complete coupling to the body of the Helicopter (97-A) when the latter will move at maximum speed to the target, to the fires.

the Helicopter, already positioned at a safe minimum height, will hover completely over the foci of heat or fire, when the operator (117) will activate the lowering of the Refractory Container (113) until it has reached the internal side of fire, drive the controlled opening of the Valves (90-R), opening them to have the discharge of the compounds (24) and/or (146), and/or (147), with or without Crystals (40), which is when the spraying will take place within the foci of heat or fires.

after the valves are opened (90-R) inside the fire, the process of fire extinction begins, when the operator (117) will move the helicopter (97-A) with the Refractory Container (113) lowered inside the fire, going in the direction of the line of fire, over the fire, until there is a total discharge of the water.

when the Refractory Container (113) empties it's content over the fire, the operator (117) hoists it completely up to the body of the helicopter, reinitiating the operation to filling it up again, as seen in FIGS. 37, 38 and 39.

to fill up, hoist and lower, specifically while using the Special Container (113-A), the Helicopter is used (97), adopting all of the procedures used for Refractory Container (113).

the Special Container (113-A) is not coupled to the body of the helicopter (97), remaining very close to it nevertheless.

the Special Container (113-B), equipped with a discharge Pipe(s) Housing (114) in a protective housing with or without a water Pump (114-B), with or without the Mobile Retractable Reel (114-A) contains a Special Hose(s) or pipe(s) (115) equipped with a Nozzle and/or open/close spray valve (117).

the Helicopter (97), already with the Special Container (113-A) which is duly filled, displaces itself to the target, hovering at a secure height in the proximity of the fires or foci of heat. The Special Container (113-A) is lowered reaching the vicinities of the fires or foci of heat, and:

the operator (117) of the Helicopter will activate the Retractable Mobile Reel through several controls, so that the Hose(s) (115) will displace itself to the pipe Housing (114), up to the location of the land operator (117), where the operator will take the hose, regulate the extension of such a Hose (115) so that its weight will fall on the Special Container (113-A), thus leaving the Hose hanging.

in the Hose (115), the Nozzle or open/close spray valve (104) is opened, and it squirts out its water or its compound (24) and/or (146), and/or (147), with or without Crystals (40) into the foci of heat, thus beginning the extinction of all fires, making the best possible use of the Cooling and/or Extinction Liquids (24) and/or (146), and/or (147), with or without Crystals (40), exactly because of the that is positioned at a site where the Barriers presented in Figures (A) and (B) will no longer decompose or have their water evaporate and/or their others compounds as can be seen in the example in FIG. 36.

to once again fill in the Special Container (113-A), the hose (115) is withdrawn by the Retractable Reel (114-A), through the retractable drives or through the use of a remote control.

Sequence of Assembly of the Mortars (96) and of the Bottle Type Containers (96-A) and their Operations:

there is a Reinforced Metal Capsule (96-C) which has already been connected to it's fuse/explosion train. (42);

introduction of the explosive (41) and/or mixtures of Explosives into the Metal Capsule (96-C);

prepares, when necessary, the Bottle Type Containers (96-A) with Programmed Fragilities (23);

introduces or not into the Bottle Type Containers (96-A), whenever necessary, the respective Core Set, already connected to its Rings (38) or Guides (39) and the percussion Pin (96-D) that will detonate de delay fuse or not or the explosion train (42);

introduces, whenever necessary, into the Bottle Type Containers (96-A) only the respective Container (51-1), or (52-2), or (RCE-3);

introduces into the Bottle Type Containers (96-A) the Fire Extinction Flow Compounds (24) and/or (146), and/or (147), with or without, the addition of Crystals (40) or other chemical products, filling it up to the edge of the Lid (96-B);

the Bottle Type Containers (96-A) closes with its Lid (96-A);

coats or not, whenever necessary, the Bottle Type Containers (96-A) with its Whole Metal Jacket (89-A) or only with a Semi-jacket of Hard Material(s) (89-B);

connects, whenever necessary to the Mortars (96), or to the Bottle Type Containers (96-A) the sensor(s) for diverse identifications and/or for scanning purposes (107-A) and/or the flashing lights or not, signaling Bulb(s), or the Light Emitting Device(s) (107-B) and/or Reflective and Fluorescent Device(s), whether adhesive or not for signaling, identification and location.

introduces within the Metal Capsule (96-C) already supplied with its Explosive (41) and/or mix of Explosives, the Bottle Type Containers (96-A) transforming them into Mortars (96) that are ready to use;

introduces the Mortars (96) into their respective launcher(s) (122) or in their Bazooka (134), activates the initiation devices, launching the Bottle Type Container in or over the foci of heat and fires, as can be seen in the example on FIGS. 40, 41 and 43.

Sequence to Put into Operational the Fighting Methods Through the Aircrafts (97-B) or Helicopters (97) for the Free Launching of Capsules (22), and/or Containers (22-A), and/or (22-B), without the Use of Cables or Chains:

prepares the Capsules (22), and/or Containers (22-A), and/or (22-B), that when necessary, will undergo the programmed fragilities (23), that can receive fragilities horizontally as well as vertically, on the outside as well as on the inside or even yet, on both sides of the Capsules (22), and/or Containers (22-A), and/or (22-B), with the formation of plates in sufficient numbers according to the dynamic needs of the type of the fire being contained, equipping them when necessary with Support Belts (30);

when necessary, hangs the Capsules (22), and/or Containers (22-A), and/or (22-B), or by the Belts (30) enabling these to be filled with water or the fire extinction flow compounds (24) and/or (146), and/or (147), with or without Crystals (40) and closed with their respective lid already connected or not, when necessary, to the respective Core Set (46), (46-A), or (46-B) or, when necessary, only to the Container (51-1), or (52-2), or (RCE-3) in one of the respective Lid options (1, 2, 3, 4, 5, 6, 7, 8, or 9);

connects to the already filled Capsules (22), and/or Containers (22-A), and/or (22-B), or the Lid equipped or not with its respective Core Set;

after they have been partially or totally assembled, the already filled Capsules (22) or the Container (22-A or 22-B) can or cannot, whenever necessary, be placed in a freezer to freeze their Fire Extinction Flow Compounds (24) and/or (146), and/or (147), with or without Crystals (40);

when necessary, these Capsules (22), and/or Containers (22-A), and/or (22-B), can be equipped or not with aerodynamic systems through fin(s) or wing(s) (70) or spoiler(s) (80), to guarantee precision on the path to the target, which may be on the outside of the Capsules (22), and/or Containers (22-A), and/or (22-B) body, or on any area of the Lid;

the already filled Capsules (22) Container (22-A or 22-B) and mortars (96), ready to use, frozen or not, with or without Container (51-1) or (52-2) or (RCE-3), with or without the Core Set (46) (46-A) or (46-B) will be stored inside the helicopters (97) or aircrafts (97-B), all equipped with the items (18-A, 19-A, 92, 93, 98, 99, 105, 106, 107, 108, 109, 109-A, 110), and with the Capsules (22) or Containers (22-A or 22-B) hanging from their trolleys (92) which will be connected to a special guide rail (93) for aircrafts/Helicopters and for storage, displacements, place setting and the launching of Capsules (22), and/or Containers (22-A), and/or (22-B);

these guiding rails (93) have, at one extremity located at the door (98) of the aircraft/Helicopters, on the sides of this end a connection to other pulleys (109) and alongside the end of the rail (93) there will be a hook or Capsules (22), and/or Containers (22-A), and/or (22-B) launching systems ready to use.

the Capsules (22), and/or Containers (22-A), and/or (22-B), will be loaded inside the aircraft/Helicopters through the Winch (109-A);

the aircraft/Helicopters that will store the Capsules (22), and/or Container (22-A), and/or (22-B), will take off and move in the direction of the fires, where it will hover over the foci of heat and/or fire;

the launching of the Capsules (22), and/or Containers (22-A), and/or (22-B), with or without the use of Cables or Chains will begin through a process of free launching, as seen in FIG. 30 or these launches can take place through other means that will help reduce the weight to the transported by the aircrafts/Helicopters;

the Capsules (22), and/or Containers (22-A), and/or (22-B), launched reach their targets, foci of heat or fire with surgical precision;

after all of these operations, the land operator, or other devices, complete the operation through the ash fire process, when necessary;

thus all operations to extinguish foci of heat and/or any type of fire, are concluded, especially forest fires and forest fires with fire in the tree crowns.

Sequence to Put into Operation the Methods of Fight through Aircrafts/Helicopters Launching Capsules (22), and/or Containers (22-A), and/or (22-B), by Means of the Use of One Guiding Cable or Chain (105):

the Capsules (22) and Container (22-A) or (22-B) are prepared and, when necessary, undergo the programmed fragilities (23). The Capsules (22) and Container (22-A) or (22-B) can receive fragilities horizontally as well as vertically, on the outside as well as on the inside and on both sides of the Capsules (22), and/or Containers (22-A), and/or (22-B), with the formation of plates, in sufficient numbers according to the dynamic needs of the type of fire being contained, equipping them when necessary with the Support Belts (30) or when necessary with the Whole Metal jacket (89-A) or merely a semi-Jacket (89-B).

when necessary, connected to the Capsules (22) or Container (22-A) or (22-B) are the sensor(s) for diverse identifications and/or for scanning purposes (107-A) and/or the flashing lights or not, signaling Bulb(s), or the Light Emitting Device(s) (107-B), and/or Reflective or Fluorescent Device(s) (107-C), adhesive or not, for signaling, identification, and location;

when necessary the Capsules (22) and Container (22-A) or (22-B) can be hung by the Support Belts (30) enabling these to be filled with water or Fire Extinction Flow Compounds (24) and/or (146), and/or (147), with or without Crystals (40) and be closed with their lid;

can be connected or not to the respective Core Set, or only to the Container (51-1) or (52-2) or (RCE-3) in one of the respective Lid options (1, 2, 3, 4, 5, 6, 7, 8, 9) or connects only to one of the Lids for closing and use of Capsules (22) or Containers (22-A or 22-B) without explosives;

connects the already filled Capsules (22) and Container (22-A) or (22-B) to the Lid equipped with its respective Core Set;

after having been partially or totally assembled, the Capsules (22) and Container (22-A) or (22-B) can or not, when necessary, be placed in freezers to freeze their Fire Extinction Flow Compounds (24) and/or (146), and/or (147), with or without Crystals (40);

the already filled Capsules (22), and/or Containers (22-A), and/or (22-B), will be loaded inside the aircraft/Helicopters through a Winch (109-A);

the ready to use Capsules (22), and/or Containers (22-A), and/or (22-B), frozen or not, with or without Container (51-1) or (52-2) or (RCE-3), with or without the Core Set, will be stored in the helicopters (97) that are equipped with items (18-A, 92, 93, 98, 99, 105, 106, 107, 108, 109, 109-A, 110), and these Capsules (22) or Containers (22-A or 22-B) hung on their trolleys (92) which will be connected to the special guiding rail (93) for aircrafts/Helicopters and for storage, displacements, positioning and launching them;

these guiding rails (93) are connected at one of their extremities, located at the aircraft/Helicopters door (98), and on the sides of this end will be other pulleys (109) and alongside the end of the rail (93) will be a hook or launching systems for the Capsules (22) or Container (22-A) or (22-B);

the aircraft/Helicopters storing the ready to use Capsules (22), and/or Containers (22-A), and/or (22-B), will take off and move in the direction of the fires, and will remain hovering over the foci of heat or fire;

with the helicopters loaded and in hovering position and at a safe height the launching process of the Capsules (22) or Containers (22-A or 22-B) through the Cable(s) or Chain(s) Guide begins (105);

connecting, when necessary, before the launch, on the external end(s) of the Capsules (22) or Containers (22-A or 22-B) of the Guiding Cable(s) or Chain(s) (105), provided with conical and rotating Dart(s) (106) that will be connected through its Rod(s) (107) magnetized or not;

when necessary, connects Capsules (22) or Containers (22-A or 22-B) on the Cable(s) or Chain(s) (105) provided with Dart(s) (106) or Rod(s) (107) with sensors for diverse identifications and/or for scanning purposes (107-A), and/or the flashing lights or not, signaling Bulb(s) or the Light Emitting Device(s) (107-B) and/or Reflective Fluorescent Device(s) (107-C), adhesive or not, for signaling, identification and location.

with the Cable(s) or Chain(s) already hung and within the target or foci of heat or fire, when necessary, make a connection, through the operator (117) or robots or robotic or cybernetic devices (138) or another system or device, of the male and female set (77) to the Cable(s) or Chain(s);

when necessary, on the lids of the Capsules (22) or Container (22-A) or (22-B), or when necessary on the outside of the Capsules (22) or Container (22-A) or (22-B) ready for launch connects around the Cable(s) or Chain(s) (105) the male and female guiding set (77) with fastening or fixation rods (77-A), with or without Speed Control Devices (77-B);

to begin any type of launch of the Capsules (22), and/or Containers (22-A), and/or (22-B), these will have to be stored on the rails (93) and be displaced through the rail (93), thus enabling them to be at launching point within the aircraft/Helicopters. This displacement can be carried or not through operators, or through other means.

the launch of the Capsules (22), and/or (22-A), and/or (22-B), begins; these will be guided by the Cable(s) or Chain(s) and when the Capsules (22), and/or Containers (22-A), and/or (22-B), equipped with the set (77) and pass through the Dart(s) (106) and/or Rods (107), their initiating devices (31) will be pulled, when there will be an explosion and blast of Capsules (22), and/or Containers (22-A), and/or (22-B), occurring in the subsequent release of plates, and they will spray their content in the manner and direction planned, within the fire or very close to the foci of heat;

these launches will also take place by other means that will help reduce the weight transported by the aircrafts/Helicopters;

the Capsules (22), and/or Containers (22-A), and/or (22-B), launched and guided by the Cable(s) or Chain(s) attain their targets, foci of heat or fires, with surgical precision;

after all of these operations, the land operators complete the operation through the ash fire process whenever this is necessary;

thus the operations for the extinction of foci of heat and/or any type of fire are concluded, mainly forest fires and forest fires with fire in the tree crowns;

the Capsules (22), and/or Containers (22-A), and/or (22-B), can have, whenever necessary, fastened on the inside, a Hard Self-Screwing Cork(s) (89), with or without a Whole Metal Jacket(s) (89-A) or Semi-Jacket(s) (89-A), directional and or breakers, with the aim of helping on the target route to break the Barriers, especially the mechanical ones, also being used as a fixation system on the ground and as a cover for oil wells, as seen in FIGS. 31, 32, 33 and 34.

Sequence to Put into Operation Fighting Methods through Aircrafts/Helicopters for Launching Capsules (22), and/or Containers (22-A), and/or (22-B), using Two Guiding Cables or Chains (105):

the Capsules (22), and/or Containers (22-A), and/or (22-B), or are prepared, when necessary they will undergo the programmed fragilities (23), and they can receive fragilities horizontally as well as vertically, on the outside as well as on the inside or even yet on both sides of the Capsules (22), and/or Containers (22-A), and/or (22-B), with the formation of plates, in sufficient numbers according to the dynamic needs of the type of fire being contained. When necessary, they can be equipped with Support Belts (30) or when necessary with a Whole Metal Jacket (89-A) or merely a Semi-jacket (89-B).

when necessary hangs the Capsules (22), and/or Containers (22-A), and/or (22-B), or by the Belts (30) or hooks (33) enabling these to be filled with water or fire extinction flow compounds (24) and/or (146), and/or (147), with or without Crystals (40) and closed with their respective Lid.

they can be connected or not to the respective Core Set, or only the respective Container (51-1), or (52-2), or (RCE-3), in one of the respective Lid options (1, 2, 3, 4, 5, 6, 7, 8, 9) or connects only to one of the Lids for closing and use of the Capsules (22) or Containers (22-A or 22-B) that may or not be used without explosives or Chemical Compound that generates High Speed Pressure (41).

connects the Capsules (22) or Containers (22-A or 22-B) or to their respective Lid, equipped or not with the respective Core Set.

stores, when necessary, the Capsules (22) or Containers (22-A or 22-B) or after they are partially or completely assembled, in freezers to freeze their Fire Extinction Flow Compounds (24) and/or (146), and/or (147), with or without Crystals (40).

fills in the Capsules (22) or Containers (22-A or 22-B) when necessary with anti-flammable chemical powders.

after the Capsules (22) or Containers (22-A or 22-B) are ready to use, they will be loaded and transported to the inside of the aircraft/Helicopters by the Winch (109-A) or through other means.

the Capsules (22) or Containers (22-A or 22-B) that are ready to use, whether frozen or not, can be equipped or not with Container (51-1), or (52-2), or (RCE-3), equipped or not with Core Sets, moment at which they will be stored inside the helicopters (97), equipped with items (18-A, 92, 93, 98, 99, 105, 106, 107, 108, 109, 109-A, 110); and these Capsules (22) or Containers (22-A or 22-B) will be hung in their trolleys (92) connected to the special guiding rail (93) for aircrafts/Helicopters and for storage, displacements, place settings and the launching of Capsules (22), and/or (22-A), and/or (22-B),

connected to these guiding rails (93) at one end, located at the door (98) of the aircraft/Helicopter, there are pulleys (109) on the sides of this extremity, and at the end of the rail (93) there will also be a hook or launching systems for the Capsules (22), and/or Containers (22-A), and/or (22-B).

the aircraft/Helicopters storing the Capsules (22), and/or Containers (22-A), and/or (22-B), will take off and move in the direction of the fire, where it will remain hovering over the foci of heat and/or fires.

with the helicopter loaded and positioned hovering at a safe height, the launching process of the Capsules (22), and/or Containers (22-A), and/or (22-B), begins, through Cable(s) or Guiding Chain(s) (105).

when necessary, before the launch, in the external extremity of the Cable(s) or Guiding Chain(s) (105) are connected the Dart(s) (106) that can or cannot be connected to the Rod(s) (107), which may or may not be magnetized.

when necessary, connected to the Cable(s) or Guiding Chain(s) (105) and/or the Dart(s) (106) and/or Rod(s) (107), are the sensor(s) for diverse identifications and/or scanning purposes (107-A), and/or flashing lights or not, the signaling Bulb(s), or Light Emitting Device(s) (107-B), and/or Reflective or Fluorescent Device(s) (107-C) adhesive or not, for signaling, identification and location.

as the Cable(s) or Guiding Chain(s) (105) are already hanging within the target or foci of heat or fire, when necessary, through the operator (117) robots (138) are connected or any other device or system, as well as the male and female set (77) to the Cable(s) or Guiding Chain(s) (105).

when necessary, the set (77) is connected in the Capsules (22), and/or Containers (22-A), and/or (22-B), lids, or when needed, in the outside areas of Capsules (22), and/or Containers (22-A), and/or (22-B), or, and around the Cable(s) or Guiding Chain(s) (105) the guiding male and female set (77) is connected, with fixation rods (77-A), with or without Speed Control devices (77-B).

to initiate any type of launch of the Capsules (22), and/or Containers (22-A), and/or (22-B), these will have to be stored on the rail (93) and be displaced through the rail (93), thus leaving them at launching point within the aircraft/Helicopters. Such a displacement can be carried out or not through operators, or through other means.

the launching of the Capsules (22), and/or Containers (22-A), and/or (22-B) already equipped with set (77), begins; these will be guided by their Cable(s) or Guiding Chain(s) (105) and when they pass through the Dart(s) (106) and Rods (107), their initiating devices (31) will be pulled and there will be the explosion and blasting of Capsules (22), and/or Containers (22-A), and/or (22-B), or, with their subsequent release of plates, when they will spray their content in the manner and direction planned, within the fire or very close to the foci of heat.

these launches can also occur through other means that help reduce the weight transported by the aircrafts/Helicopters.

the Capsules (22), and/or Containers (22-A), and/or (22-B), attain their targets, foci of heat or fires with great precision after being launched.

after all of these operations, the land operators conclude the operation through the ash fire process, when necessary.

thus the operations for the extinction of foci of heat and/or any type of fire are concluded, mainly forest fires and forest fires with fires in tree crowns.

the Capsules (22), and/or (22-A), and/or (22-B), can have, when necessary, fixated to its lower part Hard self-screwing Corks (89), with or without Whole Metal jackets (89-A) or Semi-jackets (89-B), directional and/or breakers, once again with the aim of aiding in the target route to break the Barriers, especially the mechanical ones, and also operating as a fixation system on ground, as seen in the examples in FIGS. 32 and 44.

Sequence to Put into Operation Fighting Methods through Aircrafts/Helicopters to Lower, Displace, Deposit or Overlay Capsules (22), and/or Containers (22-A), and/or (22-B), within their Target, Through Lowering Cable(s) or Chain(s) (108) and a Hook:

the Capsules (22), and/or Containers (22-A), and/or (22-B), or are prepared and when necessary, they will undergo programmed fragilities (23), and can carry out fragilities horizontally as well as vertically, on the outside as well as on the inside, on both sides of the Capsules (22), and/or Containers (22-A), and/or (22-B), with the formation of plates, in sufficient numbers according to the dynamic needs of the type of fire to be contained, also being equipped when necessary with Support Belts (30) or when necessary a Whole Metal jacket (89-A) or merely a Semi-jacket (89-B).

when necessary, the Capsules (22), and/or Containers (22-A), and/or (22-B), or are hung from the Support Belts (30) or hook(s) (33) enabling them to be filled with water or their fire extinction flow compounds (24) and/or (146), and/or (147), with or without Crystals (40).

this is connected to the respective Core Set, or only to the respective Container (51-1), or (52-2), or (RCE-3) in one of the respective Lid options (1, 2, 3, 4, 5, 6, 7, 8, 9) or connected merely to one of the Lid to close the Capsules (22), and/or Containers (22-A), and/or (22-B), without explosives or Chemical Compound that generates High Speed Pressure (41).

the already filled Capsules (22), and/or Containers (22-A), and/or (22-B), or are closed with one of the respective Lids that may or not be equipped with their respective Core Set or only the respective Container (51-1), or (52-2), or (RCE-3),

when necessary, connected to the Capsules (22), and/or Containers (22-A), and/or (22-B), and/or Lids, and/or to the Lowering Cable(s) or Chain(s) (108) and/or on the Hard Corks (89) are the sensors for diverse identifications and/or for scanning purposes (107-A) and/or the flashing light or not, signaling Bulb(s), or the Light Emitting Device (107-B) and/or the Reflective or Fluorescent Device(s) (107-C) for signaling, identification and location.

when necessary the Capsules (22), and/or Containers (22-A), and/or (22-B), or are stored after having been partially or totally assembled in freezers to freeze their Fire Extinction Flow Compounds (24) and/or (146), and/or (147), with or without Crystals (40).

after the Capsules (22), and/or Containers (22-A), and/or (22-B), are ready to use, frozen or not, they are loaded inside the aircraft/Helicopter using the Winch (109-A) or through other means.

the ready to use Capsules (22), and/or Containers (22-A), and/or (22-B), frozen or not, equipped or not with Container (51-1), or (52-2), or (RCE-3), and equipped or not with the respective Core Set will be stored inside the helicopters (97) or inside Aircrafts (97-B).

the aircrafts (97-B) or Helicopters (97) may or may not be equipped with the pertinent items (18-A, 92, 93, 98, 99, 105, 106, 107, 108, 109, 109-A, 110).

the already filled Capsules (22), and/or Containers (22-A), and/or (22-B), in the aircrafts (97-B) or/Helicopters (97) will be hung from their trolleys (92) that will be connected to a special guiding rail (93) developed for aircrafts/Helicopters and for their storage, displacements, positioning and the launching.

these guiding rails (93) have, connected to their extremity located near the door (98) of the aircraft/Helicopters, at the sides of this end other pulleys (109) and at the end of the rail (93) a hook or launching systems for the Capsules (22), and/or Containers (22-A), and/or (22-B).

the aircraft (97-B) or Helicopter (97) storing the ready to use Capsules (22), and/or Containers (22-A), and/or (22-B), will take off and move in the direction of the fires, where it will remain hovering over the foci of heat and/or fire.

with the helicopter loaded and hovering at a safe height, the processes to lower the Capsules (22), and/or Containers (22-A), and/or (22-B), one at a time begins, through one Lowering Cable(s) or Chain(s) (108).

to initiate the process of lowering of the Capsules (22), and/or Containers (22-A), and/or (22-B), these will have to be stored on the rail (93) and be displaced through the rail (93), thus leaving them at lowering point within the aircraft/Helicopters. This displacement can be carried out by an operator or not, or through other means.

the lowering of the Capsules (22), and/or Containers (22-A), and/or (22-B), or begins and these will be hung by their Lowering Cable(s) or Chain(s) (108) until arriving at the target, where the initiating devices (31) will be activated through remote control or pulled, or through other means. There will be an explosion and the blasting of Capsules (22), and/or Containers (22-A), and/or (22-B), or occurring in the subsequent release of plates, when they will spray their contents in the manner and direction planned, within the fire or very close to the foci of heat.

these launches can also take place through other means that help reduce the weight transported by the aircrafts/Helicopters.

the lowered Capsules (22), and/or Containers (22-A), and/or (22-B), hung and guided by their Lowering Cable(s) or Chain(s) (108) are positioned to attain the target, foci of heat or fires, with great precision, fires resulting from fires in oil pipes, gas pipes, oil wells or fuel deposits, or forest fires.

after all of these operations, the land operators complete the operation through the ash fire process when necessary.

thus the operations for the extinction of foci of heat and/or any type of fire are concluded.

when necessary, the Capsules (22), and/or Containers (22-A), and/or (22-B), can have fixated to their lower part self-screwing Hard Corks (89) with or without a Whole Metal jacket (89-A) or Semi-jackets (89-B), directional and/or breakers with the aim of helping, on the target route, to break the Barriers, especially the mechanical ones, and also operating as a fixation system on ground to fight technical fires in oil wells. It must be highlighted that the process of lowering or hoisting the Capsules (22) and/or Containers (22-A), and/or (22-B) is carried out regardless of the height the respective Helicopter/Aircraft is hovering on as seen in the examples in FIGS. 27, 33 34.

Sequence to Put into Operation Fight Methods Through The Helicopter (97-A) for Lowering, Displacement, Placing or Overlaying the Refractory Container (113) Lowered within the Foci of Heat or Fires, Through Lowering Cable(s) or Chain(s) (108) and Cable(s) and Rope(s) (118) for the Opening and Closing of Valves (90-R):

there is the Refractory Container (113) in the shape of a prism, cylinder, sphere, conical trunk or egg shaped.

made up of a body (90) with lids (90-A) that have sealing rims (90-B) made of rubber and other materials, that are used to contain the water or the fire extinction flow compounds (24) and/or (146), and/or (147), with or without Crystals (40) with their hinges (90-C) and their buoys/floaters (90-D) held back by lid Delimiting Angle Bars (90-E), preventing the loss of liquids during the flight of the helicopter. (97-A).

there are hooks (90-E) for support and/or fixation that will be used to fixate the lowering cable(s) or chain(s). (108).

they can or not have a counterweight (90-G) for immersion, or a motor (90-H) and/or rotating electric, electronic, mechanical or hydraulic system.

in the Refractory Container (113) are connected the fitting and fixation pins (90-I), where the sprayers (90-J) are fixated, with their outgoing tubes (90-L) or Outlet holes (90-K).

these sprayers have the same shape as the body (113) of the Refractory Container and have orifices at the outlet (90-K) or (90-L) to discharge water and/or other liquids.

these orifices or holes are placed on the sides and below, or only on the bottom side.

a set of male and female insertion (90-M) is placed overlaying the valves, acting as a seal for water and other liquids within the Refractory Container (113).

when necessary, connected to the Refractory Container (113) are the sensor(s) for diverse identifications and/or for scanning purposes (107-A), and/or the flashing lights or not, signaling Bulb(s), the Light Emitting Device(s) (107-B) and/or the Reflective and Fluorescent Device(s) (107-C), adhesive or not for signaling, identification and location.

the lowering cable or chain (118) is connected to the optional cable (90-O), in the articulated axis of the motor (90-N) and/or the rotating valve control system (90-R), in the Ring (90-P) to regulate and fixate the cable(s) (90-O) and in the arm and/or rod (90-N) that act to drive the opening and/or closing of the valve(s) (90-R), as seen in the example in FIGS. 28, 29.

the Refractory Container (113) is coupled to the body of the helicopter (97-A).

the helicopter takes off and flies in direction of the lakes (12) and others, hovers over the lake, to lower the Refractory Container (113) into the water, until it has been totally filled with water, when the valves (90-R) and the lids (90-A) close.

the helicopter (97-A) hoists the Refractory Container (113), connecting it totally to its body and displaces itself to the targets of foci of heat or fires.

the helicopter positions itself hovering over the foci of heat or fire, lowers the Refractory Container (113) within the fire or the foci of heat.

the operator activates the drive of the motor (90-H) to open and control the valves (90-R) and then begins the spraying or discharge of the water and other compounds into the foci of heat, extinguishing it.

after the valves (90-R) have been opened and the first epicenter of fire has been extinguished, the operator will displace the helicopter (97-A) with the Refractory Container (113) still lowered inside the fire, dragging or guiding it towards the line of fire always and only inside the foci of heat or fires.

once the operator sees, electronically or through other means that the Refractory Container (113) has been emptied out, the operator hoists the Refractory Container (113) until it is totally coupled with the body of the Helicopter (97-A), and displaces it towards a water source to fill it in, reinitiating the entire operation, until the fire has been completely extinguished. It must be highlighted that the process of lowering or hoisting the Refractory Container (113) is carried out regardless of the height the respective Helicopter/Aircraft is hovering on as seen in the example in FIGS. 28, 29, 37, 38 and 39.

Sequence to Put into Operation the Fight Methods Through the Helicopter (97) for Lowering, Displacement, Placing or Overlaying the Special Container (113-A) Lowered Only Near the Target, Through the Lowering Cable(s) or Chain(s) (108) and Hook:

the Special Container (113-A) has the shape of a prism, cylinder, sphere, conical trunk or can be egg-shaped.

it is made up of the body (90) with lids (90-A) that have sealing rims (90-B) made of rubber or diverse materials that are used to contain the water or the fire extinction flow compounds (24) and/or (146), and/or (147), with or without Crystals (40) with its hinges (90-C) and its buoys/floaters (90-D) held back by the lid delimiting angle bars (90-E) that prevent the loss of liquids during the flight of the helicopter (97).

they have support and/or fixation hooks (90-E) that are used to fixate the Lowering Cable(s) or Chain(s) (108).

they may or may not have a counterweight (90-G) for immersion, or a motor (90-H) and/or electric, electronic mechanical or hydraulic rotating system.

connected to the Special Container (113-A) are the fitting or insertion pins (90-I) where the sprayers (90-J) are fixated.

these sprayers have the same shape as the body (90) of the Special Container (113-A) and as an option can have outlet orifices (90-K) or (90-L) to discharge water and/or other liquids.

such orifices are placed on the sides and lower parts, or only at the bottom.

when necessary, connected to the Special Container (113-A) are the sensor(s) for diverse identifications and/or for scanning purposes (107-A) and/or flashing lights or not, signaling Bulb(s), or Light Emitting Devices (107-B) and/or Reflective and Fluorescent Device(s) (107-C), adhesive or not, for signaling, identification and location.

a male and female insertion set (90-M) is overlain on the valves, to act as a seal for water and other liquids within the Special Container (113-A).

the Special Container (113-A) is brought close to the body of the helicopter (97) without coupling it.

the helicopter takes off in the direction of the lakes (120) and others, hovers over the lake to lower the Special Container (113-A) until it has been totally filled up with water, when the valves (90-R) and the Lids (90-A) close.

the helicopter (97) hoists the Special Container (113-A) and moves towards the targets, the foci of heat or fires.

the helicopter (97) positions itself by hovering away from or close to the foci of heat or fire, lowers the Special Container (113-A) to a safe height and distance, but in this case not lowering it down inside the foci of heat or fire keeping it near enough so that the operator can use the hose (115).

the operator of the helicopter (97) activates the lowering of the Hose (115) carried out to unroll the Retractable Mobile Reel (114-A) which is contained within the protective Housing for Outlet Pipe(s) (114), that may contain or not Water Pump(s) (114-B) and/or other Cooling or Extinction Fluids (24) and/or (146), and/or (147), with or without Crystals (40), to store the Special Hose(s) or Discharge Pipe(s).

once the Special Hose(s) or Discharge Pipe(s) (115) along with the Nozzle or open/close spray valve (116) have been lowered, the land operator takes the hose (115), without having to carry it or support it, gears it towards the foci of heat or fire, and by gravity or due to the pressure of the Water Pump (114-B), the Spraying Nozzle (116) will open and squirts water at a great distance towards the fire, extinguishing it.

once the Helicopter operator, electronically or though other means, sees the Special Container (113-A) has been emptied out, will roll the hose (115) into the Reel (114-A), hoist the Special Container (113-A) near the body of the Helicopter (97) without coupling it, displacing it towards a water source to re-supply it, reinitiating the entire operating, until the fire has been completely extinguished.

the Special Container (113-A) launches its water or other cooling and/or Fire Extinction liquids (24) and/or (146), and/or (147), with or without Crystals (40) only through the equipment contained in the Protective Housing for Outlet Pipe(s) (114) that may or may not contain a Water Pump (s) (114-B), may contain a Retractable Mobile Reel (114-A) that will store the Special Hose(s) or Discharge Pipes (115) by declivity or inclination. It must be highlighted that the process of lowering or hoisting the Special Container (113-A) is carried out regardless of the height the respective Helicopter/Aircraft is hovering on, as seen in the example in FIGS. 28, 29, 35, 36. The Capsules (22), Container (22-A), the spherical Containers (22-B), the—refractory container (113), the special container: (113-A), Mortars (96), Bottle Type Containers (96-A), as well as their Fire Extinction Flow Compounds (24) and/or (146), and/or (147), with or without Crystals (40) with their Soil Recovery Elements (146) and (147) and others, and all of the new methods to run the operations using these products are destined exclusively for peaceful purposes and for the rapid, secure and efficient protection of Nature, by immediately extinguishing all types of fires.

It is well known in the markets that there are the most diverse bombs, used exclusively in wars, destruction, etc. The equipment and the methods set forth herein in this Invention patent are totally beneficial and innovative; in the technical aspects as well as in the way they were built, the materials, and above all, regarding their destination, clearly based on peaceful and innovative uses to fight against the most diverse types of foci of heat and fires. They can also be used for reforestation, a totally controlled eradication of drug plantations, clouds of locusts and others. What characterizes these Inventions is that they are necessary and urgent for human life on planet Earth.

It must be highlighted that by preserving the foundations the patent is based on, the formats, amount of functions, types of materials used, capacities, volumes, chemical compositions and their physical states and destination, as well as all of the components involved can vary, within the limits of such a foundation.

Thus, the equipment and methods presented herein have been thought of as part of the Project Salamandras, they stand out for their innovation, within the definitions of Invention.

1. “PROCESSES FOR FIGHTING FOCI OF HEAT AND/OR FIRES OF ANY MAGNITUDE”, characterized by; the previous assembly of Containers (51-1), or (52-2) or (RCE-3), with or without Programmed Fragilities (23) that equip one of the Core Sets (46), (46-A), or (46-B), also with or without Programmed Fragilities (23), and that when ready for use, are connected in the center and in the internal part of the Lids options (1), (2), (3), (4), (5), (6), (7), (8), or (09) for transportation, support, and closure, and when they are introduced in one of the respective Fire Extinction Flexible Capsules (22), or in one of the respective Fire Extinction Hard Containers (22-A), or in one of the respective Spherical Fire Extinction Hard Containers (22-B) all with Programmed Fragilities (23) and filled with flows (24) and/or (146), and/or (147), with or without Crystals (40); assembly of the Fire Extinction Refractory Articulated Container (113) or Fire Extinction Special Articulated Container (113-A), or of the Fire Extinction Mortars (96), with their respective Fire Extinction Bottle-Type Container (96-A) with Programmed Fragilities (23), and the placement, deposit, and starting of these processes over or inside the foci of heat or fire through: a fire-extinction method using Helicopters (97) or Aircrafts (97-B) hovering for free launches of Capsules (22), and/or Containers (22-A), and/or (22-B), or Mortars (96) with their Bottle-Type Container (96-A), without the use of Cable(s) or Guide Chain(s) (105), fire-extinction methods using hovering Helicopters/Aircrafts to launch Capsules (22), and/or Containers (22-A), and/or (22-B), through one Cable(s) or Guide Chain(s) (105); fire-extinction methods using hovering Helicopters/Aircrafts to launch Capsules (22), and/or Containers (22-A), and/or (22-B), using two Cables or Guide Chains (105); fire-extinction methods using hovering Helicopters/Aircrafts for lowering, displacing, depositing, or overlaying the Capsules (22), and/or Containers (22-A), and/or (22-B), over or inside the target, via Cable(s) or Lowering Chain(s) (108) and hook; fire-extinction method using Special Land Vehicle (127), launching or using Spherical Containers (22-B), that will be deposited and hoisted by the Thermal Booth (133) and by the Special Telescopic Hoist (129); everything helping in the processes that produce a mechanism to run and produce the extinction of foci of heat and/or fires; a mechanism that is started by Capsules (22), or Containers (22-A) or (22-B), or by Bottle-Type Containers (96-A) launched into the foci of heat and/or fires and that will blast through the detonation of explosives (41) creating a controlled shock wave that generates a turbulence on the flow (24) and/or (146), and/or (147), with or without Crystals (40) formed when throwing crystals or granules (40) that are inside the respective Core Sets pulverizing, throwing and driving the extinction flow compound (24) in a spray of heavy drops into directions projected and guaranteed by the Vectorizers (25) and/or (26) that belong to the Core Sets (46), or (46-A), or (46-B) that will be always fixed onto the internal central area of one of their respective new closure or support Lids options (1), (2), (3), (4), (5), (6), (7), (8), or (9) promoting since they produce their action only inside the foci of heat 100% utilization of the Compound Flow (24) and/or (146), and/or (147), with or without Crystals (40) and decomposition effects of fuel loads and the immediate extinction of flames, smoke, and heat, capture, dispersion and separation of inflammable gas, planned fragmentation of active fuel loads initiating shock, friction, and rebound over the surfaces of active fuel loads decompressing and decomposing, reducing the extremely high temperatures to values around 50° C., and promoting the formation of a layer of inert gases and insulating coverage over the active fuel loads, isolating them temporarily, thus avoiding re-ignition and ensuring 800% efficiency in fire extinction: and fire-extinction method using Helicopter (97-A) for lowering process, displacements, and hoisting of Articulated Refractory Container (113), in a controlled way inside the foci of heat or fires via Cable(s) or Lowering Chain(s) (108) and Cable(s) and/or rope (118) to control the opening and/or closure of valves (90-R); fire-extinction method using Helicopter (97) for lowering process, displacements, and hoisting of Articulated Special Container (113-A) optionally equipped with output pipe(s) (114) in a protection box with or without a water pump system (114-B), Retractable Reel (114-A) for Hoses (115) and Nozzle (116), lowered away from the fire via Cable(s) or Lowering Chain(s) (108), and hook: fire-extinction method through the use of Bazookas (134) to start Mortars (96) that throw their Bottle-Type Containers (96-A); special launcher(s) (122) coupled to their support and alignment Tripod (121) on the soil and being deployed or not in land vehicles (124) out setting the starting devices and launching them inside or over the foci of heat or fires; and fire-extinction method using the transportation and placement of Capsules (22) or Containers (22-A) or (22-B), and Mortars (96) with their Bottle-Type Container (96-A) inside the focus of heat or fires, via robots (138) or through other robotic or cybernetic means and all when necessary, with sensors for different identifications and/or for scanning (107-A), and/or flashing lights or not, signaling Bulbs, or Light Emitting Devices (107-B), or reflecting Devices or fluorescent Devices (107-C), adhesive or not, for signaling, identification, and positioning.

2. “PROCESSES FOR FIGHTING FOCI OF HEAT AND/OR FIRES OF ANY MAGNITUDE”, according to claim 1, characterized by; assembly of the Container (51-1) in its hollow cylindrical format, or (52-2) in its hollow staggered cylindrical format, or (RCE-3) in its cone-trunk hollow cylindrical format, in the following sequence:
a) one of the bodies (37), (37-A), and (37-B) of the respective Container (51-1), or (52-2), or (RCE-3), is prepared to receive whenever necessary the Programmed Fragilities (23);
b) Rings (38) and/or Guides (39) are connected to bodies (37), (37-A), and (37-B) in chosen parts on the external area;
c) upper Cap (45) that belongs to bodies (37), (37-A), and (37-B) and that belongs to the respective Container (51-1), or (52-2), or (RCE-3) is fixed;
d) the explosives or mix of explosives and/or a Chemical Compound that generates High Speed Pressure (41) are introduced inside the bodies (37), (37-A), and (37-B) and are compacted up to the level of the opposite edge;
e) the explosion train/delay fuse or not (42) already dented to the respective driver (32) for ignition is fixed in the center of the lower Cap (44); and
f) the lower Cap (44) already equipped with the delay fuse or not (42) on the side that is still open, is connected and becomes Container (51-1), or (52-2), or (RCE-3), ready to be introduced in one of the respective Core Sets or used isolated.

3. “PROCESSES FOR FIGHTING FOCI OF HEAT AND/OR FIRES OF ANY MAGNITUDE”, according to claim 1, characterized by; assembly of the Core Sets in the following sequence:
a) body (36) of the Core Sets (46), (46-A), and (46-B) is prepared to receive or not whenever necessary the programmed fragilities (23) and to receive the connection in one of the openings of the lower Vectorizer (25), or the lower Cap (47) belonging to the Core Sets (46), or (46-A), or (46-B);
b) part of the Propelled-Propellant Crystals and/or Granules (40) is introduced; and
c) one of the respective Container (51-1), or (52-2), or (RCE-3) is introduced;
d) the respective body (36) of the Core Sets is completed with the remainder Crystals (40) leaving driver (32) outside the respective body (36) of Core Sets;
e) driver (32) is introduced by hole (26-A) of the upper Vectorizer (26), or by the hole (50) of the upper Cap (48), or by the Hole (28-A) of the Adaptor (71) and introduced onto the upper part of the body (36) of the Core Sets to become the Core Sets (46), (46-A), and (46-B), ready to connect into the central internal and lower area of respective lid options (1), (2), (3), (4), (5), (6), (7), (8), or (9) forming the Core Sets (46), or (46-A), or (46-B) ready to be introduced in the Capsules (22) or Containers (22-A) or (22-B), or Bottle-Type Containers (96-A) already filled with Flow (24) and/or (146), and/or (147), with or without Crystals (40).

4. “PROCESSES FOR FIGHTING FOCI OF HEAT AND/OR FIRES OF ANY MAGNITUDE”, according to claim 1, characterized by; assembly of the Capsules (22), and/or Containers (22-A), in the following sequence:
a) Capsules (22), and/or Containers (22-A), are prepared and whenever necessary they will receive the programmed fragilities (23) and these fragilities can be carried out both on the horizontal and in the vertical directions, both on the outside and inside or still on both sides of the Capsules (22), and/or Containers (22-A) forming plates and providing when necessary with Support Belts (30);
b) Capsules (22), and/or Containers (22-A), are hung by the Belts (30), so that they can be supplied with water or with fire extinction flow compounds (24) and/or (146), and/or (147), with or without Crystals (40), and closed with the respective Lid;
c) the respective Core Sets (46), (46-A), or (46-B) are connected to one of the respective option Lids (1), (2), (3), (4), (5), (6), (7), (8), or (9);
d) Capsules (22), and/or Containers (22-A), are connected to the equipped Lid with its Core Set (46), (46-A), or (46-B);
e) if necessary, the male and female Guide Set (77) with fastening Rods (77-A) with or without Speed Control Devices (77-B) are connected to the lid or to the Capsules (22), and/or Containers (22-A) or to their external areas, or if necessary fin(s) or wing(s) (79) or spoilers (80) are also connected or not onto the Lid;
f) if necessary Cables or Guide Currents (105) are connected to Capsules (22) or Containers (22-A) already connected to these male and female Guide Set (77) with fastening Rods (77-A) with or without Speed Control Devices (77-B)
g) when necessary, sensors for different identifications and/or for scanning (107-A), and/or flashing lights or not, signaling Bulbs, or Light Emitting Devices (107-B), or reflecting Devices or fluorescent Devices (107-C), adhesive or not, for signaling, identification, and place setting are connected to the Lid(s), and/or to the Capsules (22), and/or Containers (22-A), and/or to the Cable(s) or guide Chain(s) (105), and/or to the rotating conical Dart(s) (106), and/or to the Pendulum Rod(s) (107);
h) Capsules (22), and/or Containers (22-A), after partially or totally assembled may or may not if necessary be deposited in freezers to freeze their Fire Extinction Flow Compound (24) and/or (146), and/or (147), with or without Crystals (40).

5. “PROCESSES FOR FIGHTING FOCI OF HEAT AND/OR FIRES OF ANY MAGNITUDE”, according to claim 1, characterized by; assembly of the Mortars (96) in the following sequence:
a) the explosion train/fuse (42) is connected to the Reinforce and Reusable Metal Capsule (96-C);
b) Explosive (41) and/or the mix of Explosives is introduced inside the Reusable and Reinforced Metal Capsule (96-C);
c) the Bottle-Type Container (96-A) is prepared whenever necessary with the Programmed Fragilities (23);
d) the Core Sets (46), (46-A), or (46-B) already connected to its Rings (38) or Guides (39) and to its percussion pin (96-D) to activate the explosion train/delay fuse or not (41), or only the respective Container (51-1), or (52-2), or (RCE-3), is introduced into the Bottle-Type Container (96-A);
e) the Fire Extinction Flow Compound (24) and/or (146), and/or (147), with or without Crystals (40) or other chemical products is introduced into the Bottle-Type Container (96-A) filling it up to the edge of the Lid (96-B);
f) the Bottle-Type Container (96-A) is closed with its Lid (96-B);
g) the Bottle-Type Container (96-A) is covered whenever necessary with its Whole Metal Jacket (89-A), or only with its Hard Material Semi-Jacket (89-B);
h) whenever necessary the sensors for different identifications and/or for scanning (107-A), and/or flashing lights or not, signaling Bulbs or Light Emitting Devices (107-B), or reflecting Devices or fluorescent Devices (107-C), adhesive or not, are connected to the Bottle-Type Containers (96-A) (96); and
i) the respective Bottle-Type Container (96-A) is introduced inside the Reusable and Reinforced Metal Capsule (96-C) already supplied with its Explosive (41), transforming both in Mortars (96) ready to be introduced and activated inside the Bazookas (134) or through Cannons (122) that will throw their Bottle-Type Containers (96-A) into the fires.

6. “PROCESSES FOR FIGHTING FOCI OF HEAT AND/OR FIRES OF ANY MAGNITUDE”, according to claim 1, characterized by; the assembly of Articulated Refractory Container (113), and Special Articulated Refractory Container (113-A) in the following sequence:
a) the lids (90-A) that are already connected to their buoys/floaters (90-D) and that already have their sealing rims (90-B) are connected to body (90);
b) lids (90-A) are connected and articulated through their hinges (90-C) and are restricted by the Bounding Angle Bars (90-E);
c) support and or fastening hooks (90-F) are connected to the body (90), as well as the counter weight (90-G), the motor (90-H), and/or the engine (90-H), and/or the electric, electronic, mechanical, or hydraulic rotating system, the fitting and fastening pin(s) (90-I), and on these pins one type of sprays (90-J) with Output Tubes (90-L) or output Holes (90-K) is connected, positioned on the lateral and lower areas of the body (90), and/or only on the lower area;
d) the male and female set (90-M) is installed on the supporting guide (90-Q) over the valves (90-R);
e) the articulated axle of the motor and/or the engine, and/or the rotating system (90-N) to control the valves (90-R) through a ring (90-P) for regulating and fastening the optional cable(s) (90-O) is connected to the optional cable(s) (90-O) that open and close the valve(s);
f) hinges (90-T), the supporting guide (90-Q) in each side, and ring (90-P) are installed over the valve(s);
g) the protection Box (114) for output Pipes may hold or not water Pump(s) and/or for other Cooling fluid(s) and/or Extinguishing fluid(s) (114-B), and/or Retractable Mobile Reel (114-A) to store the special Hoses or flow pipes (115) is connected whenever necessary to the body (90) of the Special Articulated Refractory Container (113-A);
h) the Nozzle or Open/Close spray Valve (116) is connected to the special Hoses or flow pipes (115); and
i) whenever necessary the sensors for different identifications and/or for scanning (107-A), and/or flashing lights or not, signaling Bulbs or Light Emitting Devices (107-B), or reflecting Devices or fluorescent Devices (107-C), adhesive or not, are connected to the Articulated Refractory Container (113) and to Special Articulated Refractory Container (113-A).

7. “PROCESSES FOR FIGHTING FOCI OF HEAT AND/OR FIRES OF ANY MAGNITUDE”, according to claim 1, characterized by; the extinction of foci of heat or fires operations through the use of Aircrafts (97-B) or Helicopter (97) for free launching of Capsules (22), and/or Containers (22-A), and/or (22-B), or Mortars (96) with their Bottle-Type Container (96-A) via only One or Two Cable(s) or Guide Chain(s) (105) in the following sequence:
a) the Capsules (22), and/or Containers (22-A), and/or (22-B), are loaded inside the Aircraft (97-B) or Helicopter (97) via Hoist (109-A);
b) the Capsules (22), and/or Containers (22-A), and/or (22-B), ready for use, frozen or not, with or without Container (51-1), or (52-2), or (RCE-3), with or without Core Sets (46), or (46-A), or (46-B), will be stored inside the Aircrafts/Helicopters, all equipped with items (18-A, 19-A, 92, 93, 98, 99, 105, 106, 107, 108, 109, 109-A, 110), hanging on their Trolleys (92) that will be connected to the special Guide rail (93) for Aircrafts/Helicopters and for storage, displacements, positioning, and launching of the Capsules (22), and/or Containers (22-A), and/or (22-B);
c) these Guide rails (93) have connected to their far end close to the door (98) of the Aircraft/Helicopter the launching systems for the Capsules (22), and/or Containers (22-A), and/or (22-B). The sides of the far end have other pulleys (109) and next to the end of the rail (93) there is a hook (99);
d) the Aircraft/Helicopter loaded with the containers takes off and moves towards the fire where it will remain hovering over the focus of heat and/or fire;
e) with the Aircraft/Helicopter loaded and hovering on a safe height;
f) the launching process starts guided via one or two Cable(s) or Guide Chain(s) (105) connecting whenever necessary before launching on the far external end of the Cable(s) or Guide Chain(s) (105) the rotating conical Dart(s) (106) that will be connected or not to the Rod (107) that can be magnetized or not;
g) when necessary the Cable(s) or Guide Chain(s) (105) or the Dart(s) (106), or the Rod(s) (107) are connected to sensors for different types of identification and/or scanning (107-A), or also have connected when necessary flashing lights or not, signaling Bulb(s) or Light Emitting Device(s) (107-B), or Reflective or Fluorescent Device(s) (107-C), adhesive or not, for signaling, identification, and place setting;
h) with the Cable(s) or Guide Chain(s) (105) hanging and inside the target or focus of heat or fire, the male and female set (77), is connected when necessary via operator (117) or robots, or robotic devices, or cybernetic devices (138) or another system or device on the Cable(s) or Guide Chain(s) (105);
i) whenever necessary on the lids of the Capsules (22), and/or Containers (22-A), and/or (22-B), or when necessary on the external areas of the Capsules (22), and/or Containers (22-A), and/or (22-B), the male and female Guide Set (77) is connected around the Cable(s) or Chain(s) (105) with the fastening rods (77-A) with or without Speed Control Devices (77-B);
j) to start any type of launching of Capsules (22), and/or Containers (22-A), and/or (22-B), they should be stored on the rail (93) and be moved through the rail (93) and be ready at the launch point inside the Aircraft/Helicopter. This move can be carried out or not through the operators, or by other means; and
k) the launching of the Capsules (22), and/or Containers (22-A), and/or (22-B) starts and they are guided by the Cable(s) or Guide Chain(s) (105) and when these Capsules (22), and/or Containers (22-A), and/or (22-B) equipped with the set (77) pass by the Dart(s) (106) and/or Rods (107), they will have their starting devices (31) pulled and the explosion takes place with the blasting of Capsules (22), and/or Containers (22-A), and/or (22-B) with the subsequent release of the plates when the contents, Compound Flow (24) and/or (146), and/or (147), with or without Crystals (40) will be sprayed on a planned form and direction towards the fire or very close to the foci of heat.

8. “PROCESSES FOR FIGHTING FOCI OF HEAT AND/OR FIRES OF ANY MAGNITUDE”, according to claim 1, characterized by; fire or foci of heat extinctions operations by Aircrafts (97-B) or Helicopters (97) for lowering procedures, displacing, depositing, or overlaying of Capsules (22), and/or Containers (22-A), and/or (22-B) over or inside the target via one Cable or Lowering Chain (108) and hook in the following sequence:
a) after the Capsules (22), and/or Containers (22-A), and/or (22-B) are ready for use, frozen or not, they will be loaded inside the Aircrafts/Helicopters via Hoist (109-A), or by other means;
b) the Capsules (22), and/or Containers (22-A), and/or (22-B) ready for use, frozen or not, only with Container (51-1), or (52-2), or (RCE-3), or only with the respective Core Sets (46), or (46-A), or (46-B), will be stored inside the Helicopters (97), or Aircrafts (97-B). The Aircrafts/Helicopter may all be equipped or not with the matching items (18-A, 19-A, 92, 93, 98, 99, 105, 106, 107, 108, 109, 109-A, 110);
c) the Capsules (22), and/or Containers (22-A), and/or (22-B), inside the Aircrafts/Helicopter are hanging on their trolleys (92) that are connected to the special Guide rail (93) developed for Aircrafts/Helicopter and for storage, displacements, positioning, and lowering of the Capsules (22), and/or Containers (22-A), and/or (22-B);
d) these Guide rails (93) have connected to their far end close to the door (98) of the Aircraft/Helicopter the lowering systems for the Capsules (22), and/or Containers (22-A), and/or (22-B). The sides of the far end have other pulleys (109) and next to the end of the rail (93) there is a hook (99);
e) the Aircraft/Helicopter loaded with the Capsules (22), and/or Containers (22-A), and/or (22-B), takes off and moves towards the fire where it will remain hovering over the focus of heat and/or fire;
f) with the Aircraft/Helicopter loaded and hovering on a safe height, starts the process of lowering down of one Capsules (22), and/or Containers (22-A), and/or (22-B), at a time via Cable or Lowering Chain (108);
g) to start any lowering of Capsules (22), and/or Containers (22-A), and/or (22-B), they should be stored on the rail (93) and be moved through the rail (93) and be ready at the launch point inside the Aircraft/Helicopter. This move can be carried out or not through the operators, or by other means;
h) the lowering of the Capsules (22), and/or Containers (22-A), and/or (22-B), starts and they are hung and guided by their Cable or Lowering Chain (108) to the target where the starting devices (31) are activated via remote control or pulled, or by other means and the explosion takes place with the blasting of Capsules (22), and/or Containers (22-A), and/or (22-B), with the subsequent release of the plates when the contents, the Compound Flow (24) and/or (146), and/or (147), with or without Crystals (40) will be sprayed on a planned form and direction towards the fire or very close to the foci of heat; and
i) the lowered Capsules (22), and/or Containers (22-A), and/or (22-B), remain hanging and guided by their Cable or Lowering Chain (108), and they are positioned to reach accurately their targets that are the foci of heat or fires originated from fires on oil pipelines, gas pipelines, oil wells, fuel deposits, or forest fires.

9. “PROCESSES FOR FIGHTING FOCI OF HEAT AND/OR FIRES OF ANY MAGNITUDE”, according to claim 1, characterized by; the extinction of foci of heat or fires operations through the use of special Land Vehicle(s) (127), using Spherical Containers (22-B) that will be deposited and hoisted by the Thermal Booth (133) and by the Special Telescopic Hoist (129) in the following sequence:
a) Spherical Containers (22-B) already filled with plain water or the Compound Flow (24) and/or (146), and/or (147), with or without Crystals (40) frozen or not equipped only, with the Core Sets introduced in its respective new Closing Lid, or with only one of the Container (51-1), or (52-2), or (RCE-3), will be deposited and transported on special land vehicles;
b) on special land vehicles (127), the Spherical Container (22-B) after ready for use will be deposited in the thermal booth (133) and hoisted by the Hoist lifting Tackle (132), by the Special Telescopic Hoist (129) that is coupled to the respective land Vehicle (127) transporting them up to the telescopic Trough (128) that will be positioned inside the windows of the buildings (125) and in a descending position, so that when the Spherical Containers (22-B) are deposited or placed on the telescopic trough (128), they are conducted by gravity/declivity inside the trough (128) towards the interior of the buildings (125) via windows or other openings; and
c) the ignition of the explosives (41) that belong to the Spherical Containers (22-B) occurs by remote control using a electronic or analog timer, or a wick, or delay fuses or not (42), or other means.

10. “PROCESSES FOR FIGHTING FOCI OF HEAT AND/OR FIRES OF ANY MAGNITUDE”, according to claim 1, characterized by; extinction of foci of heat and fire operations through the use of Helicopter (97-A) for lowering, displacing, depositing, or overlaying the Articulated Refractory Container (113) completely lowered in the foci of heat or fires, or of the Special Articulated Container (113-A) only lowered close to the foci of heat and fires through Helicopter (97) or Aircraft (97-B) via Cables or Lowering Chain(s) (108) and Cables or Rope(s) (118) for opening and closing the Valves (90-R) in the following sequence:
a) Articulated Refractory. Container (113) ready for use is fully coupled to the body of the Helicopter (97-A); or the Special Articulated Container (113-A) is hung very close to Helicopter (97);
b) the Helicopter takes off towards the lakes (120), hover over the lake to lower the Articulated Refractory Container (113) or Special Articulated Container (113-A) down into the water until it is totally filled in with water when its valves (90-R) and Lids (90-A) close;
c) the Helicopter (97-A) hoists the Articulated Refractory Container (113) connecting it totally to its body and moves towards the foci of heat or fires;
d) the Helicopter places itself hovering over the focus of heat or fire, Helicopter (97-A) lowers the Articulated Refractory Container (113) completely into the center of the fire or the focus of heat, and Helicopter (97) lowers its Special Articulated Container (113-A) only close to the foci of heat or fires;
e) the operator activates the drive of the motor (90-H) to open and control the valves (90-R) when the dumping or spray of water or other compounds or Flow Compound (24), and/or (146), and/or (147), with or without Crystals (40) begins over the focus of heat, extinguishing it;
f) the operator start moving the Helicopter (97-A) after the valves (90-R) are open and the first epicenter of fire is extinct. The Articulated Refractory Container (113) is lowered inside the fire and dragged towards the line of fire; Helicopter (97) activates the lowering of its Special Articulated Container (113-A) only close to the foci of heat or fires and in this case the operator of Helicopter (97) activates the lowering of the Hose (115) carried out by the unwinding of the Retractable Mobile Reel (114-A) that is held in the protection Box for the output Pipe(s) (114) that may hold or not water Pump(s) and/or for other Cooling and/or Extinction Fluid (114-B), or Flow Compound (24), and/or (146), and/or (147), with or without Crystals (40); Special Hose(s) or flow pipes (115); together with the Nozzle or the open/close spray Valve (116) are lowered, and the land operator (117) holds this hose (115) without the need of carrying it or lifting it, or dragging it, and directs it towards the focus of heat or fire when by gravity or by the pressure made by the water Pump (114-B), opens the Nozzle (116) and sprays water or the Flow Compound (24), and/or (146), and/or (147), with or without Crystals (40) at a great distance towards the fire extinguishing it; after the operator verifies electronically, or by means of other source of information, that the Special Articulated Container (113-A) is empty, he controls the process of winding the hose (115) on the Reel (114-A), hoists the Special Articulated Container (113-A) until it is coupled very close to the body of the Helicopter (97) moving towards the source of water to replenish it, starting the operation all over again until total extinction of the fire; and
g) after the operator verifies electronically, or by means of other source of information, that the Articulated Refractory Container (113) or the Special Articulated Container (113-A) is empty, he hoists them moving towards the source of water to replenish them, starting the operation all over again until total extinction of the fire.

11. “EQUIPMENT USED FOR OPERATIONS AND EQUIPMENT FOR EXTINCTION AND EXTINCTION COMPOUNDS”, assembled and run according to a sequence of process described in claim 1, characterized by; extinction equipment of foci of heat and fires: Container (51-1), or (52-2), or (RCE-3), Core sets (46), (46-A), and (46-B), Capsules (22), and/or Containers (22-A), and/or (22-B), and Mortars (96), with their respective Bottle-Type Containers (96-A), fire extinction flow compounds (24) and/or (146), and/or (147), with or without Crystals (40), and Articulated Refractory Containers (113), and Articulated Special Container (113-A), and equipment used for operations: Helicopter (97) and (97-A), Aircraft(s) (97-B), accessories for route maintenance and for starting and identifying the new Capsules (22), and/or Containers (22-A), and/or (22-B), traditional support and alignment tripod (121), traditional launchers (122) for starting the Mortars (96) and future launches of the respective Bottle-Type Container (96-A), special land vehicles (127) and operational equipment such as Bazookas (134) and Cannons (132).

12. “EQUIPMENT USED FOR OPERATIONS AND EQUIPMENT FOR EXTINCTION AND EXTINCTION COMPOUNDS”, according to claims 1 and 11, characterized by; Container (51-1), or (52-2), or (RCE-3), to hold explosives and/or a mix of explosives or Chemical Compound that generates High Speed Pressure (41), that are provided with nesting bodies (37), (37-A), and (37-B) to hold explosive(s) and that may have a hollow cylindrical pipe format (37), or (37-A) with a hollowed cylindrical pipe staggered by adaptor (43), and (37-B) with a hollow trunk-cone pipe format or a trunk-cone, or also with a hollow cylindrical pipe format, or a polygonal prismatic format, or a spherical format, combined or not, that can be positioned in any position, placed on a vertical or horizontal direction or inclined and are made of a hard material or a flexible material to hold airtight and resistant inside explosive(s) and/or mix of explosives (41), which will have different speeds, compacted or not, inside the bodies (37), (37-A), and (37-B), with delay fuse or not and/or explosion train (42) connected and/or placed in any position of the bodies (37), (37-A), and (37-B), and that will be connected on the respective driver(s) for ignition (32) that may be electric or not electric, and that will have or not whenever necessary connected onto their external area their Axle Limiting Rings (38) with formats that match the formats of the respective bodies (37), (37-A), and (37-B) and are provided with three or more rods (38-A) with lengths that match the internal measures of the body of the core set (36) and that can also be provided with Axle Limiting Guides (39) that are made of three or more fins (39-A) with a rectangular prismatic format or a trapezoidal format and with sizes and quantities that match the internal measures of the body (36) of the respective Core Sets (46), (46-A), and (46-B); will have lower Caps (44) and upper Caps (45) on a format that matches the format of the bodies (37), (37-A), and (37-B) and they may be threaded, glued, or connected by any other conventional means; the Container (52-2), will have the reducing adaptor staggered (43) and utilized exclusively for the construction of the body (37-A) and will be used for staggering where the sizes and formats will match the formats of respective body (37-A); and these Containers (51-1), or (52-2), or (RDE-3) ready for use and with their rings (38) and or Axle Limiting Guides (39) will be introduced in the axle of the internal diameter of the Core Sets (46), (46-A), and (46-B) to ensure equalized emissions of the explosion and of the high pressures that are generated, guaranteeing sprays that are also standardized and with high pressure without losses of the Flow Compound (24), and/or (146), and/or (147), with or without Crystals (40).

13. “EQUIPMENT USED FOR OPERATIONS AND EQUIPMENT FOR EXTINCTION AND EXTINCTION COMPOUNDS”, according to claims 1 and 11, characterized by; Core Set(s) (46), (46-A), and (46-B) with body (36) made of biodegradable hard materials or not, milled, injected, molded, extruded, blown, or by any other traditional mechanical means, hollow, and with a cylindrical, cone-trunk, polygonal prismatic, or spherical, with or without internal or external programmed fragilities (23), with lower Vectorizer (25) and an upper Vectorizer (26) that can be made of biodegradable hard materials or not, milled, injected, molded, blown, extruded, or by any other traditional mechanical means, hollow or solid, with the internal part having a cone trunk format, and cone with hard faces, and the Vectorizers (25) and (26) can be replaced by the lower Cap (47) and the upper Cap (48) with or without pin(s) (49) or adaptor with internal and/or external thread (71); Core Sets (46), or (46-A), or (46-B) will be replenished with Propelled-Propellant Crystals and/or Granules (40), and equipped with their respective Container (51-1), or (52-2), or (RCE-3), provided with their Rings (38) and/or their Guides (39); Core Sets (46), or (46-A), or (46-B) can be pressurized or not with compressed air and/or another gas and/or liquid through its specific calibrating valve (69), and can be complemented by a Decentralize Adaptor (78) with a cylindrical format or a hollow or perforated polygonal prismatic format, or by a support rod(s) (82) with a cylindrical format or a hollow or perforated polygonal prismatic format; and the fully equipped Core Sets (46), or (46-A), or (46-B) will be fixed in one of the respective new support and closure Lids when they will be introduced on one of the Capsules (22) or Containers (22-A) or (22-B), closed and ready for use.

14. “EQUIPMENT USED FOR OPERATIONS AND EQUIPMENT FOR EXTINCTION AND EXTINCTION COMPOUNDS”, according to claim 1, characterized by; Propelled-Propellant Crystals and/or Granules (40) made of any kind of solid hard matter, in any format, including a block of materials to be fragmented by detonation, that absorb water or not, that can have a natural origin, and/or a synthetic origin, and/or a semi-synthetic origin, with the sizes of the particles that vary from one micron until fifteen millimeters at the most, and that can be combined or not with delaying compounds, fire extinction compounds (24) and/or (146), and/or (147) or binders to form whenever necessary a previously molded hard block; to be introduced in the respective Core Sets (46-A) or (45-B) or in the Flow Compound (24), and/or (146), and/or (147), with or without Crystals (40).

15. “EQUIPMENT USED FOR OPERATIONS AND EQUIPMENT FOR EXTINCTION AND EXTINCTION COMPOUNDS”, according to claims 1 and 13, characterized by; the lower Vectorizer (25) and the upper Vectorizer (26) with the internal part on a conical format and internal angular measures of the upper apex varying from 15° to 179°, with the internal part on a cone-trunk format with the angular measures of the edges compared to the vertical varying from 17° to 179°, to be introduced in the respective Core Sets (46), (46-A), and (46-B) and guarantee the pre-determined sprays.

16. “EQUIPMENT USED FOR OPERATIONS AND EQUIPMENT FOR EXTINCTION AND EXTINCTION COMPOUNDS”, according to claim 11, characterized by; Fire Extinction Flexible Capsules (22) and Fire Extinction Hard Container (22-A) built or molded with programmed fragilities to their bodies that may or not hold Core Sets (46), (46-A), or (46-B), or may only hold Container (51-1), or (52-2), or (RCE-3) that can be fitted, or connected, or fastened to the respective option closure Lids (1), (2), (3), (4), (5), (6), (7), (8), (9); Capsules (22) or Containers (22-A) with the body of a cylindrical format flexible or hard material, or a cone trunk format, or egg-shaped, or polygonal prismatic format, or a semi-spherical format, or a combination of these formats, with or without internal or external programmed fragilities (23) with variable depths and in one or more directions, supplied with Fire Extinction Flow Compound (24), and/or (146), and/or (147) that may or may not be in a frozen physical state, or in other states, added or not of Propelled-Propellant Crystals and/or Granules (40) with or without supporting, and/or guide, and/or transportation belts (30) of a supporting material and consolidated on the body and fastened close to the option closure lids (1), (2), (3), (4), (5), (6), (7), (8), or (9), and in any place of the external area of the Capsules (22), and/or Containers (22-A), that may or not hold or receive in any place of its body or area, fittings (73) for fin(s) or wing(s) (79), spoiler(s) (80), Male and Female Guiding Set(s) (77) fastening rod(s) (77-A) with or without Speed Control Device(s) (77-B), and optionally they may hold a special vulcanizable adaptor (81) with a hollow cylindrical format with external thread and with its internal area smooth for fastening the upper open edge of Capsule (22) with or without Whole Metal Jacket(s) (89-A), or Semijacket(s) (89-B), that may hold or not internal or external Programmed Fragilities (23) in any position.

17. “EQUIPMENT USED FOR OPERATIONS AND EQUIPMENT FOR EXTINCTION AND EXTINCTION COMPOUNDS”, according to claim 11, characterized by; Spherical Fire Extinction Hard Container (22-B) built and molded with programmed fragilities (23) in its body, made of hard materials and built in a sole body, or in two parts, with the body on a spherical format, and in the case of two parts it will be provided with; a semi-spherical upper part (84) with hole (83) with a cylindrical format on the upper edge for the connection of option closure Lids (1), (2), (3), (8), or (9) and female fitting (85) on the lower edge and lower part (87) with a semi-spherical format with a male fitting (86) on the upper edge, and with or without counter weight for plummet maintenance (88), magnetized or not, and consolidated on the lower internal part (87), or consolidated in other parts or area, that may hold or not Core Sets (46), (46-A), or (46-B), or may only hold Container (51-1), or (52-2), or (RCE-3) and all with or without internal or external programmed fragilities (23) with variable depths and in one or more directions, with Fire Extinction Flow Compound (24) and/or (146), and/or (147), that may or may not be in a gelid physical state, or in other states, added or not of Propelled-Propellant Crystals and/or Granules (40); Containers (22-B) with or without supporting belts, and/or guide, and or transportation belts (30) of a supporting material and consolidated on the body that may or not hold or receive in any place of its body or area, fittings (73) for fin(s) or wing(s) (79), spoiler(s) (80), Male and Female Guiding Set(s) (77) fastening rod(s) (77-A) with or without Speed Control Device(s) (77-B), with or without Whole Metal Jacket(s) (89-A), or hard material Semijacket(s) (89-B), that may hold or not internal or external Programmed Fragilities (23) in any position.

18. “EQUIPMENT USED FOR OPERATIONS AND EQUIPMENT FOR EXTINCTION AND EXTINCTION COMPOUNDS”, according to claim 11, characterized by; closure Lid (35) option 1, centrally fixed for the respective Core Sets: Lid with a cylindrical format, or a polygonal prismatic format, or a semi-spherical format, with or without fastening shoulder, and/or adjustment, and/or sealing shoulder for the clamp(s) (35-B) on the external lateral central part with running through hole (28-A) for the drivers (32) with Starting Device(s) and/or Detonators (31) fit on hole (35-C) with a format that matches the external format of the starting device (31) with Capsules (22) or Containers (22-A) or (22-B) filled or supplied by an opening (35-D) with a cylindrical or polygonal prismatic format, with or without internal thread or fitting thread for its traditional screw Cap (34) that can be screwed or fit, with fastening Hole (28) and or fitting for the Hook(s) (33), with a running through cylindrical format or not, or with internal thread, with support and/or transportation hooks (33), with one or more running through, or fastening, or fitting holes (35-E) for the fastening screw for the upper Vectorizer (26), or for the upper Cap (48), or for the adaptor with internal and external threads (71) and with a cylindrical or polygonal prismatic format and with fastening and/or adjustment, and/or sealing clamp(s) (29) and may or not hold or receive in any place in its body or area, fin(s) or wing(s) (79), spoiler(s) (80), Male and Female Guiding Set (77), fastening Rod(s) (77-A), with or without Speed Control Device(s) (77-B) and a variable from closure Lid (35-A) option 2 of centralized fixed position for the respective Core Sets. Lid with hole (28-A), clamp (29), Starting and/or Detonating Device(s) (31) with or without shoulder (35-B), with one or more holes (35-E) and fin(s) or wing(s) (79), spoiler(s) (80) Male and Female Guiding Set (77), fastening Rod(s) (77-A), with or without Speed Control Device(s) (77-B) identical to Lid (35) option 1 of centralized fixed position for the respective Core Sets; and such lid with another hole (35-F) for fitting and/or fastening of the Starting and/or Detonating Device(s) (31) with a format that matches the device(s) (31) and that transfix the Lid, that has two or more fastening and/or fitting holes (28) of one or more hook(s) (33) with or without Speed Control Device(s) (77-B), with or without Whole Metal Jacket(s) (89-A), or Hard Material Semi-jacket (89-B) that may or not hold Programmed Fragilities (23) that are internal or external or in any position.

19. “EQUIPMENT USED FOR OPERATIONS AND EQUIPMENT FOR EXTINCTION AND EXTINCTION COMPOUNDS”, according to claim 11, characterized by; closure lid (55) option 3, of centralized fixed position for the respective Core Sets; and this lid is provided with Fastening Retention Disk (58) made of a hard material and with a cylindrical or polygonal prismatic format, with running through hole (28-A) for the driver(s) for ignition (32) with one or more hole(s) (54) for the screw(s) (62) to fasten the Disk (58) and the upper Vectorizer (26), or the upper Cap (48), and/or adaptor with internal and external threads (71) with three or more holes (61) with a cylindrical format, with transportation, fastening, retention, and adjustment lid (56) made of a hard material and with a cylindrical or polygonal prismatic format, with three or more Holes (61) with rims (59-A) for support reinforcement, and support and transportation holes (59) with running through Hole (28-A) for driver (32), and with fitting and/or fastening hole(s) (35-C) for the Starting and/or Detonating Device(s) (31) and with hard polymer Lids (57) for experimental Capsules (22), and/or Containers (22-A), and/or (22-B) with a format that matches the format of the Capsules (22), and/or Containers (22-A), and/or (22-B) and with screws (60) that run through and fasten on Disk (58), run through the experimental containers lid(s) (57), and run through and fasten the lid (56) and all the set adjusted by the check nuts (63), and they may hold or not or receive in any place in its body or area fin(s) or wing(s) (79) or spoiler(s) (80), Male and Female Guiding Set (77), fastening Rod(s) (77-A), with or without Speed Control Device(s) (77-B).

20. “EQUIPMENT USED FOR OPERATIONS AND EQUIPMENT FOR EXTINCTION AND EXTINCTION COMPOUNDS”, according to claim 11, characterized by; closure Lid (64) option 4 of centralized fixed position for the respective Core Sets; and this lid is provided with a hollow cylindrical format and reinforced base (72), with a central hole (70) for threading the adaptor (71), with fitting or fastening hole (74) for the Lid (65), with fastening and running through hole (75) for the Calibrating Valve (68), with Lid (65) with running through Hole (28-A) for protection of the Electronic Board(s) with its component(s) (66) provided with pin(s) (67) for support and fastening with fitting and/or fastening hole(s) (35-C) for the Starting and/or Detonating Device(s) (31), and with fittings for one or more fastening and/or fitting Holes (67-A) for pin(s) (67), with two or more support and transportation holes (59) with a cylindrical format for the Capsules (22), and/or Containers (22-A), and/or (22-B) that may hold or not fittings (73) for fin(s) or wing(s) (79), spoiler(s) (80), Male and Female Guiding Set (77), fastening Rod(s) (77-A), with or without Speed Control Device(s) (77-B) and with adaptor (71) with internal and/or external threads, with or without conical hole (28-A) for the passage of drivers, with or without running through or fastening hole (76) for the calibrating valve (69) with a cylindrical format and variable closure Lid (64) option 6 of centralized fixed position for the respective Core Sets; and this lid is provided without the adaptor (71) and variable closure Lid (64) option 8 of centralized fixed position for the respective Core Sets; and this lid is provided with reinforced base (72) without lower rim and with external thread (64-C).

21. “EQUIPMENT USED FOR OPERATIONS AND EQUIPMENT FOR EXTINCTION AND EXTINCTION COMPOUNDS”, according to claim 11, characterized by; closure Lid (64) option 5 of centralized fixed position for the respective Core Sets; and this lid is provided with a hollow cylindrical format and a straight base (72-A), with two running through holes (35-E) for fastening the screws (62) on the adaptor (71), with a hole (74) to fit or fasten on the lid (65), with running through Hole (75) for fastening the Calibrating Valve (68) with a cylindrical format, with Lid (65) with running through hole (28-A) for the protection of the Electronic Board(s) with their component(s) (66) provided with support and fastening pin(s) (67) with fitting and/or fastening hole(s) (35-C) for the Starting and/or Detonating Device(s) (31) and with fittings for one or more Holes (67-A) for fastening and fitting the pin(s) (67), with two or more Holes (59) with cylindrical format for supporting, and transporting, and closure of the Capsules (22), and/or Containers (22-A), and/or (22-B) that may hold or not fittings (73) for fin(s) or wing(s) (79) or spoiler(s) (80), Male and Female Guiding Set (77), fastening Rod(s) (77-A), with or without Speed Control Device(s) (77-B), and with adaptor (71) with internal and/or external threads, and with or without conical hole (28-A) for running through the drivers, with variable closure Lid (64) option 7 of centralized fixed position for the respective Core Sets; and this lid is provided without the adaptor (71), and with screws (62) for direct fastening on the Vectorizer (26) or on the upper Cap (48) and variable closure lid (64) option 9 of centralized fixed position for the respective Core Sets; and this lid is provided with straight base (72-A) without lower rim and with external thread (64-C), with adaptor (71) or with screws (62) for direct fastening on the Vectorizer (26) or on the upper Cap (48).

22. “EQUIPMENT USED FOR OPERATIONS AND EQUIPMENT FOR EXTINCTION AND EXTINCTION COMPOUNDS”, according to claim 11, characterized by; target route guidance devices built with fin(s) or wing(s) (79) or spoiler(s) (80) that direct towards the target, made of hard material and with traditional format, Male and Female Guiding Set (77) for target route and ignition start, provided with one or more fastening Rod(s) (77-A), or whenever necessary with Speed Control Device(s) (77-B), and with a cylindrical or polygonal prismatic format, or two piece fluting format creating a cylinder attached to each other, and that may hold in its interior jackets or brake linings holding the Cable(s) and/or Guide Chain(s) (105), to be used to ensure target accuracy during Capsules (22) or Containers (22-A) or (22-B) launches.

23. “EQUIPMENT USED FOR OPERATIONS AND EQUIPMENT FOR EXTINCTION AND EXTINCTION COMPOUNDS”, according to claim 11, characterized by Fire Extinction Mortar (96), and/or Bottle-Type Container (96-A) provided with a reinforced and reusable metal capsule (96-C) with a cylindrical or polygonal prismatic format, with fuses and/or explosion train by percussion or electric, or electronic, or mechanical activation (42) connected on its lower part to the propulsion explosive (41), Bottle-Type Container (96-A) with lower and/or external lid (96-B), that can be connected via thread or glue, or by other conventional means, and can be smaller or of the same internal or external size of the body of the Bottle-Type Container (96-A), that may or not have Programmed Fragilities (23) that are placed in several directions and being in its internal or external area, may be made of hard material or whenever necessary of flexible material, and if flexible will receive Whole Metal Jackets (89-A) or Hard Material Semi-jacket (89-B), that will contain water or fire extinction flow compound (24) and/or (146), and/or (147), with or without Crystals (40), and provided or not with Core Sets (46), (46-A), or (46-B) in its interior, or having only Container (51-1), or (52-2), or (RCE-3) with percussion pin (96-D), connected to the delay fuse (42) or not that belongs to the Core Sets (46), (46-A), or (46-B) or that belongs to Container (51-1), or (52-2), or (RCE-3), and with Rings (38) or Guides (39) positioned on the external part of these Core Sets.

24. “EQUIPMENT USED FOR OPERATIONS AND EQUIPMENT FOR EXTINCTION AND EXTINCTION COMPOUNDS”, according to claim 11, characterized by; a thick fire extinction flow compound (24) and/or (146), and/or (147), with or without Crystals (40) that may hold water and/or components combined among chemical products and/or compounds selected among emulsifiers, isolators, dispersants, coolers for extinction: with or without deployment of Foam Generating Liquid and/or Bio-Natural anti-flame, and/or Bio-Gel—Roots, and/or Gel-Refractory (146), and/or anti-flame chemical Powder(s): Natural and/or Chemical Fertilizers for soil recovery (147), and/or different Seeds for reforestation, and/or Propelled-Propellant Crystals or Granules (40), and/or special Gel-capsules to cover the seeds provided with nutrients and/or fertilizers, or anti-flame chemical Powder(s) also to control weeds and parasites: Herbicides that may be on a solid, thick liquid, paste, powder, gelatin, or gelid physical state in encapsulated clusters, with gas, cold, or warmed.

25. “EQUIPMENT USED FOR OPERATIONS AND EQUIPMENT FOR EXTINCTION AND EXTINCTION COMPOUNDS”, according to claim 11, characterized by; Articulated Special Container (113-A) or Articulated Refractory Container for fire extinction (113) with lids (90-A), with rubber sealing rims (90-B) or sealing materials to stop the flows, with their hinges (90-C) and floating buoys (90-D), container body (90) with a prismatic, cylindrical, spherical, cone-trunk, or egg-shaped format, support and/or fastening hooks (90-F), counter weight (90-G) for immersion, electric, electronic, mechanical, or hydraulic motor and/or engine (90-H), fitting and fastening pin (90-I) for and of the sprays (90-J), spray (90-J) with the same format of the body (90), and output holes (90-K) on the lateral and lower areas and that can be fitted and/or fastened onto the body (90) through fitting and fastening pins (90-I), or through threads, angle bars (90-E) that restrict the lids, activation cable (90-O) for opening and/or closing the valve(s), mechanical articulated axle (90-N) for opening and/or closing the valves (90-R), ring (90-P) for regulating and fastening the cable (90-O) and/or the arm, and/or mechanical articulated axle (90-N), hinges (90-T) to seal the valves (90-R), supporting guide (90-Q) for the valves (90-R), base (90-S) for supporting, sealing, and fitting of the valves (90-R), valve or output valves (90-R), and output holes (90-K) or valves for flow discharge, output pipes (90-L) or pipes for flow discharge, and male and female sealing fitting set (90-M) covered or not with refractory materials or isolating materials.

26. “EQUIPMENT USED FOR OPERATIONS AND EQUIPMENT FOR EXTINCTION AND EXTINCTION COMPOUNDS”, according to claim 11, characterized by; Special Fire Extinction Articulated Container (113-A) with the same building process of Articulated Refractory Container (113) where a protection Box for output Pipe(s) (114) is added, with
or without water Pump(s) (114-B) and/or other Cooling Fluid(s) and/or Extinction Fluids, Retractable Mobile Reel (114-A), Special Hose(s) or flow pipe (115), and Nozzle or Open/Close spray Valve (116) optionally added with Propelled-Propellant Crystals and/or Granules (40) whenever necessary, as particles (powder and/or granules) to be mixed by dosing devices, mixing Crystals (40) with the water jets that are directed by the Nozzle or open/close Spray Valve (116) that belongs to Articulated Special Container (113-A), or for utilization on the diffusers connected to the hoses of the firemen trucks, or as a “dosing sachet”, or to be used by other systems and/or fire extinction equipment with the body (90) covered or not with refractory or isolating materials.

27. “EQUIPMENT USED FOR OPERATIONS AND EQUIPMENT FOR EXTINCTION AND EXTINCTION COMPOUNDS”, according to claim 11, characterized by; Capsules (22), and/or Containers (22-A), and/or (22-B), Mortars (96) and their respective Bottle-Type Containers (96-A), Lids options (1), (2), (3), (4), (5), (6), (7), (8), (9), Articulated Refractory Container (113), Articulated Special Container (113-A), Cable(s) or Guide Chain(s) (105), Lowering Cable(s) or Guide Chain(s) (108), rotating, conical dart(s) (106) and pendulum articulated rod(s) (107), Lowering Cable(s) or Guide Chain(s) (108) that may hold or not sensor(s) for different identifications and/or for scanning (107-A), and they can also be connected, when necessary, to flashing lights or not, signaling Bulbs of Light Emitting Devices (107-B), or reflecting Devices or fluorescent Devices (107-C), adhesive or not, for signaling, identification, and place setting, and that can be connected on the external area or lower area, or embedded in any external or internal area, and will be supplied by solar radiation, batteries, electric power, or other traditional and necessary means.

28. “EQUIPMENT USED FOR OPERATIONS AND EQUIPMENT FOR EXTINCTION AND EXTINCTION COMPOUNDS”, according to claim 11, characterized by Helicopters (97) or Helicopters (97-A), or Aircrafts (97-B) equipped with devices and pieces of equipment of advanced avionics (18-A) for Helicopters/Aircrafts piloted only by a crew, and/or Helicopters/Aircrafts piloted by crew and/or commands by remote control, and/or radio, and/or Helicopters/Aircrafts only piloted by control remote, and/or electronic means, and with a trolley(s) or hook(s), guide trolley (92) for supporting and transporting the articulated mobile hook, and with special guide rails (93) for Helicopters/Aircrafts and to store, displace, position, and guided launch of the Capsules (22), and/or Containers (22-A), and/or (22-B), and with door(s) (98) or equipped openings for Helicopters/Aircrafts, and/or with articulated mobile Hook (99) connected to the Trolley and/or a Trolley Hook, and/or with one or more Cable(s) or Guide Chain(s) (105) for guided launches, and/or Rotating Conical Dart(s) (106), and/or with Pendulum Articulated Rod(s) (107), or with Cable(s) and or lowering and hoisting Chain(s) (108) and/or with Guide pulley(s) (109) and/or with special electric, and/or electronic, and/or mechanical, and/or hydraulic hoist (109-A), and/or with rotating device(s) (110) for Cable(s) and/or Chain(s) (105) or (108).

29. “EQUIPMENT USED FOR OPERATIONS AND EQUIPMENT FOR EXTINCTION AND EXTINCTION COMPOUNDS”, according to claim 11, characterized by; Aircraft(s) (97-B) that can be airplanes, balloons, dirigibles, and ordinary air balloons (19), provided with advanced avionics (19-A) for Aircrafts piloted only by a crew, and/or piloted by a crew and/or commanded by remote control, and/or radio, and/or others only piloted by remote control and/or by electronic means, and/or with trolley(s) or guide trolley hook (92) for the support and transportation of the articulated mobile hook, and with special guide rail(s) (93) for Aircrafts for launching, lowering, hoisting, storage, and displacement, of Capsules (22) or Containers (22-A) or (22-B) and with a door(s) or equipped opening(s) (98), and/or articulated mobile hook (99) connected to the trolley and/or with trolley hook, and/or with guide pulley(s) (109) of the lowering or hoisting cable(s) or chain(s) (108) or launch-guided cable(s) or Guide Cable(s) (105), and/or special electric, and/or electronic, and/or mechanical, and/or hydraulic hoist (109-A).

30. “EQUIPMENT USED FOR OPERATIONS AND EQUIPMENT FOR EXTINCTION AND EXTINCTION COMPOUNDS”, according to claim 11, characterized by; accessories for route maintenance and to start Capsules (22), and/or Containers (22-A), and/or (22-B), provided with target route male and female set (77) or optionally belts (30), with rotating conical dart(s) (106) made of hard materials, magnetized or not, with conical formats on the upper part and with cylindrical format with threads on the lower part with transfixing central hole for the passage and fastening on the cable(s) and/or guide chain(s) (105) and with rotating devices introduced inside the threaded lower part, and with a pendulum articulated rod(s) (107) with cylindrical or polygonal prismatic hollow or not format, with or without internal and/or external threads, with or without articulations, with different lengths, and that can be magnetized or not, or made of magnets.

31. “EQUIPMENT USED FOR OPERATIONS AND EQUIPMENT FOR EXTINCTION AND EXTINCTION COMPOUNDS”, according to claim 11, characterized by; special land vehicle(s) (127) that is a truck with a special traditional telescopic hoist (129) with the appropriate size for the loads to be hoisted or lowered with operational equipment including a traditional thermal booth with controls (130) covered with thermal isolator and fastened to the hoist (129), telescopic trough (128) with a fluting or “U” format fastened on the front of the booth (130), telescopic arm(s) (131) with a cylindrical or polygonal prismatic format fastened in parallel on the upper part of the trough (128), hoist (129) tackle (132) fastened on the far upper part of the hoist (129) with horizontal and vertical move, and with traditional hook, cable, and thermal booth (133) covered with thermal isolator for transportation of first-aid crew, victims, Containers (22-B) used for the extinction of forest fires, urban fires, on oil wells, gas pipelines, and oil pipelines.

32. “EQUIPMENT USED FOR OPERATIONS AND EQUIPMENT FOR EXTINCTION AND EXTINCTION COMPOUNDS”, according to claim 11, characterized by; the performance or modeling in Capsules (22) or Containers (22-A) or (22-B), in Bottle-Type Container (96-A), in Metal Jacket(s) (89-A), or Semijacket(s) (89-B), or in Container (51-1), or (52-2), or (RCE-3), or on the bodies of the respective Core Sets, of internal or external Programmed Fragilities (23) and different depths and in one or more directions, with shoulders with polygonal prismatic, semi-spherical, semi egg-shaped, and mixed format, to enable the planned blasting of Capsules (22), and/or Containers (22-A), and/or (22-B) into plates, and/or mono blocks, and/or windows (137) to ensure high speed sprays in pre-determined directions of the Flow Compound (24), and/or (146), and/or (147), with or without Crystals (40) placed in these same Capsules (22), and/or Containers (22-A), and/or (22-B), and in Bottle-Type Container (96-A) and in Metal Jacket(s) (89-A), or Semijacket(s) (89-B).
